(19) United States
(12) Patent Application Publication
(10) Pub. No.: US 2026/0134455 A1
(43) Pub. Date: May 14, 2026

(54) SYSTEMS AND METHODS FOR AUTOMATIC GENERATION OF MEDIA PROMOTIONS

(71) Applicant: MUSX, Austin, TX (US)

(72) Inventor: John Reardon, Chagrin Falls, OH (US)

(73) Assignee: MUSX, Austin, TX (US)

(21) Appl. No.: 19/387,384

(22) Filed: Nov. 12, 2025

Related U.S. Application Data
(60) Provisional application No. 63/719,381, filed on Nov. 12, 2024.

(51) Int. Cl. G06Q 30/0241; G06F 16/638

(52) U.S. Cl. CPC G06Q 30/0276; G06F 16/638

(57) ABSTRACT

Disclosed embodiments provide a framework for automatically generating media promotions according to real-time media analytics and that can be presented to different users of a peer-to-peer music recommendation service. In response to a user query to generate a promotion for a song, the service converts the query into a set of embeddings. Using user profile data and historical music data corresponding to the song and obtained based on the set of embeddings, the service generates music analytics corresponding to the song and recommendations for different music promotions associated with the song. The service can implement these music promotions and track the efficacy of these music promotions as users engage with the music promotions and the song.

### CROSS-REFERENCE TO RELATED APPLICATIONS

The present application claims the priority benefit of U.S. Provisional Application No. 63/719,381, filed on Nov. 12, 2024, the disclosure of which is incorporated herein by reference.

### FIELD

The present disclosure relates generally to the automatic generation and presentation of media promotions based on real-time media analytics. In one example, the systems and methods described herein may be used to provide recommendations for different media promotions according to user interactions with different media and other media analytics. Further, the systems and methods described herein may be used to dynamically monitor user interactions with new promotions to provide further recommendations according to user engagement with the new promotions.

### SUMMARY

Disclosed embodiments may provide a framework for automatically generating media promotions according to real-time media analytics and that can be presented to different users of a peer-to-peer music recommendation service. The media promotions may be dynamically generated through generative artificial intelligence systems that can dynamically process different media analytics and user profile data to identify target cohorts for tailored media promotions.

According to some embodiments, a computer-implemented method is provided. The method comprises receiving a user query to generate a music promotion corresponding to a song. The user query is received during an ongoing communications session. The method further comprises dynamically converting the user query into a set of embeddings. The embeddings are obtained through language processing of the user query. The method further comprises obtaining user profile data and historical music data corresponding to the song and based on the set of embeddings. The user profile data is associated with a set of different users. Further, the historical music data corresponds to different user interactions with the song. The method further comprises processing the user profile data and the historical music data through a trained machine learning algorithm to dynamically generate a set of music analytics corresponding to the song and a set of recommendations for different music promotions. The trained machine learning algorithm is trained using a dataset of sample music data and sample promotions. The method further comprises generating a response to the user query. The response includes the set of music analytics and the set of recommendations. The method further comprises updating the trained machine learning algorithm based on feedback associated with the set of music analytics and the set of recommendations. The feedback is obtained through the ongoing communications session.

In some embodiments, the computer-implemented method further comprises receiving a request to implement a music promotion corresponding to a provided recommendation. The request is received through the ongoing communications session. The computer-implemented method further comprises automatically implementing the music promotion according to a set of characteristics associated with the song and the music recommendation.

In some embodiments, the different music promotions correspond to different user cohorts. Further, the different user cohorts are identified according to the user profile data.

In some embodiments, the set of recommendations includes corresponding rationales for generating the set of recommendations and predicted outcomes from implementing the set of recommendations.

In some embodiments, the set of music analytics includes a set of tags defining attributes assigned to the song in response to the different user interactions with the song.

In some embodiments, the set of music analytics includes representative comments communicated amongst the set of different users as the song is shared.

In some embodiments, the set of music analytics includes different activities linked to the song based on the different user interactions with the song.

According to some embodiments, a computer-program product is provided. The computer-program product is tangibly embodied in a non-transitory machine-readable storage medium, including instructions that, when executed by one or more processors, cause the one or more processors to perform the steps of the above method.

According to some embodiments, a system is provided. The system comprises one or more processors, and one or more non-transitory machine-readable storage media containing instructions that, when executed on the one or more processors, cause the one or more processors to perform operations including the steps of the above method.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 shows an illustrative example of an environment in which a peer-to-peer (P2P) music recommendation service dynamically provides a set of media analytics and recommendations for promotions related to media specified in a user query in accordance with at least one embodiment;

FIG. 2 shows an illustrative example of an environment in which a P2P music recommendation service processes incoming music sharing and music recommendation requests for different users and generates different media analytics for creation of tailored media promotions in accordance with at least one embodiment;

FIG. 3 shows an illustrative example of an environment in which an automated promotion system implemented by the P2P music recommendation service dynamically generates and evaluates music analytics corresponding to different music to generate and provide promotion recommendations in response to user queries in accordance with at least one embodiment;

FIG. 4 shows an illustrative example of an environment in which a music identification system of the P2P music recommendation service utilizes a set of machine learning systems to generate and update various profiles used to identify music that can be shared by users of the P2P music recommendation service in accordance with at least one embodiment;

FIG. 5 shows an illustrative example of an environment in which an automated promotion system, through a user interface and for a particular song, provides music analytics corresponding to user listening habits and preferences in accordance with at least one embodiment;

FIG. 6 shows an illustrative example of an environment in which an automated promotion system, through a user interface and for a particular song, provides music analytics corresponding to user sentiment, user activities, and user comments regarding the particular song in accordance with at least one embodiment;

FIGS. 7A-7B show an illustrative example of an environment in which an automated promotion system dynamically generates different music promotion recommendations corresponding to different user cohorts in accordance with at least one embodiment;

FIGS. 8A-8C show an illustrative example of an environment in which an automated promotion system, through a user interface and for a particular music promotion, provides promotion analytics corresponding to the music promotion and recommendations for modifying the music promotion in accordance with at least one embodiment;

FIG. 9 shows an illustrative example of an environment in which a P2P music recommendation service automatically surfaces a music promotion in response to a user request for music recommendations in accordance with at least one embodiment;

FIG. 10 shows an illustrative example of an environment in which a P2P music recommendation service provides a set of songs associated with a music administrator to different users through a music administrator profile in accordance with at least one embodiment;

FIG. 11 shows an illustrative example of an environment in which a P2P music recommendation service provides a song promoted by a music administrator according to a defined music promotion and to a user profile in accordance with at least one embodiment;

FIG. 12 shows an illustrative example of a process for generating music promotion analytics and recommendations in response to music administrator queries and corresponding embeddings in accordance with at least one embodiment;

FIG. 13 shows an illustrative example of a process for launching a music promotion and dynamically monitoring user interactions with the music promotion to generate music promotion analytics and recommendations in accordance with at least one embodiment; and

FIG. 14 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

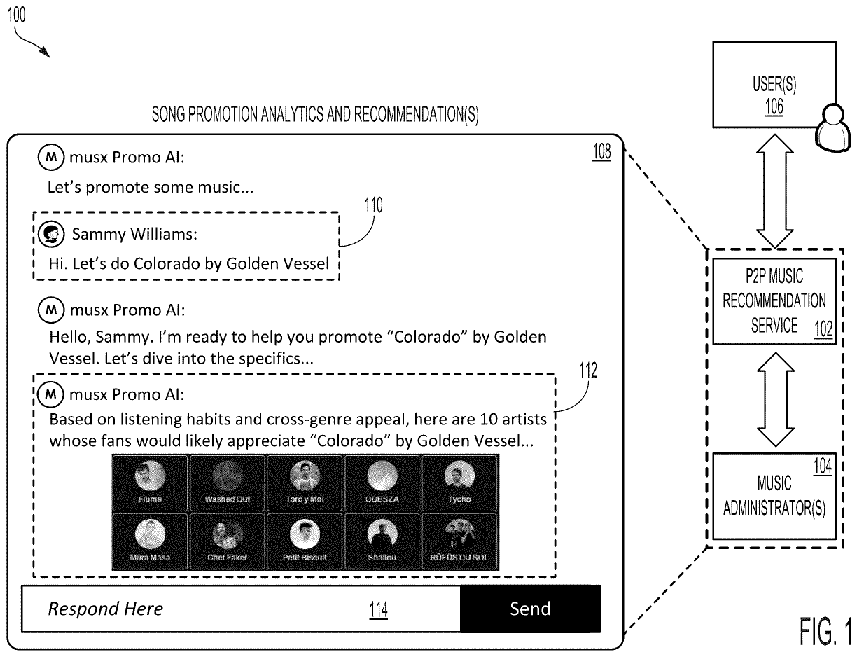

FIG. 1 shows an illustrative example of an environment 100 in which a P2P music recommendation service 102 dynamically provides a set of media analytics and recommendations for promotions related to media specified in a user query 110 in accordance with at least one embodiment. In the environment 100, a music administrator 104 submits a request to a P2P music recommendation service 102 to obtain a set of media analytics corresponding to a particular song and, based on this set of media analytics, a set of recommendations corresponding to different music promotions that may be implemented to better promote the song to different users of the P2P music recommendation service 102. The P2P music recommendation service 102 may provide, to the music administrator 104 and other music administrators of different songs shareable through the P2P music recommendation service 102, an interface 108 (such as a graphical user interface (GUI)) through which music administrators may interact with an automated agent implemented by the P2P music recommendation service 102 to obtain analytics related to different songs administered by the music administrators and to implement different promotional campaigns to increase exposure of these different songs to different users of the P2P music recommendation service 102. The interface 108 may be provided by the P2P music recommendation service 102 through an application that may be implemented on a computing device (e.g., smartphone, computer, laptop, etc.) that may be used to access the P2P music recommendation service 102. Additionally, or alternatively, the interface 108 may be provided by the P2P music recommendation service 102 through a website or web portal implemented by the P2P music recommendation service 102. It should be noted that while music and songs are utilized extensively throughout the present disclosure for the purpose of illustration, the techniques described herein may be applied to other forms of media (e.g., podcasts, films, books, audiobooks, etc.) or elements associated with these other forms of media (e.g., authors, book titles, etc.). Further, the techniques described herein may also be applied to other forms of content unrelated to media (e.g., restaurants, products, recipes, etc.) for which different promotions may be generated and implemented.

In an embodiment, the P2P music recommendation service 102 further allows users 106 to submit requests to obtain music recommendations from other users of the P2P music recommendation service 102. For instance, a user of the P2P music recommendation service 102 may define one or more parameters of a music recommendation request that is to be transmitted to one or more other users of the P2P music recommendation service 102. This requesting user may select one or more tags that may be used to define, or provide context for, the types of music the requesting user is interested in receiving in music recommendations from other users. Tags may correspond to musical genres, musical subgenres, musical styles, musical instruments, activities, sentiments, locations, and the like. For instance, when a requesting user submits a request to the P2P music recommendation service 102 to generate a music recommendation request, the P2P music recommendation service 102 may provide the requesting user with various options for selecting a set of tags that are to be provided in the music recommendation request. As an illustrative example, a requesting user may submit a tag query to identify a set of tags that may be included in the request. The P2P music recommendation service 102 may process the tag query from the requesting user and identify any tags that may be of interest to the requesting user. Further, the P2P music recommendation service 102 may provide a set of popular tags that may be incorporated into the music recommendation request. This set of popular tags may be commonly used by the requesting user in their music recommendation requests, related to music that the requesting user has previously interacted with via the P2P music recommendation service 102, related to activities that the requesting user has performed via the P2P music recommendation service 102, and the like. These tags may also be popular among the user base (e.g., users 106) of the P2P music recommendation service 102. The set of popular tags may also be specific to a particular time of day and/or location.

In an embodiment, the P2P music recommendation service 102 dynamically identifies or automatically generates a set of tags corresponding to a music recommendation request as the music recommendation request is communicated by a user. For example, the P2P music recommendation service 102 may implement a Natural Language Processing (NLP) model that is dynamically trained to process a music recommendation request in real-time as the music recommendation request is provided to identify a set of tags that may be associated with the music recommendation request. This NLP model may be dynamically trained using a dataset of sample music recommendation requests (e.g., historical requests, hypothetical requests, combinations of historical and hypothetical requests, etc.) and sample tags corresponding to the sample music recommendation requests. To dynamically train the NLP model for dynamically identifying and/or generating tags for music recommendation requests, the P2P music recommendation service 102 may generate an initial iteration of the NLP model by randomly setting a set of model coefficients according to a Gaussian or non-Gaussian distribution. Using this initial iteration of the NLP model, the P2P music recommendation service 102 may process the sample music recommendation requests to generate corresponding tags that are assigned to the sample music recommendation requests. The P2P music recommendation service 102 may compare these newly generated tags to the sample tags (e.g., expected tags) from the dataset to identify any inaccuracies or other errors.

If the output of the NLP model does not satisfy one or more criteria (e.g., an accuracy threshold, etc.), the P2P music recommendation service 102 may iteratively update the set of model coefficients of the NLP model to generate a new iteration of the NLP model. The P2P music recommendation service 102 may process the aforementioned dataset through this new iteration of the NLP model to generate a new set of tags for each sample music recommendation request in the dataset. The P2P music recommendation service 102 may evaluate these new sets of tags to determine whether the new iteration of the NLP model satisfies the one or more criteria. This process of updating the set of coefficients associated with the NLP model according to the one or more criteria may be performed iteratively until an iteration of the NLP model is produced that satisfies the one or more criteria.

Once the NLP model is dynamically trained to automatically identify a set of tags from music recommendation requests submitted by users 106 of the P2P music recommendation service 102, the NLP model may process, in real-time and as a user submits a music recommendation request to the P2P music recommendation service 102, any terms associated with the music recommendation request to identify any tags that may be associated with the request. The P2P music recommendation service 102 may present these tags to the user in addition to any other tags previously selected by the user. The user may evaluate these suggested tags and determine whether to incorporate any of the identified tags into its music recommendation request or omit these suggested tags. In some instances, the user may provide, in addition to their request, optional comments in the form of text, digital images (e.g., GIFs, JPEGs, BMPs, etc.), recorded video, recorded audio, and the like. These optional comments may also be evaluated using the NLP model to identify any additional tags that may be included with the request.

In the music recommendation request, a user may further select one or more other users that may be solicited to provide responses to the music recommendation request. For instance, the P2P music recommendation service 102 may provide the user with a listing of other users that may be followers of the user. A follower of a particular user may be a user of the P2P music recommendation service 102 that has established a connection with the particular user to obtain notifications (e.g., songs, recommendations, etc.) from the particular user or provided on behalf of the particular user. For instance, a follower may receive new messages including shared songs from the particular user. Similarly, a follower may receive music recommendation requests submitted by the particular user or on behalf of the particular user. These other users and the requesting user may be mutual followers, whereby each of the users may share music with the requesting user and/or submit music recommendation requests to the requesting user. Through the interface, the requesting user may select the users that are to be recipients of the music recommendation request. In an embodiment, the P2P music recommendation service 102 provides additional information to the requesting user that can be used by the requesting user to determine which users to select for its music recommendation request. This additional information may include tags associated with the types of music shared by each user, recommendation scores for each user (e.g., scores indicating the quality of a user's recommendations, etc.), and the like.

In addition to providing a listing of users that may be mutual followers of the requesting user, the P2P music recommendation service 102 may also provide, via the interface, a listing of tastemakers from which to solicit music recommendations. A tastemaker may be a user of the P2P music recommendation service 102 that is deemed to be qualified to provide relevant music recommendations or otherwise shares music with other users that is of interest to a wide audience. The requesting user may select from the listing of tastemakers supplied by the P2P music recommendation service 102, any tastemakers that may be solicited for a music recommendation. The listing of tastemakers may specify one or more tastemakers that are selected based at least in part on the parameters of the music recommendation request. For instance, if the music recommendation request specifies that the requesting user is seeking music recommendations within a particular genre, the P2P music recommendation service 102 may select one or more tastemakers for presentation that are known to provide relevant music recommendations for that genre.

In some instances, the P2P music recommendation service 102 may provide a requesting user with an option to submit the music recommendation request to the public (e.g., all users of the P2P music recommendation service 102) to allow any user of the P2P music recommendation service 102 to provide a music recommendation in response to the request. In some instances, if the requesting user opts to submit the music recommendation request to the public, the P2P music recommendation service 102 may automatically select different users to solicit responses for the music recommendation request. For instance, the P2P music recommendation service 102 may automatically select a set of users that have previously provided music recommendations in response to requests having similar tags or other characteristics. As another illustrative example, the P2P music recommendation service 102 may automatically select a set of users that have previously submitted similar music recommendation requests and have received relevant responses from other users of the P2P music recommendation service 102. In some instances, the P2P music recommendation service 102 may automatically select one or more users based on a score that is indicative of each user's performance with regard to the quality of recommendations provided in response to music requests having similar parameters (e.g., tags, characteristics, etc.) to those of the music recommendation request submitted by the user.

Once the requesting user has completed generating the music recommendation request, the P2P music recommendation service 102 may transmit the music recommendation request to the one or more other users selected by the requesting user or otherwise selected on behalf of the requesting user by the P2P music recommendation service 102 (e.g., tastemakers, users not followed by the requesting user but otherwise selected based on other criteria, etc.). For instance, the P2P music recommendation service may transmit a notification to each selected user to indicate that it has received a music recommendation request from the requesting user. Each of the selected users may also access the P2P music recommendation service via an interface provided by the P2P music recommendation service to evaluate the music recommendation request and provide a music recommendation in response to the request.

In response to a received music recommendation request, a responding user may select one or more songs that can be shared with the requesting user as music recommendations. For instance, the P2P music recommendation service 102 may provide a user with an option to submit queries for different songs that may be shared with the requesting user. If the responding user submits a song query to the P2P music recommendation service 102, the P2P music recommendation service 102 may transmit the query to the one or more music external services (e.g., music streaming services, etc.) to identify songs maintained by these one or more external music services that correspond to the submitted query and/or the requesting user. For instance, these music services may allow users to stream or play back various songs maintained by the music services for their subscribers or other users. In some instances, these music services may allow users to stream or play back a portion of songs maintained by the music services for users that may not be subscribed to these music services. Thus, in response to the submitted query, the one or more music services may utilize the search terms of the query to identify any songs that correspond to the provided search terms.

The P2P music recommendation service 102 may present to the responding user a set of query results provided by one or more music services and/or by the P2P music recommendation service from a cache of previously provided query results in response to the song query submitted by the responding user. Each song result may include identifying information of the particular song. In an embodiment, the song result is presented in the form of a hyperlink or other link that may be used to access the song at a particular network location associated with the P2P music recommendation service 102 or from the music service that provided the song result. This may allow the responding user to select a particular song and initiate playback of the song. The P2P music recommendation service 102, in some instances, may further provide a responding user access to their playlists and/or saved songs maintained by another music service. For instance, if the responding user has an account with another music service, the responding user may establish a connection between the P2P music recommendation service 102 and their account with the other music service. The responding user may accordingly select one or more songs from their playlists and/or saved songs that may be included in the music recommendation to be provided to the requesting user.

If the responding user selects one or more songs for their music recommendation to the requesting user, the P2P music recommendation service 102 may provide a summary of the music recommendation. If the responding user includes an optional comment in their music recommendation, the P2P music recommendation service 102 may evaluate the optional comment to identify any additional tags that may be associated with the response. For instance, the P2P music recommendation service 102 may process an optional comment using a machine learning algorithm or artificial intelligence to identify one or more tags that may be germane to the response to be submitted by the responding user. These additional tags may provide further context to the selection of the one or more songs specified in the music recommendation provided by the responding user. Further, the P2P music recommendation service 102 may utilize these identified tags to update any song profiles for the one or more selected songs, one or more tag profiles associated with the identified tags, artist profiles for the artists associated with the one or more selected songs, and a location profile associated with the location from which the music recommendation is being made.

In response to receiving the music recommendation, the P2P music recommendation service 102 may transmit the music recommendation to the requesting user. In an embodiment, the music recommendation is further provided to other users that may have received the music recommendation request from the requesting user. This may allow these other users to evaluate the provided music recommendation and supplement this recommendation if so desired. For instance, another user may provide feedback with regard to the music recommendation submitted by the responding user. Further, these other users may be provided with an option to follow the responding user and obtain songs shared by the responding user in response to music recommendation requests or otherwise shared with its followers.

As music recommendations are provided in response to the music recommendation request from the requesting user, the P2P music recommendation service 102 may present these music recommendations to the requesting user. The requesting user may review any music recommendations received from other users and interact with the provided music recommendations. For instance, a requesting user may initiate playback of each of the provided songs in the music recommendations, individually or continuously. Additionally, the other users that were solicited to provide music recommendations to the requesting user may also initiate playback of any of the songs provided to the requesting user in response to the music recommendation request. For instance, a user that has submitted a music recommendation in response to the music recommendation request may be presented with any other music recommendations provided by other users in response to this request. The user may select any of these provided songs and initiate playback of one or more of these provided songs.

The requesting user may also perform various operations for each recommended song. For instance, a requesting user may save a provided song to a playlist or library. Alternatively, the requesting user may skip the song, submit a reply to the responding user that submitted the song, and/or re-share the song with other followers of the requesting user. In an embodiment, if the requesting user is subscribed to another music service and the requesting user has linked their account with the other music service to their P2P music recommendation service account, and the requesting user has indicated that it wishes to save the song, the P2P music recommendation service 102 may also save the song to an automatically generated playlist maintained by the music service or to specific playlist as specified by the requesting user. Thus, the requesting user may access the saved song through this other music service. Once the requesting user has interacted with a particular response (e.g., has listened to a provided song, has dismissed a provided song, etc.), the P2P music recommendation service 102 may remove the response from the interface. Further, the response provided by the other user may be added to a heard responses window of the interface for the requesting user. In some instances, a response provided within the heard responses window may include any feedback provided by the requesting user, such as a score assigned to a provided song, comments regarding a provided song, whether a provided song has been saved to a requesting user's playlist, recorded audio or video by the requesting user regarding the provided song, and the like.

In some instances, the requesting user may provide one or more responses to their own music recommendation request. For instance, as the requesting user receives one or more recommendations from other users, the requesting user may respond to their own music recommendation request by selecting and submitting one or more songs, comments, or other feedback. The responses submitted by the requesting user may be provided to the responding users. This may facilitate the creation of a playlist for the given music recommendation request, collaboration amongst users in providing appropriate music recommendations, and the like.

In an embodiment, as users 106 share music recommendations with one another and interact with different songs, the P2P music recommendation service 102 tracks these music recommendations and corresponding interactions to dynamically generate different analytics. For instance, as described in greater detail herein, the P2P music recommendation service 102 may implement and dynamically train a set of machine learning systems to generate and update various profiles that may be used to identify music that can be shared by users 106 and to dynamically identify any music recommendation and sharing trends. For instance, the P2P music recommendation service 102 may track interactions amongst users 106 as related to the sharing of songs and to the communications related to music recommendation requests submitted by users 106 (e.g., feedback submitted by users, any additional tags submitted by users, etc.). For example, the P2P music recommendation service 102 may specify, for a given user action (e.g., sharing of a song, submission of a music recommendation request, etc.), any tags associated with the action (e.g., tags associated with a selected song to be shared, tags associated with a music recommendation request, etc.), any feedback provided with regard to the action (e.g., songs provided in response to a request, user interaction with a shared song, etc.), the targets corresponding to the action (e.g., users receiving a music recommendation request, users receiving a shared song, etc.), any songs and/or artists associated with the action (e.g., sample songs and/or artists specified in the submission of a music recommendation request, etc.), the location associated with the action (e.g., location from which a selected song is being shared from, location from which a music recommendation request is being submitted from, etc.), and the like. Further, the P2P music recommendation service 102 may specify, for a given action, information regarding any shared songs (e.g., songs submitted in a music recommendation request to other users, songs received in response to music recommendation request, songs shared with other users, etc.) including, but not limited to, song titles, artists that performed and/or produced the songs, the music genres of the songs, and the like. The P2P music recommendation service 102 may maintain an association of these songs to tags submitted by the users 106 as well.

In an embodiment, a music administrator 104, through the interface 108, can submit a query 110 to the P2P music recommendation service 102 to generate a dynamic promotion corresponding to one or more songs and that may be presented to different users 106 as these users 106 interact with the P2P music recommendation service 102 and with other users. A music administrator 104, in some examples, may be an individual associated with a publisher or distributor of music associated with different artists (e.g., a record label, etc.). In some instances, a music administrator 104 may be a particular artist (e.g., an independent artist, an artist associated with a record label, etc.) whose music may be shared by different users 106 through the P2P music recommendation service 102. As another illustrative example, a music administrator 104 may include an entity that facilitates distribution of music to different audiences (e.g., promoters, entities associated with different venues, entities associated with radio or satellite music stations, etc.).

As illustrated in FIG. 1, the query 110 submitted by a music administrator 104 through the interface 108 may include the name of an artist (i.e., “Golden Vessel”) and of a corresponding song (i.e., “Colorado”) for which a tailored promotion is to be generated. The P2P music recommendation service 102, in response to the query 110, may process the query 110 through a machine learning algorithm or artificial intelligence to identify the song for which new promotions are to be generated. The machine learning algorithm or artificial intelligence may be dynamically trained using supervised, unsupervised, or hybrid training techniques. For instance, a dataset of sample user communications (e.g., known or historical user communications, sample user communications, combinations of known/historical and hypothetical user communications, etc.) and sample songs (e.g., known songs corresponding to the sample user communications, etc.) may be analyzed to identify any correlations between the sample user communications and characteristics of the sample songs (e.g., song names, artists associated with the sample songs, any pseudonyms or aliases corresponding to the songs and/or corresponding artists, etc.). For instance, the machine learning algorithm may be dynamically trained in real-time by converting the sample user communications or messages into a set of communication embeddings and data corresponding to the sample songs into a set of song embeddings. These communication embeddings and song embeddings may be generated according to a set of hyperparameters of the machine learning algorithm or artificial intelligence, which may be dynamically tuned according to the training of the machine learning algorithm or artificial intelligence. The machine learning algorithm or artificial intelligence may classify the sample communications or messages according to one or more vectors of similarity between the set of communication embeddings and the set of song embeddings.

In an embodiment, through the machine learning algorithm or artificial intelligence, the P2P music recommendation service 102 may perform such classification of different requests in real-time or near real-time as these requests are generated by a music administrator 104 through the interface 108. Through this processing of the different requests, the P2P music recommendation service 102 may obtain partial matches among different songs and other known responses to identify the appropriate action to be performed (e.g., generate and provide analytics corresponding to a specified song, provide a response to a query unrelated to a particular song, etc.). Example classification and/or clustering algorithms that may be implemented include Support Vector Machines (SVM), k-Nearest Neighbor (KNN) algorithms, logistic regression algorithm, random forest models, Naïve Bayes models, decision tree models, gradient boosting machine models, and the like.

In an embodiment, as new communications are exchanged through the interface 108, the machine learning algorithm or artificial intelligence implemented by the P2P music recommendation service 102 may dynamically convert the new communications into corresponding embeddings and accordingly perform such classification of the embeddings to obtain partial matches among other classifications according to the one or more vectors of similarity. As noted above, the P2P music recommendation service 102 may maintain a set of song embeddings corresponding to songs for which the P2P music recommendation service 102 maintains different song profiles. Through this process, the machine learning algorithm or artificial intelligence may identify, for each new communication or message received through the interface 108, a particular class and, from this class, identify a response that may be provided through the interface 108 or other action (e.g., generate song analytics for a specified song, prompt the music administrator 104 for more information about a song for which a promotion may be generated, etc.) that may be performed in response to the communication or message.

In an embodiment, if the P2P music recommendation service 102 determines, based on the embeddings corresponding to the submitted query 110, that the submitted query 110 is associated with a particular song (e.g., the vector difference between the set of query embeddings and a set of song embeddings corresponding to the song is within a pre-defined threshold distance, etc.), the P2P music recommendation service 102 dynamically generates and presents a set of song analytics or other metrics corresponding to the particular song. These song analytics or metrics may correspond to user interactions with the song over time. For instance, the song analytics or metrics may include any correlations between different characteristics of the particular song (e.g., song genre, song artist, music label associated with song, etc.) and other artists or songs shared amongst users 106 of the P2P music recommendation service 102. As another illustrative example, the song analytics or metrics may include identification of different tags that may be commonly associated with the song (e.g., tags associated with music recommendation requests for which the song was provided as a recommendation, tags assigned to the song by users 106 when sharing the song, etc.). As yet another illustrative example, the song analytics or metrics may further include any user behaviors associated with the song, as determined through evaluation of comments and tags assigned to the song by different users 106 when sharing or otherwise interacting with the song through the P2P music recommendation service 102. In some instances, the song analytics or metrics associated with a particular song may include demographic information corresponding to the users 106 that have shared or otherwise interacted with the song through the P2P music recommendation service 102 (e.g., age range, location, gender, education level, etc.). It should be noted that the foregoing is not intended to be an exhaustive list of all examples of song analytics or metrics that may be generated by the P2P music recommendation service 102. Rather, the foregoing is intended as illustrative examples of possible song analytics or metrics that may be generated by the P2P music recommendation service 102 in response to a query 110.

In an embodiment, the P2P music recommendation service 102 implements a song profile machine learning algorithm that is dynamically trained to generate analytics or other metrics for different songs shared within the P2P music recommendation service 102 network or otherwise made available to users of the P2P music recommendation service 102 (e.g., songs promoted by artists or other entities associated with the P2P music recommendation service 102, songs performed and/or produced by artists associated with the P2P music recommendation service 102, etc.). The song profile machine learning algorithm may be trained using supervised, unsupervised, or hybrid training techniques. For instance, the song profile machine learning algorithm may be dynamically trained using a dataset of sample music recommendation requests and shared music recommendations (e.g., historical requests and recommendations shared amongst users 106, hypothetical requests and recommendations, combinations of historical and hypothetical requests and recommendations, etc.), corresponding characteristics (e.g., tags provided in the sample requests and recommendations, comments provided in the sample requests and recommendations, user demographics associated with users providing the sample requests and recommendations, etc.), and sample song analytics for the songs corresponding to the sample requests and recommendations. This dataset may be analyzed by the song profile machine learning algorithm to identify any correlations between different songs according to the characteristics of the provided requests and recommendations and, based on these correlations, generate song analytics for these different songs. These song analytics may be compared to the sample song analytics provided in the dataset to identify any inaccuracies or errors.

In some instances, the song profile machine learning algorithm is dynamically trained to classify the different characteristics of music recommendation requests and of shared music recommendations (e.g., tags, comments, sentiments, user demographics, locations, activities, representative songs provided in requests and/or recommendations, etc.) to generate song profiles for different songs. For example, for a particular song, the P2P music recommendation service 102 may automatically record any music recommendation requests and shared music recommendations that include an indication of the particular song (e.g., any comments that mention the song, any requests or recommendations that include the song, etc.). These music recommendation requests and shared music recommendations may be stored within a song profile corresponding to the particular song. In an embodiment, the song profile machine learning algorithm may dynamically process the music recommendation requests and shared music recommendations corresponding to a particular song identify any correlations amongst different characteristics of these requests and recommendations. For instance, based on a set of music recommendation requests and corresponding music recommendations associated with a particular song, the song profile machine learning algorithm may identify the tags associated with the requests and recommendations. The song profile machine learning algorithm may evaluate the frequency of different tags included in the requests and recommendations including the song to identify any correlations amongst these different tags and, accordingly, generate clusters of tags that may be associated with the particular song.

In some instances, different clusters of tags may be associated with different song characteristics that may be used to further generate song analytics for a particular song. In an embodiment, the song profile machine learning algorithm may classify the clusters of tags associated with the particular song (as generated through evaluation of the different requests and recommendations associated with the particular song) according to one or more vectors of similarity between the clusters of tags for the particular song and known tag clusters associated with different song characteristics (e.g., sentiments, activities, cross-genre connections, etc.). As an illustrative example, based on a set of music recommendation requests and music recommendations associated with a particular song, the song profile machine learning algorithm may dynamically identify a set of tags that are frequently associated with the particular song. The song profile machine learning algorithm may process this set of tags and identify different subsets of tags that may correspond to particular known tag clusters according to the one or more vectors similarity. Each of these known tag clusters may be associated with a particular song characteristic (e.g., a particular sentiment, a particular activity, a particular cross-genre connection, etc.) that may be associated with the particular song. Thus, through such clustering of the different tags associated with a particular song, the song profile machine learning algorithm may identify different characteristics of the particular song.

In an embodiment, the song profile machine learning algorithm is further trained to identify correlations between different users and songs shareable through the P2P music recommendation service 102. For instance, for any music recommendation requests and shared music recommendations associated with a particular song, the song profile machine learning algorithm may dynamically retrieve any user profile data corresponding to the users associated with these music recommendation requests and shared music recommendations. This user profile data, for a particular user, may include any available user demographics (e.g., age, gender, education level, employment, etc.), user location, user hobbies, and the like. The song profile machine learning algorithm may process these different user characteristics for the users corresponding to the music recommendation requests and shared music recommendations associated with a particular song to identify any correlations between these different user characteristics and the different characteristics of the particular song. For instance, the song profile machine learning algorithm may evaluate all positive interactions with a particular song to identify the users associated with these positive interactions. The song profile machine learning algorithm may evaluate the user profile data corresponding to these users to obtain corresponding user characteristics and, through clustering of these user characteristics, identify a set of representative user characteristics corresponding to a representative user that may have a positive interaction with the particular song. The characteristics corresponding to this representative user may be added to the song profile for the particular song.

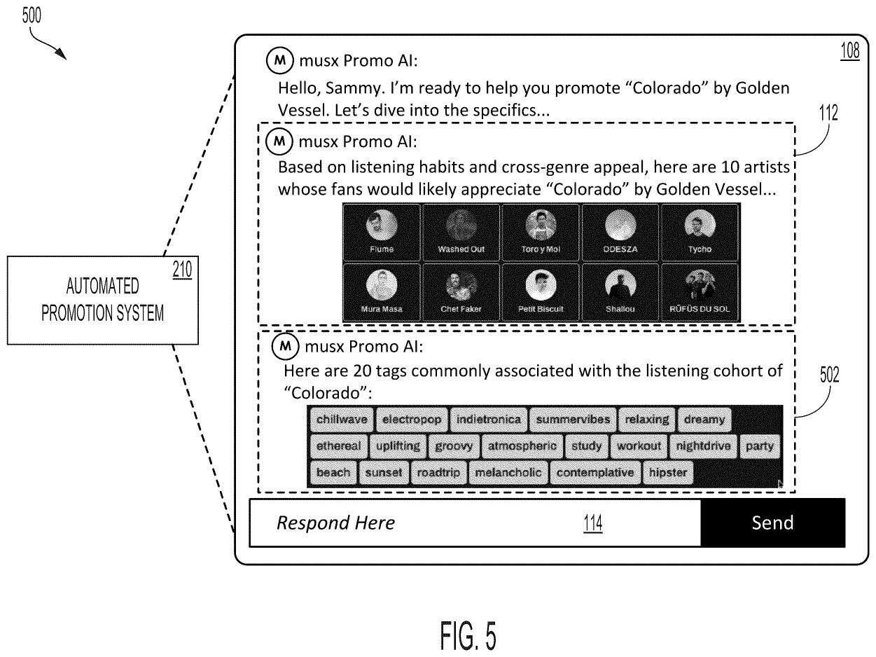

As illustrated in FIG. 1, in response to a user query 110 denoting a particular song, the P2P music recommendation service 102 may automatically update the interface 108 to provide a response 112 that includes a set of analytics or metrics corresponding to the specified song. For example, as illustrated in FIG. 1, the P2P music recommendation service 102, in a response 112, may provide a listing of different artists whose fans, based on listening habits and cross-genre appeal, are likely to appreciate the specified song. This listing of different artists may be generated by the song profile machine learning algorithm described above based on analysis of the song profile corresponding to the song specified in the user query 110 and evaluation of user profile data corresponding to users that previously interacted with the specified song (such as through submitted music recommendation requests and/or through shared music recommendations associated with the specified song). Additionally, as illustrated in FIGS. 5-6 and 7A, the P2P music recommendation service 102 may further provide a music administrator 104, through the interface 108, with the set of tags that are commonly associated with the specified song, a sentiment commonly associated with the specified song, any representative comments provided by users for the specified song, activities commonly associated with the specified song, and characteristics of the representative user that may positively interact with the specified song. The P2P music recommendation service 102 may provide additional insights regarding the specified song according to any additional data provided in the song profile associated with the specified song. In some instances, in the response 112, the P2P music recommendation service 102 may further provide a music administrator 104 with suggestions for different artists, tags, songs, and the like that may be relevant to their user query 110 (e.g., the song indicated in the user query 110, the artist indicated in the user query 110, etc.). This may allow the music administrator 104 to further refine their user query 110 to generate tailored promotion recommendations that may be appealing to user cohorts that may be interested in the original song or artist expressed in the original user query 110 and in the additional artists, songs, or tags indicated by the music administrator 104 in response to the provided suggestions.

In an embodiment, in addition to providing a listing of different artists whose fans are likely to appreciate the specified song, the P2P music recommendation service 102, in the response 112, can provide a listing of different songs that can be recommended with the specified song to different users 106. For instance, based on song profile data corresponding to the specified song and evaluation of user profile data, the P2P music recommendation service 102 may identify other songs that are commonly recommended by users that have previously shared the song specified by the music administrator 104. The P2P music recommendation service 102, through the interface 108, may provide a listing of the most common songs shared by users that previously shared the song specified by the music administrator 104, as well as any other metrics (e.g., sample communications provided when sharing the specified song and the other identified songs, etc.) that may assist the music administrator 104 in identifying correlations amongst the specified song and the songs provided in the listing of songs.

As noted above, a user may provide, in their music recommendation requests, optional comments in the form of text, digital images, recorded video, recorded audio, and the like. Further, a user sharing a song with one or more other users of the P2P music recommendation service 102 may further provide optional comments in the form of text, digital images, recorded video, recorded audio, and the like. In an embodiment, the P2P music recommendation service 102, in the response 112, can provide a listing of text, digital images, recorded video, recorded audio, and the like that are commonly used by users that have positively interacted with the specified song (e.g., users sharing the specified song with others, users saving the specified song to a playlist, etc.).

In an embodiment, if the P2P music recommendation service 102 is unable to identify any data associated with a song indicated in the user query 110, the P2P music recommendation service 102, through the interface 108, can automatically prompt the music administrator 104 to provide information corresponding to artists, songs, and/or tags that may be similar or related to the particular song that the music administrator 104 wishes to promote. If the music administrator 104, in response to this prompt and through the interface 108, provides information corresponding to different artists, songs, and/or tags that may be similar or related to the particular song, the P2P music recommendation service 102 may automatically evaluate a set of analytics or metrics corresponding to the provided information. Further, as described in greater detail herein, the P2P music recommendation service 102 may dynamically generate different promotions corresponding to the original song according to any available characteristics or data corresponding to the sharing of the songs identified according to the music administrator response to the aforementioned prompt (e.g., indicated artists, songs, and/or tags) and to the interactions with these different songs by different users 106.

In an embodiment, through an input field 114 implemented through the interface 108, a music administrator 104 can submit a request to P2P music recommendation service 102 to dynamically generate one or more song promotions for the specified song that may be presented to different users 106 as these users 106 submit music recommendation requests or otherwise interact with the P2P music recommendation service 102. The P2P music recommendation service 102, in an embodiment, implements one or more Large Language Models (LLMs) and/or other generative artificial intelligence processes to dynamically generate different promotions corresponding to different songs according to any available characteristics or data corresponding to the sharing of these different songs and to the interactions with these different songs by different users 106. In response to a request from a music administrator 104 to generate one or more promotion recommendations for a particular song, the P2P music recommendation service 102 may aggregate any available data stored in the song profile corresponding to the specified song. As noted above, this data may include any previously submitted music recommendation requests and shared music recommendations associated with the song. Further, the song profile may include the previously generated song analytics associated with the specified song. In some instances, in addition to obtaining any available data stored in the song profile corresponding to the specified song, the P2P music recommendation service 102 may obtain any available user profile data corresponding to the different users associated with the previously submitted music recommendation requests and shared music recommendations associated with the song. This user profile data for each user, as noted above, may include available user demographics (e.g., age, gender, education level, employment, etc.), user location, user hobbies, and the like.

The one or more LLMs or other generative artificial intelligence processes implemented by the P2P music recommendation service 102 to generate different promotion recommendations for different songs, in some instances, are evaluated to determine whether the one or more LLMs or other generative artificial intelligence processes are accurately leveraging the data from relevant song and user profiles. For instance, the P2P music recommendation service 102 may evaluate the output generated by these one or more LLMs or other generative artificial intelligence processes (e.g., promotion recommendations, related descriptions, related rationales, etc.) to determine whether the one or more LLMs or other generative artificial intelligence processes are identifying appropriate song data for a specified song and appropriate user profile data corresponding to users associated with relevant music recommendation requests and shared music recommendations according to a set of embeddings associated with the particular song indicated by a music administrator 104 (e.g., correctly matching the set of embeddings corresponding to the song to corresponding embeddings associated with the song profile associated with the song). Based on this evaluation, the P2P music recommendation service 102 may dynamically update the one or more LLMs or other generative artificial intelligence processes as described above to improve the likelihood of the one or more LLMs or other generative artificial intelligence processes obtaining the correct data for generating different song promotion recommendations.

In response to a query to generate song promotion recommendations for a particular song, the P2P music recommendation service 102, through the one or more LLMs or other generative artificial intelligence processes and leveraging the historical song profile data and user profile data associated with the particular song, may generate a set of song promotion recommendations for the particular song. For instance, through the one or more LLMs or other generative artificial intelligence processes, the P2P music recommendation service 102 may identify any user cohorts for which tailored song recommendations may be generated. As an illustrative example, based on a cluster of tags commonly associated with the particular song (as identified through the song profile machine learning algorithm described above), the one or more LLMs or other generative artificial intelligence processes may define a user cohort corresponding to a classification of this cluster of tags. For this user cohort, the one or more LLMs or other generative artificial intelligence processes may obtain additional user profile data that may be used to determine whether this user cohort is familiar with the particular song and, accordingly, derive a proposed song promotion that may be appealing to this user cohort. As another illustrative example, the one or more LLMs or other generative artificial intelligence processes may automatically define a user cohort corresponding to users that are familiar with the artist associated with the particular song or with similar artists, as identified through the song profile machine learning algorithm described above. For this user cohort, the one or more LLMs or other generative artificial intelligence processes may dynamically evaluate the user profile data associated with these users to identify any other user characteristics that may be used to define a proposed song promotion that may be appealing to this user cohort. In some instances, through the one or more LLMs or other generative artificial intelligence processes, the P2P music recommendation service 102 may further break down the identified user cohorts into different sub-cohorts according to different characteristics (e.g., locations where users within a user cohort listened to the song, activities engaged in by users within a user cohort while listening to the song, etc.). This may allow the music administrator 104 to further refine the audience for different tailored song promotions. Further, tailored song promotions may be personalized by the P2P music recommendation service 102 (such as through the one or more LLMs or other generative artificial intelligence processes) for different users within a user cohort according to different user parameters (e.g., detected user activity, detected user location, unique idiolect, etc.).

In some instances, through the one or more LLMs or other generative artificial intelligence processes, the P2P music recommendation service 102 may further identify user cohorts according to social parameters such as interaction frequency (e.g., users that routinely share songs with one another), mutual associations (e.g., users that are on personalized friends lists with other users), and the like. This may allow for the creation of proposed song promotions that may be tailored to such user networks defined according to these social parameters.

In an embodiment, for each proposed song promotion recommendation, the one or more LLMs or other generative artificial intelligence processes generate a description of the corresponding user cohort and a reasoning for promoting the song to the user cohort. The description of a user cohort and the corresponding reasoning may be dynamically generated by the one or more LLMs or other generative artificial intelligence processes using one or more knowledge bases corresponding to the user cohorts (as defined by the P2P music recommendation service 102 or through observation over time). For instance, based on a selected user cohort, the one or more LLMs or other generative artificial intelligence processes may identify a knowledge base that includes basic descriptions of the user cohort and basic reasonings for promoting a song to this user cohort. The one or more LLMs or other generative artificial intelligence processes, using the historical song data from the song profile and the user profile data corresponding to users in the selected user cohort, may supplement the basic descriptions and basic reasonings from the knowledge base with such data to generate tailored descriptions and reasonings that are specific to the selected user cohort.

In an embodiment, through the one or more LLMs or other generative artificial intelligence processes, the P2P music recommendation service 102 may identify any tastemakers within the user cohorts for which tailored song recommendations may be generated. As noted above, a tastemaker may be a user of the P2P music recommendation service 102 that is deemed to be qualified to provide relevant music recommendations or otherwise shares music with other users that is of interest to a wide audience. Thus, a tastemaker may have a higher influence on the discovery and enjoyment of different songs by other users. A tailored song promotion recommendation may, thus, identify any tastemakers that are part of the corresponding user cohort. This may help the music administrator 104 to determine whether to accept the tailored song promotion recommendation and provide the tailored song promotion to these identified tastemakers, thereby potentially increasing the exposure of the particular song to a wider audience.

Once the one or more LLMs or other generative artificial intelligence processes have generated tailored song promotion recommendations corresponding to different user cohorts, the P2P music recommendation service 102 may update the interface 108 to present these tailored song promotion recommendations to the music administrator 104. Through the interface 108, the music administrator 104 may review these song promotion recommendations, provide feedback related to these song promotion recommendations, and submit requests to launch any of the song promotions recommended by the P2P music recommendation service 102. Based on any feedback supplied by a music administrator 104 for a particular song promotion recommendation, the P2P music recommendation service 102 may retrain or otherwise update the one or more LLMs or other generative artificial intelligence processes to dynamically generate song promotion recommendations that may be more germane to the particular song and to similar songs.

When a song promotion recommendation is accepted by a music administrator 104, the P2P music recommendation service 102 may deploy the selected song promotion for the particular song. For instance, the P2P music recommendation service 102 may update the song profile associated with the song to incorporate the song promotion such that, in response to a music recommendation request including tags, user profile data, or other information that is associated with the particular song, the song promotion may be presented to the user that submitted the music recommendation request. As another illustrative example, if a user responding to a music recommendation request has selected a song that is similar to the particular song being promoted (e.g., the song has similar tags to those of the promoted song, the song is associated with a similar artist or to the same artist of the promoted song, etc.), the P2P music recommendation service 102 may automatically surface the song promotion to the user. As yet another illustrative example, when a user accesses the P2P music recommendation service 102, the P2P music recommendation service 102 may evaluate the user profile data associated with the user and identify the song promotion based on similarities between song preferences indicated in user profile data and the song profile for the particular song.

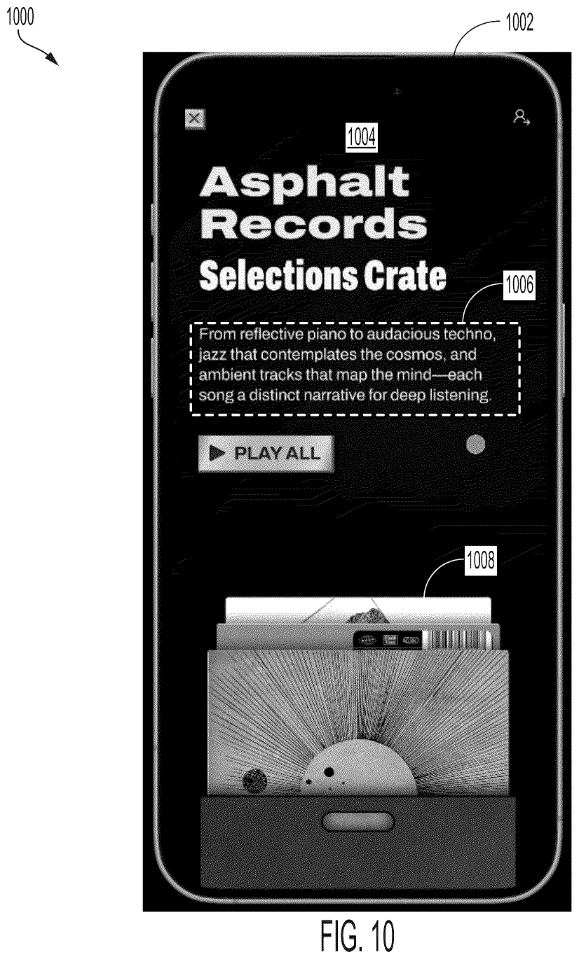

In some instances, if a user interacts with a song promotion deployed by the P2P music recommendation service 102, the P2P music recommendation service 102 may automatically perform additional actions to further provide additional content that may enhance the song promotion. For example, if a user saves a promoted song to a playlist for later listening, the P2P music recommendation service 102 may automatically surface one or more songs by the same artist and/or by other artists that may be associated with the music administrator 104. As another illustrative example, the P2P music recommendation service 102 may automatically redirect the user to a music administrator profile page (such as the music administrator profile page 1004 described herein in connection with FIG. 10) to present the user with other artists and songs that may be associated with the music administrator 104. As another illustrative example, the P2P music recommendation service 102 may automatically surface, to the user exposed to the song promotion, artist information corresponding to the artist associated with the promoted song.

In an embodiment, the P2P music recommendation service 102 dynamically tracks user interactions with presented song promotions to determine the efficacy of these song promotions in increasing user engagement and interaction with the particular song. Based on aggregated data corresponding to these user interactions, the P2P music recommendation service 102 may further retrain or otherwise update the one or more LLMs or other generative artificial intelligence processes trained to dynamically generate song promotion recommendations according to song profile data and user profile data. For instance, if a particular promotion launched by the P2P music recommendation service 102 does not result in increased user interaction with a promoted song amongst a particular user cohort, the P2P music recommendation service 102 may annotate the data point corresponding to the song promotion created for this user cohort to indicate that the song promotion was not appealing for the user cohort (including any feedback provided by users of user cohort). This data point may cause the P2P music recommendation service 102, for similar songs and user cohorts, to adjust the proposed song promotion recommendations according to the obtained feedback.

In an embodiment, the P2P music recommendation service 102 allows music administrators (such as music administrator 104) to submit, through the interface 108, a user query 110 denoting a particular song that has not been released to the public (i.e., not yet shareable by users 106 of the P2P music recommendation service 102) but that the music administrator 104 would like to promote through vetted tastemakers. As noted above, a tastemaker may be a user of the P2P music recommendation service 102 that is deemed to be qualified to provide relevant music recommendations or otherwise shares music with other users that is of interest to a wide audience. In the user query 110, the music administrator 104 may indicate that, for the unreleased song, the song recommendations that are to be generated are to only target different tastemakers and not other users of the P2P music recommendation service 102. Further, the music administrator 104 may indicate that the unreleased song cannot be shared with other users and, thus, can only be accessed by different tastemakers for their review and feedback. Accordingly, through the processes and techniques described herein, the P2P music recommendation service 102 may evaluate any information associated with the particular song (e.g., song genre, song tags as designated by the music administrator 104, etc.) and user profile data corresponding to vetted tastemakers to identify one or more tastemakers that may be targeted for feedback with regard to the unreleased song.

In an embodiment, the P2P music recommendation service 102 further allows music administrators to promote specific music recommendation requests to users 106 of the P2P music recommendation service 102 that may be relevant to different songs associated with a particular artist. Through the processes and techniques described herein, the P2P music recommendation service 102 may process the music recommendation requests that are to be promoted to identify a set of tags that may be associated with these requests. Based on the tag profiles associated with these identified tags and user profiles corresponding to different users of the P2P music recommendation service 102 to identify one or more user cohorts to which these music recommendation requests may be promoted. Through promotion of these music recommendation requests, users within these user cohorts may be more likely to be exposed to particular songs associated with the music administrator 104.

In an embodiment, the P2P music recommendation service 102 further allows music administrators (such as music administrator 104) to submit, through the interface 108, a request to obtain a set of media analytics corresponding to a particular artist and, based on this set of media analytics, a set of recommendations corresponding to different songs associated with the artist that may be promoted to different users of the P2P music recommendation service 102 to increase artist exposure to these users. For instance, a music administrator 104, through the interface 108, may submit a request to the P2P music recommendation service 102 to generate a dynamic promotion corresponding to an artist and that may be presented to different users 106 as these users 106 interact with the P2P music recommendation service 102 and other users. The P2P music recommendation service 102, in response to this request, may dynamically process the request to promote a particular artist through a machine learning algorithm or artificial intelligence to identify the artist for which new promotions are to be generated.

In an embodiment, the machine learning algorithm or artificial intelligence converts the request into a set of embeddings that may be classified to obtain partial matches among other classifications corresponding to one or more artist embedding vectors. These one or more artist embedding vectors may correspond to known artists for which artist profiles are maintained by the P2P music recommendation service 102. As described in greater detail herein, the P2P music recommendation service 102 may implement an artist profile machine learning system that uses a music link database to track any tags and comments used by users when sharing, requesting, saving, and otherwise interacting with different songs by different artists. Further, for a particular artist, the artist profile machine learning system may evaluate the user profiles of users that react positively to the artist's music to identify which other artists these users may also react positively to. This may result in the discovery of possible relationships or correlations amongst artists that may be used to group artists for user recommendations, discovery of different user cohorts for the promotion of different songs, for cross promotional ventures between artists, and the like.

In an embodiment, if the P2P music recommendation service 102 determines, based on the embeddings corresponding to the submitted artist-related request, that the submitted request is associated with a particular artist, the P2P music recommendation service 102 dynamically generates and presents, through the interface 108, a set of artist analytics or other metrics corresponding to the particular artist. These artist analytics or metrics may correspond to user interactions with different songs associated with the artist over time. For instance, the artist analytics or metrics may include any correlations among different characteristics of the particular artist and their songs (e.g., artist genre(s), music label(s) associated with artist, etc.) and other artists or songs shared amongst users 106 of the P2P music recommendation service 102. As another illustrative example, the artist analytics or metrics may include identification of different tags that may be commonly associated with the artist (e.g., tags associated with music recommendation requests for which songs associated with the artist were provided as recommendations, tags assigned to the artist's songs by users 106 when sharing these songs, etc.). As yet another illustrative example, the artist analytics or metrics may further include any user behaviors associated with songs by the artist, as determined through evaluation of comments and tags assigned to the songs by different users 106 when sharing or otherwise interacting with the artist's songs through the P2P music recommendation service 102. In some instances, the artist analytics or metrics associated with a particular artist may include demographic information corresponding to the users 106 that have shared or otherwise interacted with the artist's songs through the P2P music recommendation service 102 (e.g., age range, location, gender, education level, etc.). It should be noted that the foregoing is not intended to be an exhaustive list of all examples of artist analytics or metrics that may be generated by the P2P music recommendation service 102. Rather, the foregoing is intended as illustrative examples of possible artist analytics or metrics that may be generated by the P2P music recommendation service 102 in response to a query 110.

In an embodiment, in response to the request to obtain a set of media analytics corresponding to a particular artist, the P2P music recommendation service 102 may update the interface 108 to provide a response that includes a set of analytics or metrics corresponding to the artist. In some instances, the set of analytics or metrics may further correspond to different songs associated with the artist. For example, the P2P music recommendation service 102, in a response provided through the interface 108, may provide a listing of different artists whose fans, based on listening habits and cross-genre appeal, are likely to appreciate the specified artist. This listing may be further broken down according to the different songs associated with the artist, as these different songs may have different characteristics (e.g., genres, etc.) and, thus, may appeal to different audiences. This listing of different artists may be generated by the artist profile machine learning algorithm in conjunction with the song profile machine learning algorithm described above based on analysis of the artist profile corresponding to the specified artist, song profiles corresponding to the different songs associated with the artist, and evaluation of user profile data corresponding to users that previously interacted with the different songs associated with the artist (such as through submitted music recommendation requests and/or through shared music recommendations associated with the different songs associated with the artist). Additionally, the P2P music recommendation service 102 may further provide a music administrator 104, through the interface 108, with the set of tags that are commonly associated with the specified artist, a sentiment commonly associated with the specified artist, any representative comments provided by users for the specified artist and the artist's songs, activities commonly associated with the specified artist's songs, and characteristics of the representative user that may positively interact with different songs by the artist. The P2P music recommendation service 102 may provide additional insights regarding the specified artist according to any additional data provided in the artist profile associated with the specified artist and in the song profiles corresponding to the different songs associated with the artist.

In an embodiment, the P2P music recommendation service 102 can further dynamically generate one or more artist promotions for the specified artist that may be presented to different users 106 as these users 106 submit music recommendation requests or otherwise interact with the P2P music recommendation service 102. Similar to the process described above for generating song promotions for specific songs, the P2P music recommendation service 102, through the one or more LLMs or other generative artificial intelligence processes, may leverage the historical artist profile data corresponding to the specified artist, the song profile data corresponding to the songs associated with the artist, and the user profile data corresponding to the artist and the artist's songs to generate a set of artist promotion recommendations for the particular artist. An artist promotion may be tailored to incorporate different song recommendations for songs associated with the artist that may be appealing to recipients of the artist promotion. For instance, the one or more LLMs or other generative artificial intelligence processes may define different user cohorts corresponding to different clusters of tags that may be associated with the artist and with the songs associated with the artist. For each user cohort, the one or more LLMs or other generative artificial intelligence processes may obtain additional user profile data that may be used to identify which of the artist's songs may be appealing to this user cohort and based on this identification of songs, craft a tailored artist promotion that incorporates these songs. Further, for each proposed artist recommendation, the one or more LLMs or other generative artificial intelligence processes generate a description of the corresponding user cohort and a reasoning for promoting the artist and the selected songs to the user cohort. This process of generating this description may be similar to the process for generating descriptions for each proposed song promotion recommendation described above.

In an embodiment, the P2P music recommendation service 102 further allows music administrators to promote different events that may be associated with different artists whose songs are shared by users 106 through the P2P music recommendation service 102. Similar to the process described above for generating artist promotion recommendations for a particular artist, the P2P music recommendation service 102 may identify different user cohorts to which the event may be appealing. For instance, based on the location of the event and the artists involved in the event, the P2P music recommendation service 102, through the one or more LLMs or other generative artificial intelligence processes described herein, may leverage the historical artist profile data corresponding to the artists associated with the event, location profile data corresponding to the location of the event, song profile data corresponding to the songs associated with the artists participating in the event, and the user profile data corresponding to the artists, the artist's songs, and the location of the event to generate a set of event promotion recommendations for the particular event. An event promotion may be tailored to incorporate event information (including information corresponding to the artists participating in the event) that may be appealing to recipients of the event promotion. For instance, the one or more LLMs or other generative artificial intelligence processes may define different user cohorts corresponding to different clusters of tags that may be associated with artists and with songs associated with these artists. For each user cohort, the one or more LLMs or other generative artificial intelligence processes may obtain additional user profile data that may be used to identify which artists may be appealing to this user cohort and based on this identification of artists, craft a tailored event promotion that incorporates these artists. Further, for each proposed event recommendation, the one or more LLMs or other generative artificial intelligence processes generate a description of the corresponding user cohort and a reasoning for promoting the event to the user cohort. This process of generating this description may be similar to the process for generating descriptions for each proposed song promotion recommendation described above.

In an embodiment, the P2P music recommendation service 102 can automatically monitor user interactions with different songs shared through the P2P music recommendation service 102 to detect any real-time spikes in activity related to any of these songs. If the P2P music recommendation service 102 detects, for a particular song, a spike in activity (e.g., significant user interactions with the song, etc.), the P2P music recommendation service 102 may automatically transmit a notification to a music administrator 104 associated with the particular song to indicate that this spike in activity has been detected and automatically generate and provide the music administrator 104 with tailored song promotion recommendations for different user cohorts and that may be implemented to further amplify the song. As an illustrative example, if the P2P music recommendation service 102 detects that the song “Colorado” by Golden Vessel is being shared amongst users 106 at a higher frequency than average during Memorial Day weekend, the P2P music recommendation service 102 may automatically transmit a notification to the music administrator 104 to indicate that this song is currently trending within the network. Accordingly, the music administrator 104 may access the interface 108 and the P2P music recommendation service 102, through the one or more LLMs or other generative artificial intelligence processes, may automatically generate one or more song promotion recommendations for different song promotions that may be presented to different user cohorts. This may assist the music administrator 104 in capitalizing on this identified trend and maximize exposure of the song to a wider audience.

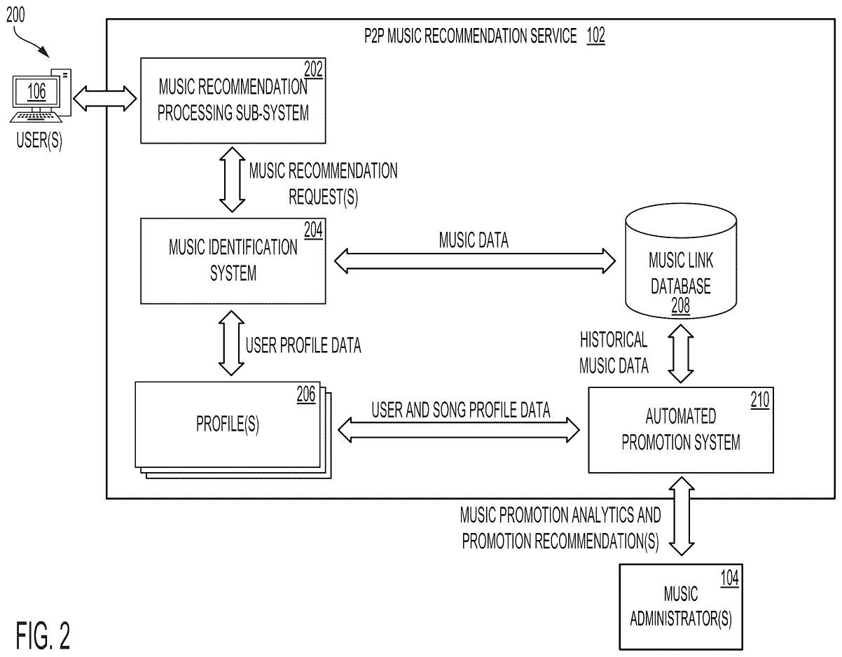

FIG. 2 shows an illustrative example of an environment 200 in which a P2P music recommendation service 102 processes incoming music sharing and music recommendation requests for different users and generates different media analytics for creation of tailored media promotions in accordance with at least one embodiment. In the environment 200, a user 106 of the P2P music recommendation service 102 submits a request to a music recommendation processing sub-system 202 to share one or more songs with other users of the P2P music recommendation service 102. A user 106 of the P2P music recommendation service 102 may access the P2P music recommendation service 102 via an application provided by the P2P music recommendation service 102 and installed on a computing device (e.g., smartphone, computer, etc.), through which the user 106 may submit the music sharing request to the music recommendation processing sub-system 202. The user 106 may alternatively access the P2P music recommendation service 102 via a website provided by the P2P music recommendation service 102.

In some instances, the P2P music recommendation service 102 may provide access to the service via a smart speaker or other device (e.g. Internet-of-Things (IoT) devices, smart hubs, smartphones, smart watch, smart television, smart car player etc.) through which a user 106 may interact with the P2P music recommendation service 102 via voice commands. For example, a user 106 may issue a voice command to a smart speaker or other device to access the P2P music recommendation service 102. Further, once such access is established via the smart speaker or other device, the user 106 may issue additional voice commands to submit music sharing requests and/or to perform other functions made available to the user 106 by the P2P music recommendation service 102, as described herein. In some instances, a user 106 may issue a voice command to a virtual assistant implemented on a smartphone or other computing device to interact with the P2P music recommendation service 102 via voice commands.

In some instances, the P2P music recommendation service 102 may provide access to the service via a module or application implemented on an alternative service. For instance, an alternative music streaming service may implement a module, application, or other functionality that enables users to access the P2P music recommendation service 102. As an illustrative example, if a user is listening to a particular song via an alternative music streaming service, and the alternative music streaming service provides the user with access to the P2P music recommendation service 102 via a module implemented by the alternative music streaming service (e.g., an icon corresponding to the module presented via an interface of the alternative music streaming service, etc.), the user may utilize the module to access the P2P music recommendation service 102. Through the module, the user may initiate a request to share the particular song with a set of other users or to obtain music recommendations based on the particular song from the set of other users, which may then be transmitted from the alternative music streaming service to the P2P music recommendation service 102. The user may continue to interact with the particular song via the alternative music service while awaiting responses from the set of other users.

The P2P music recommendation service 102, in some instances, provides a user 106 with an interface through which the user 106 may submit a music sharing request to the music recommendation processing sub-system 202. For instance, via the interface, a user 106 may select an option to initiate a request to share a song with one or more other users (e.g., followers of the user 106, etc.) of the P2P music recommendation service 102. If the user 106 selects this option, the music recommendation processing sub-system 202 of the P2P music recommendation service 102 may detect selection of this option and update the interface to present the user 106 with a song query bar, through which the user 106 may submit a query for a particular song that is to be shared to a selected set of other users of the P2P music recommendation service 102. The music recommendation processing sub-system 202 may be implemented using a computer system or utilizing an application implemented using a computer system of the P2P music recommendation service 102.

In an embodiment, the music recommendation processing sub-system 202 evaluates, from a set of profiles 206, the user profile of the user 106 to identify a set of followers (e.g., other users of the P2P music recommendation service 102 that may be following the user 106, etc.) of the user 106. For each of these followers, the music recommendation processing sub-system 202 may identify the types of music that a follower is requesting at a given time. The music recommendation processing sub-system 202 may present, via the interface, each of the follower requests and the types of music that each follower is looking for. This may guide the user 106 in identifying what songs to share with the other users of the P2P music recommendation service 102. In some instances, the music recommendation processing sub-system 202 may further identify any public music recommendation requests that may be fulfilled by the user 106. As noted above, when a requesting user opts to submit a music recommendation request to the public, the P2P music recommendation service 102 may automatically select different users to solicit responses for the music recommendation request. These different users may be automatically selected based on music recommendations previously provided in response to requests having similar tags or other characteristics to those of the submitted public request. As another illustrative example, the P2P music recommendation service 102 may automatically select a set of users that have previously submitted similar music recommendation requests and have received relevant responses from other users of the P2P music recommendation service 102. In some instances, the P2P music recommendation service 102 may automatically select one or more users based on a score that is indicative of each user's performance with regard to the quality of recommendations provided in response to music requests having similar parameters (e.g., tags, characteristics, etc.) to those of the music recommendation request submitted by the user. Thus, in some instances, the music recommendation processing sub-system 202 may automatically provide the user 106 with one or more public music recommendation requests for which the user 106 has been selected to provide a music recommendation based on any of the criteria described above.

If the user 106 submits, via the song query bar, a query for a particular artist or song, the music recommendation processing sub-system 202 may transmit the query to a music identification system 204 of the P2P music recommendation service 102 to identify any songs that satisfy the query. The music identification system 204 may be implemented using a computer system or utilizing an application implemented using a computer system of the P2P music recommendation service 102. In an embodiment, in response to the query, the music identification system 204 accesses a music link database 208 of the P2P music recommendation service 102 to determine whether any songs that may satisfy the query have been previously identified by the P2P music recommendation service 102. For instance, the music link database 208 may include a cache of previously submitted queries and corresponding songs identified in response to these queries. Additionally, or alternatively, the music link database 208 may include a library of known artists and songs, each of which may be associated with a set of keywords or expressions that may be used to determine whether an artist or song satisfies a submitted query. If the music identification system 204 identifies, from the music link database 208, any artists or songs responsive to the query, the music identification system 204 may provide these artists and songs to the user 106. It should be noted that, in some instances, contemporaneous queries may be conducted as the user 106 enters one or more characters into the song query bar. Thus, as the user 106 enters one or more characters into the song query bar, the P2P music recommendation service 102 may identify any artists and/or songs that may be associated with the entered one or more characters. As the user 106 changes the characters entered into the song query bar, the P2P music recommendation service 102 may update its query results, which are provided to the user 106 in real-time or near real-time.

In an embodiment, if the music link database 208 does not include entries associated with artists or songs that may be used to fulfill the submitted query, the music identification system 204 submits the query to one or more music services to identify network locations of the one or more external music services (not shown) that may include artists and songs that satisfy the submitted query. For example, the music recommendation processing sub-system 202 may present to the user 106, a song query bar that is specific to a particular music service. When the user 106 submits a query via the song query bar, the music recommendation processing sub-system 202, via the music identification system 204, may transmit the query to the corresponding music service, which may process the query and identify any songs and artists that may satisfy the query. The music service may provide, in response to the query, identifying information of the identified songs, as well as a network address for each identified song through which the identified song may be accessed. This may cause the music recommendation processing sub-system 202 to present, for each identified song, identifying information of the song (e.g., song title, artist name, music genre, etc.) and a method for accessing the song via the music service. If the user 106 performs these operations, the music recommendation processing sub-system 202 may utilize the network address provided by the music service for the song to provide the user 106 with access to the song.

In an embodiment, query results may be presented for each music service, whereby the query results may be delineated based on the music service that provided the results. Thus, the user 106 may select different results from different music services corresponding to the same song that is to be shared with other users of the P2P music recommendation service 102. In some instances, the user 106 may select which music services may be utilized for obtaining the song that is to be shared with other users. Thus, the user 106 may not be required to submit a query to each available music service. Further, in some instances, rather than selecting different results from different music services, the user 106 may select a single result. This may cause the music recommendation processing sub-system 202 to identify the different results from the different music services corresponding to the single result selected by the user 106.

In some instances, the music recommendation processing sub-system 202 allows the user 106 to access their playlists or song libraries from one or more music services via an interface of the P2P music recommendation service 102. The user 106 may select, from their playlists or song libraries, a song that is to be shared with other users of the P2P music recommendation service 102. The music recommendation processing sub-system 202 may utilize this selection to identify a network location of the selected song, from which the selected song may be accessed from within the network of a music service.

Once the user 106 has selected a song that is to be shared with other users of the P2P music recommendation service 102 (e.g., selection of different results from different music services for a particular song, etc.), the music recommendation processing sub-system 202 may present a listing or other ordering of followers and other users (e.g., users that submitted public requests received by the user 106, etc.) to which the selected song may be shared. In some instances, the music recommendation processing sub-system 202 may indicate, for each follower or other user, the music services that the follower or other user may be a member of. This may guide the user 106 in determining which followers or other users to select, as the different results selected by the user 106 may be from music services that a particular follower or other user is not a member of. In an embodiment, the music recommendation processing sub-system 202 provides additional information for each follower or other user to indicate whether the follower or other user is likely to have a favorable reaction to the selected song. For instance, for each follower or other user, the music recommendation processing sub-system 202 may access, from the set of profiles 206, a profile of the follower or other user to identify what types of music the follower or other user is known to enjoy versus other types of music the follower or other is known to dislike or is otherwise agnostic to.

In some instances, the music recommendation processing sub-system 202 enables the user 106 to record a voice or video caption, provide a text comment, and/or provide digital images (e.g., GIFs, JPEGs, BMPs, etc.) that can be included with the shared song. This may provide additional context about the user's selection of the song that is being shared with the selected followers and/or other users. Further, the music recommendation processing sub-system 202 enables the user 106 to schedule when the song is to be shared with the selected followers or other users. For instance, a user 106 may specify a given time at which the song is to be shared.

In some instances, the user 106 may specify a location from which the song is to be shared. Thus, the music recommendation processing sub-system 202 may continuously monitor the user's location (subject to the user's granting of permission to the P2P music recommendation service 102 to monitor the user's location) to determine whether the user 106 is at the specified location and, if so, share the selected song with the followers and/or other users indicated by the user 106. The selected song may be shared with a follower or other user once it is detected that the follower or other user is at the specified location. For instance, if the P2P music recommendation service 102 obtains, from a computing device associated with a follower or other user, geolocation data corresponding to the location specified by the user 106, the P2P music recommendation service 102 may present the selected song to the follower or other user at the specified location.

In an embodiment, the music recommendation processing sub-system 202 enables the user 106 to assign one or more tags to the song that is to be shared with the selected users. These tags may be selected from a set of pre-defined tags generated by the P2P music recommendation service 102. Alternatively, the user 106 may define a unique set of tags for the song that is to be shared with other users. The selected tags may provide additional context with regard to the song shared by the user 106. In an embodiment, the user's selection of a set of tags for a particular song is used by the music identification system 204 to update, from the set of profiles 206, a song profile of the song to increase the association between the song and the selected tags. Further, the tag profiles for each of the selected tags, from the set of profiles 206, may be updated such that the likelihood of these tags being presented whenever the song is shared or accessed is increased. In some instances, when the user 106 selects a song that is to be shared with other users, the P2P music recommendation service 102, through the music recommendation processing sub-system 202, may automatically identify any tags that are associated with the selected song and present these tags to the user 106. For instance, when the user 106 selects one or more songs that are to be shared with different users, the music identification system 204 may query the set of profiles 206 to identify the song profiles corresponding to these one or more songs. From these song profiles, the music identification system 204 may identify any tags that are associated with the one or more songs and present these tags to the user 106.

In an embodiment, the music recommendation processing sub-system 202 further associates the one or more songs that are to be shared with the selected set of followers and/or other users with a location from which the one or more songs are being shared from. For instance, the music recommendation processing sub-system 202 may identify the user's location and associate this location with the one or more songs that are being shared. This association may be used to update a location profile specific to the location from which the one or more songs are being shared such that the P2P music recommendation service 102 may utilize the location profile to indicate what types of songs and artists are shared from a particular location by users of the P2P music recommendation service 102. The P2P music recommendation service 102 may track which users, artists, songs, and tags each location is associated with, as well as the actions taken by users at the location (e.g., skipping songs, saving songs, feedback provided about songs shared from the location, requests submitted from the location, etc.).

Once the user 106 has completed generating the share request (e.g., selected one or more songs to be shared and the set of users that are to receive the song, selected the tags that are associated with the one or more songs, provided any comments to be included with the one or more songs, etc.), the music recommendation processing sub-system 202 may transmit information associated with the selected one or more songs to the selected users. This information may include the name of each song being shared, the artist associated with each song being shared, the tags associated with each song being shared, any comments provided by the user 106, the location from which the one or more songs was shared, a network locations from which the one or more songs may be retrieved, and the like. The P2P music recommendation service 102 may notify each user specified by the user 106 of the one or more songs being shared by the user 106. A recipient user, via the P2P music recommendation service 102, may access and interact with any of the shared one or more songs as desired. For instance, a recipient user may initiate playback of a song or save a song to their own playlist or library. Alternatively, a recipient user may dismiss or skip a shared song. Further, a recipient user may re-share one or more songs with other users of the P2P music recommendation service 102 (e.g., their followers, etc.) via the music recommendation processing sub-system 202 and/or reply to the user 106 by providing feedback with regard to the one or more shared songs.

In an embodiment, the music recommendation processing sub-system 202 monitors user interaction with any shared songs to generate a set of metrics for the shared songs. For instance, based on feedback provided by the users to which a shared song was provided (e.g., any actions taken with regard to the shared song, comments provided in response to the shared song, etc.), the music recommendation processing sub-system 202 may determine whether the shared song was received positively or negatively by the selected users. Further, the music recommendation processing sub-system 202 may indicate to the user 106 which other users have heard the song (e.g., have listened to the song for at least a minimum amount of time, have re-shared the song with other users, have saved the song to a playlist, have replied to the user 106 in response to having received the song, etc.) and which users have skipped the song (e.g., have dismissed the song, have listened to the song less than the minimum amount of time, etc.). These metrics may be used to update profiles, from the set of profiles 206, associated with the shared song, artist that performed and/or produced the shared song, the users that received the shared song, and the tags assigned to the shared song. For instance, if other users indicate that the specified tags are not relevant to the shared song, the music identification system 204 may update, from the set of profiles 206, the song profile and any corresponding tag profiles to reduce the association between the song and these tags. The music identification system 204 may further update a user profile corresponding to the recipient user based on the recipient user's response to the song, whereby a positive reaction of the song may result in the recipient user's profile being updated to indicate a preference for the song and other similar songs (e.g., songs of the same genre, songs by the same artist, etc.).

In an embodiment, a user receiving a shared song can update or add tags to the shared song. These tags may be selected from a set of pre-defined tags generated by the P2P music recommendation service 102. Alternatively, the recipient user may define a unique set of tags for the shared song. The recipient user's selection of a set of tags for the received song may be used by the music identification system 204 to update, from the set of profiles 206, a song profile of the song to increase the association between the song and the selected tags. Further, the tag profiles for each of the selected tags, from the set of profiles 206, may be updated such that the likelihood of these tags being presented whenever the song is shared or accessed is increased.

The music recommendation processing sub-system 202 may further process incoming requests from users of the P2P music recommendation service 102 to obtain music recommendations from other users. The music recommendation processing sub-system 202, in response to a request from a user 106 to obtain music recommendations from other users, may provide the user 106 with various options for selecting a set of tags that are to be provided in the music recommendation request. For instance, the music recommendation processing sub-system 202 may provide a user 106 with a tag query bar, through which the user 106 may submit a query for available tags that can be incorporated into the music recommendation request. The music recommendation processing sub-system 202 may provide this query to the music identification system 204, which may evaluate a set of tag profiles from the set of profiles 206 to identify and present any tags that may satisfy the query. In some instances, the music recommendation processing sub-system 202 may provide, to the user 106, a set of popular tags that may be incorporated into the music recommendation request. In an embodiment, if the user 106 selects, from the set of popular tags, a first tag that may be incorporated into the music recommendation request, the music recommendation processing sub-system 202 provides the user 106 with a set of tags that are associated with the first tag. For instance, each tag may be associated with one or more other tags that may be commonly used in conjunction with the tag.

The set of popular tags that may be presented to the user 106 may be selected based on various factors. For instance, the music recommendation processing sub-system 202 may determine, based on the present location of the user 106, which tags are most commonly selected by users of the P2P music recommendation service 102 at the present location. Similarly, the music recommendation processing sub-system 202 may determine, based on the time at which the music recommendation request is being submitted, which tags are most commonly selected at that time. Thus, the set of popular tags presented to the user 106 by the music recommendation processing sub-system 202 may differ based on these various factors.

As noted above, the P2P music recommendation service 102 may implement a NLP model that is dynamically trained to automatically identify a set of tags from music recommendation requests submitted by users 106 of the P2P music recommendation service 102. This NLP model may be implemented through the music recommendation processing sub-system 202. The NLP model may process, in real-time and as a user 106 submits a new music recommendation request, any terms associated with the music recommendation request to identify any tags that may be associated with the request. The P2P music recommendation service 102 may present these tags to the user 106 in addition to any other tags previously selected by the user. The user may evaluate these suggested tags and determine whether to incorporate any of the identified tags into their music recommendation request or omit these suggested tags.

In some instances, a user 106 may define or otherwise add new tags and assign these new tags to the request. For example, the music recommendation processing sub-system 202 may provide the user 106 with an option to define new tags that may otherwise not be available or present in the aforementioned tag profiles. If the user 106 defines or otherwise adds new tags to the request, the music recommendation processing sub-system 202 may generate a set of tag profiles corresponding to the newly defined tags and add this new set of tag profiles to the set of profiles 206. The newly defined tags may further be associated with the request and with any songs shared with the user 106 in response to their music recommendation request, as described herein.

In some instances, the user may provide, in addition to their request, optional comments in the form of text, digital images (e.g., GIFs, JPEGs, BMPs, etc.), recorded video, recorded audio, and the like. These optional comments may provide additional context about the music recommendation request. Any optional comments provided by the user 106 may be evaluated using the NLP model to identify any additional tags that may be included with the request or used to replace previously selected tags for the request. The user 106 may evaluate these identified tags and determine whether to incorporate any of the identified tags into their music recommendation request or omit these suggested tags.

In some instances, the user 106 may further identify one or more other users and/or tastemakers that are to be provided with the music recommendation request to solicit music recommendations from these one or more other users and/or tastemakers. For instance, the music recommendation processing sub-system 202 may access, from the set of profiles 206, a user profile of the user 106 to identify any other users that are associated with the user 106. Further, the music recommendation processing sub-system 202 may evaluate the parameters of the request (e.g., selected tags, comments provided by the user 106, etc.) and the set of profiles 206 to identify any tastemakers that may provide relevant recommendations in response to the request. A tastemaker may be a user of the P2P music recommendation service 102 that is deemed to be qualified to provide relevant music recommendations or otherwise shares music with other users that is of interest to a wide audience. In some instances, the music recommendation processing sub-system 202 may query, based on the selected set of tags, the set of profiles 206 to identify any other users and/or tastemakers that are likely to provide a positive recommendation in response to the request. For instance, a user profile may specify the tags corresponding to requests previously responded to by the corresponding user and any feedback associated with the responses to these requests. Based on this feedback, the music recommendation processing sub-system 202 may determine whether a user is likely to provide a positive music recommendation to the requesting user 106.

In some instances, the user 106 may select an option to make the music recommendation request publicly available, whereby anyone with access to the music recommendation request may provide a music recommendation in response to the request. If the user 106 selects this option, the music recommendation processing sub-system 202 may automatically surface the music recommendation request to any number of other users of the P2P music recommendation service 102 to solicit music recommendations responsive to the request. In some instances, the music recommendation processing sub-system 202 may evaluate the parameters of the request (e.g., selected tags, comments provided by the user 106, etc.) and the set of profiles 206 to identify a set of users that are likely to provide music recommendations in response to the music recommendation request. This set of users may include one or more users that have not previously interacted with the user 106. In an embodiment, the set of users are selected based on historical data corresponding to requests previously submitted by these users, music recommendations provided by these users, music interactions performed by these users, music preferences associated with these users, and the like. For example, if the user 106 is known to have a preference for Scandinavian melodic metal music and the music recommendation request includes tags and/or comments associated with a desire for music recommendations related to Scandinavian melodic metal music, the music recommendation processing sub-system 202 may evaluate the set of profiles 206 to identify any user profiles corresponding to users that have similar interests in Scandinavian melodic metal music and that have previously responded to similar music recommendation requests (e.g., requests having similar tags, requests for which similar types of music were shared, etc.). When a selected user accesses the P2P music recommendation service 102, the music recommendation processing sub-system 202 may automatically surface the public request to solicit a response from the selected user.

In an embodiment, the public users to which the music recommendation request is to be provided are selected through a machine learning algorithm or artificial intelligence implemented by the music recommendation processing sub-system 202. The machine learning algorithm or artificial intelligence may be dynamically trained using a dataset of sample music recommendation requests (e.g., historical requests, hypothetical requests, combinations of historical and hypothetical requests, etc.) and corresponding sample user profiles (e.g., actual users, hypothetical users, combinations of actual users and hypothetical users, etc.) to select, from a pool of sample users, an appropriate set of users that may be solicited to provide responses to the sample music recommendation requests. To dynamically train this machine learning algorithm or artificial intelligence, the music recommendation processing sub-system 202 may generate an initial iteration of the machine learning algorithm or artificial intelligence. For instance, the music recommendation processing sub-system 202 may initialize a set of coefficients or hyperparameters randomly according to a Gaussian or non-Gaussian distribution. Using this initial iteration of the machine learning algorithm or artificial intelligence, the music recommendation processing sub-system 202 may process the dataset of sample music recommendation requests and corresponding sample user profiles to generate an output. This output may specify, for each sample music recommendation request included in the dataset, a predicted set of sample users that may be likely to provide a relevant response to the sample request or that otherwise may be interested in the sample request. The music recommendation processing sub-system 202 may compare the predicted set of sample users generated using the initial iteration of the machine learning algorithm or artificial intelligence to the sample users defined in the dataset for each of the data points (e.g., sample music recommendation requests) to identify any inaccuracies or other errors.

If the output of the machine learning algorithm or artificial intelligence does not satisfy one or more criteria, the music recommendation processing sub-system 202 may iteratively update one or more coefficients of the set of coefficients to generate a new iteration of the machine learning algorithm or artificial intelligence. This new iteration of the machine learning algorithm or artificial intelligence may be used to process the aforementioned training dataset, as well as any additional data points or other datasets obtained by the P2P music recommendation service 102 to generate a new output for each data point in the training dataset. The music recommendation processing sub-system 202 may use this new iteration of the machine learning algorithm or artificial intelligence to process the available data points and generate a new output (e.g., sample users for a sample music recommendation request). The music recommendation processing sub-system 202 may evaluate this new output to determine whether the output satisfies the one or more criteria. This process of updating the set of coefficients associated with the machine learning algorithm or artificial intelligence according to the one or more criteria may be performed iteratively until an iteration of the machine learning algorithm or artificial intelligence is produced that satisfies the one or more criteria.

The machine learning algorithm or artificial intelligence trained by the music recommendation processing sub-system 202 may dynamically extract, from a new music recommendation request, the parameters associated with the request (e.g., indicated tags, any preferences associated with the requesting user 106, location information, etc.). Based on these parameters, the machine learning algorithm or artificial intelligence may evaluate a set of user profiles from the profiles 206 according to different vectors of similarity to identify users to which the request may be provided. These vectors of similarity may correspond to the tags frequently encountered by these users, the locations of these users, any music preferences associated with these users, and the like. The machine learning algorithm or artificial intelligence may be trained with a threshold parameter whereby users having a similarity score (calculated based on value proximity along each of the vectors of similarity) within the threshold parameter may be selected for the music recommendation request. Based on these selections generated by the machine learning algorithm or artificial intelligence, the music recommendation processing sub-system 202 may provide the public music recommendation request to the corresponding users.

Once the user 106 has generated a new music recommendation request, the music recommendation processing sub-system 202 may transmit the music recommendation request to the selected set of users and/or tastemakers selected by the user 106 and/or by the music recommendation processing sub-system 202 (in the case of a public music recommendation request). Each of the selected users and/or tastemakers may be notified of the music recommendation request by the music recommendation processing sub-system 202. In response to the request, a user may select one or more songs to be shared with the requesting user 106, such as through the process described above for sharing different songs with other users. However, in some instances, as opposed to the process described above for sharing different songs with other users, a responding user may not be permitted to modify the tags selected by the requesting user 106. Each of the users and/or tastemakers selected by the requesting user 106 and/or the music recommendation processing sub-system 202 may be notified via a notification provided by the P2P music recommendation service 102, a push notification, or any other form of notification.

In an embodiment, once a user 106 has submitted a new music recommendation request and while awaiting a response from one or more users to which the new music recommendation request has been provided, the P2P music recommendation service 102 can automatically surface one or more song promotions that may be of interest to the user 106. As noted above, when a song promotion for a particular song is deployed, the P2P music recommendation service 102 may access the profiles 206 to update a song profile associated with the song to incorporate the song promotion such that, in response to a music recommendation request including tags, user profile data, or other information that is associated with the particular song and the song promotion, the song promotion may be presented to the user that submitted the music recommendation request. Thus, in response to a new music recommendation request, the music recommendation processing sub-system 202, through the music identification system 204, may automatically identify any song promotions corresponding to songs that may be of interest to the user 106 or that otherwise may be relevant to the submitted music recommendation request.

In an embodiment, the music recommendation processing sub-system 202 selects one or more user promotions that may be presented to the user 106 by processing the music recommendation request and user profile data corresponding to the user 106 through a trained machine learning algorithm or artificial intelligence. This machine learning algorithm or artificial intelligence (hereafter referred to as a promotion selection algorithm) may be dynamically trained using a dataset of sample music recommendation requests (e.g., historical requests, hypothetical requests, combinations of historical and hypothetical requests) and sample song promotions (e.g., historical song promotions, hypothetical song promotions, combinations of historical and hypothetical song promotions, etc.) to select, for each sample music recommendation request, corresponding sample song promotions. This training of the promotion selection algorithm may be similar to that of the machine learning algorithm or artificial intelligence deployed for user selection described above. For instance, the promotion selection algorithm, according to different vectors of similarity defined according to different tags, song characteristics (e.g., genre, artist, music label, etc.), and user characteristics (e.g., user song preferences, user location, user demographics, etc.), may identify one or more song promotions from the profiles 206 that may be appealing to the requesting user 106.

As music recommendations are provided by different users to which the music recommendation request was provided, the music recommendation processing sub-system 202 may provide the requesting user 106 with these music recommendations. For instance, the music recommendation processing sub-system 202 may notify the user 106 of a newly received music recommendation, along with any additional information that may have been supplied by the responding user (e.g., additional tags for the recommended song, any comments supplied with the song, etc.). The requesting user 106 may interact with the recommended song, such as initiating playback of the song, saving the song to a playlist or library of the P2P music recommendation service 102 or other music service, re-sharing the song with other users, skipping the song, providing feedback with regard to the recommended song, and the like. As the user 106 interacts with the recommended song, the music recommendation processing sub-system 202 may track these interactions in order to identify the user's response to the music recommendation. This response may be used to determine whether the user has reacted favorably to the song. Further, the response may be used to update corresponding profiles for the song, artist that performed and/or produced the song, any associated tags, the responding user, and the like. As noted herein, these updates may be used to identify and recommend songs (such as through song promotions) that may be positively received by the user 106, more accurately associate particular tags to particular songs and artists, establish connections between similar artists, and the like.

In an embodiment, the P2P music recommendation service 102 implements an automated promotion system 210 to dynamically generate and provide song analytics, and promotion recommendations for different songs that may be shared within the P2P music recommendation service network. The automated promotion system 210 may comprise one or more computer systems of the P2P music recommendation service 102 or may be implemented as an application or process executing on a computer system of the P2P music recommendation service 102. In some instances, the automated promotion system 210 may be configured with various special-purpose components that can facilitate real-time or near real-time processing of different music data corresponding to different songs and user data corresponding to any number of different users to dynamically generate song analytics and recommendations for song promotions.

As noted above, as users 106 share music recommendations with one another and interact with different songs, the P2P music recommendation service 102 may track these music recommendations and corresponding interactions to dynamically generate different song analytics. In an embodiment, the music identification system 204 tracks interactions amongst users 106 as related to the sharing of songs and to the communications related to music recommendation requests submitted by users 106 (e.g., feedback submitted by users, any additional tags submitted by users, etc.). For example, the music identification system 204 may specify, for a given user action (e.g., sharing of a song, submission of a music recommendation request, etc.), any tags associated with the action (e.g., tags associated with a selected song to be shared, tags associated with a music recommendation request, etc.), any feedback provided with regard to the action (e.g., songs provided in response to a request, user interaction with a shared song, etc.), the targets corresponding to the action (e.g., users receiving a music recommendation request, users receiving a shared song, etc.), any songs and/or artists associated with the action (e.g., sample songs and/or artists specified in the submission of a music recommendation request, etc.), the location associated with the action (e.g., location from which a selected song is being shared from, location from which a music recommendation request is being submitted from, etc.), and the like. Further, the music identification system 204 may specify, for a given action, information regarding any shared songs (e.g., songs submitted in a music recommendation request to other users, songs received in response to music recommendation request, songs shared with other users, etc.) including, but not limited to, song titles, artists that performed and/or produced the songs, the music genres of the songs, and the like. The music identification system 204 may maintain an association of these songs to tags submitted by the users 106 as well. Such information generated by the music identification system 204 may be used to update profiles 206 corresponding to the different users, songs, and tags associated with these music recommendations and song interactions. Further, these interactions may be recorded within the music link database 208, which may track the frequency in which different songs are shared and interacted with.

As illustrated in FIG. 2, a music administrator 104 may submit a request to the automated promotion system 210 to obtain a set of media analytics corresponding to a particular song and any recommendations for song promotions that may be implemented for this particular song. In response to this request submitted by a music administrator 104, the automated promotion system 210 may process the request through a machine learning algorithm or artificial intelligence (hereinafter referred to as a song identification algorithm) to identify the song for which new promotions are to be generated. As noted above, this song identification algorithm may be trained using a dataset of sample user communications and sample songs, which may be analyzed to identify any correlations between the sample user communications and characteristics of the sample songs. For instance, the song identification algorithm may be dynamically trained by converting the sample user communications or messages from the training dataset into a set of communication embeddings and data corresponding to the sample songs into a set of song embeddings. The song identification algorithm may classify the sample communications or messages according to one or more vectors of similarity between the set of communication embeddings and the set of song embeddings (e.g., the vector differences between the set of communication embeddings and the set of song embeddings are within a pre-defined threshold distance, etc.).

If the automated promotion system 210, through the song identification algorithm, determines that a submitted query or request is associated with a particular song, the automated promotion system 210 may dynamically generate and present a set of song analytics or other metrics corresponding to the particular song. As noted above, these song analytics or other metrics may correspond to user interactions with the specified song over time and may include correlations between different characteristics of the particular song and other artists or songs shared amongst users 106, different tags that may be commonly associated with the song, user behaviors associated with the song, demographic information corresponding to the users 106 that have shared or otherwise interacted with the song, and the like.

In some instances, the automated promotion system 210 leverages a song profile machine learning algorithm that is dynamically trained to generate analytics or other metrics for different songs shared within the P2P music recommendation service network or otherwise made available to users of the P2P music recommendation service 102. As noted above, the song profile machine learning algorithm is dynamically trained to identify any correlations between different songs according to the characteristics of the provided requests and recommendations and, based on these correlations, generate song analytics for these different songs. Further, the song profile machine learning algorithm may be dynamically trained to classify the different characteristics of music recommendation requests and of shared music recommendations (e.g., tags, comments, sentiments, user demographics, locations, activities, representative songs provided in requests and/or recommendations, etc.) to generate or otherwise update song profiles for different songs. The song profile machine learning algorithm may be further trained to classify different clusters of tags that may be associated with different song characteristics according to one or more vectors of similarity between the clusters of tags for the particular song and known tag clusters associated with different song characteristics. The song profile machine learning algorithm, in some instances, is further trained to identify correlations between different users and songs shareable through the P2P music recommendation service 102. The song profile machine learning algorithm, in an embodiment, dynamically processes historical music data from the music link database 208 and the user profile data from the profiles 206 to provide the aforementioned outputs and generate corresponding song analytics.

The set of song analytics for a specified song may include a listing of different artists whose fans, based on listening habits and cross-genre appeal, are likely to appreciate the specified song. Further, the automated promotion system 210 may provide a music administrator 104 with the set of tags that are commonly associated with the specified song, a sentiment commonly associated with the specified song, any representative comments provided by users for the specified song, activities commonly associated with the specified song, and characteristics of the representative user that may positively interact with the specified song. The automated promotion system 210 may further provide any additional insights regarding the specified song according to any additional data provided in the song profile associated with the specified song and/or obtained through the song profile machine learning algorithm.

In addition to providing song analytics for a particular song indicated by a music administrator 104, the automated promotion system 210 can further provide recommendations for different song promotions that may be implemented for a specified song. In an embodiment, the automated promotion system 210 implements one or more LLMs and/or other generative artificial intelligence processes to dynamically generate different promotions corresponding to different songs according to any available characteristics or data corresponding to the sharing of these different songs and to the interactions with these different songs by different users 106. In response to a request from a music administrator 104 to generate one or more promotion recommendations for a particular song, the automated promotion system 210, through the one or more LLMs and/or generative artificial intelligence processes, may aggregate any available data stored in the song profile corresponding to the specified song (e.g., in the profiles 206) and in the music link database 208. As noted above, this data may include any previously submitted music recommendation requests and shared music recommendations associated with the song. Further, the song profile may include the previously generated song analytics associated with the specified song. In some instances, in addition to obtaining any available data stored in the song profile corresponding to the specified song, the automated promotion system 210 may obtain any available user profile data corresponding to the different users associated with the previously submitted music recommendation requests and shared music recommendations associated with the song.

In response to a query to generate song promotion recommendations for a particular song, the automated promotion system 210, through the one or more LLMs or other generative artificial intelligence processes and leveraging user and song profile data from the profiles 206 and historical music data from the music link database 208 (e.g., historical music recommendation requests associated with the song, etc.), may generate a set of song promotion recommendations for the particular song. Through the one or more LLMs or other generative artificial intelligence processes, the automated promotion system 210 may identify any user cohorts for which tailored song recommendations may be generated. Returning to an earlier illustrative example, based on a cluster of tags commonly associated with the particular song (as identified through the song profile machine learning algorithm described above), the one or more LLMs or other generative artificial intelligence processes may define a user cohort corresponding to a classification of this cluster of tags. For this user cohort, the one or more LLMs or other generative artificial intelligence processes may obtain additional user profile data from the profiles 206 that may be used to determine whether this user cohort is familiar with the song and, accordingly, derive a proposed song promotion that may be appealing to this user cohort. As another illustrative example, the one or more LLMs or other generative artificial intelligence processes may automatically define a user cohort corresponding to users that are familiar with the artist associated with the song and/or with similar artists, as identified through the song profile machine learning algorithm described above. For this user cohort, the one or more LLMs or other generative artificial intelligence processes may dynamically evaluate the user profile data associated with these users to identify any other user characteristics that may be used to define a proposed song promotion that may be appealing to this user cohort of fans of the artist and/or similar artists.

The automated promotion system 210, through the one or more LLMs or generative artificial intelligence processes, may further generate for each song promotion recommendation a description of the user cohort associated with the song promotion recommendation and a reasoning or rationale for promoting the song to this user cohort. As noted above, the description of a user cohort may be generated by the one or more LLMs or generative artificial intelligence processes using one or more knowledge bases corresponding to known types of user cohorts (as defined by the P2P music recommendation service 102 or through observation over time). Returning to an earlier illustrative example, for an identified user cohort, the one or more LLMs or other generative artificial intelligence processes may identify a knowledge base that includes basic or generic descriptions of the user cohort and basic or generic reasonings and/or rationales for promoting a song to this user cohort. Once the one or more LLMs or generative artificial intelligence processes have identified the relevant knowledge base(s) for the selected user cohort, the one or more LLMs or generative artificial intelligence processes may dynamically process the song profile data corresponding to the song, user profile data associated with members of the user cohort, and historical music data corresponding to music recommendations and interactions associated with the song, to supplement the basic or generic descriptions and rationales from the knowledge base with additional data that is specific to the song, resulting in customized and tailored descriptions of the user cohort and rationales for promoting the selected song to this user cohort.

The automated promotion system 210 may present these customized or tailored song promotion recommendations to the music administrator 104, such as through an interface provided by the P2P music recommendation service 102. The music administrator 104 may review these song promotion recommendations and provide feedback corresponding to these song promotion recommendations (e.g., acceptance of a song promotion recommendation, changes to a song promotion recommendation, rejection of a song promotion recommendation, etc.). Based on such feedback from a music administrator 104, the automated promotion system 210 may dynamically retrain or otherwise update the one or more LLMs or other generative artificial intelligence processes to improve the likelihood of the one or more LLMs or other generative artificial intelligence processes generating song promotion recommendations that are relevant to a specified song and that may be appealing to corresponding user cohorts.

If a music administrator 104 submits a request to the automated promotion system 210 to execute a selected song promotion for a specified song and for an identified user cohort, the automated promotion system 210 may automatically deploy the selected song promotion for presentation to users of the user cohort. For instance, the automated promotion system 210 may update the song profile associated with the song in the profiles 206 to incorporate the song promotion for the user cohort such that, in response to a music recommendation request including tags, user profile data, or other information that is associated with the particular song and the song promotion, the song promotion may be automatically presented to the user that submitted the music recommendation request. As another illustrative example, if a user responding to a music recommendation request has selected a song that is similar to the particular song being promoted (e.g., the song has similar tags to those of the promoted song, the song is associated with a similar artist or to the same artist of the promoted song, etc.), the music recommendation processing sub-system 202 may obtain, from the music identification system 204, the song promotion associated with the promoted song and automatically surface the song promotion to the user. As yet another illustrative example, when a user accesses the P2P music recommendation service 102, the music recommendation processing sub-system 202 may automatically evaluate the user profile data associated with the user from the profiles 206 and identify the song promotion based on similarities between song preferences indicated in user profile and the song profile for the particular song.

As users 106 interact with presented song promotions, the music identification system 204 may track these interactions through the music link database 208. This song promotion tracking data may be used to determine the efficacy of an implemented song promotion for a particular song in increasing user engagement and interaction with the particular song. In an embodiment, the automated promotion system 210 may evaluate this song promotion tracking data to generate various performance metrics related to the song promotion that may be provided to the music administrator 104. These performance metrics may include user feedback to the song promotion (e.g., user engagement with the promoted song, user dismissal of the promoted song, user sharing of the promoted song with other users, any user comments provided in response to the song promotion, etc.) that may denote whether the song promotion was received favorably by users presented with the song promotion (e.g., members of a user cohort, etc.). Based on this feedback, the automated promotion system 210 may dynamically retrain or otherwise update the one or more LLMs or other generative artificial intelligence processes to further improve the song promotion recommendations for different songs and corresponding to different user cohorts. Returning to an earlier illustrative example, if a particular promotion launched by the automated promotion system 210 does not result in increased user interaction with a promoted song amongst a corresponding user cohort, the automated promotion system 210 may annotate a new data point corresponding to the song promotion associated with the song and created for this user cohort to indicate that the song promotion was not appealing for the user cohort (including any feedback provided by users of user cohort). This new data point may be added to the training dataset implemented for training and evaluating the one or more LLMs or other generative artificial intelligence processes. The one or more LLMs or other generative artificial intelligence processes may process the updated training dataset (including this newly annotated data point) to generate new outputs that may be evaluated by the automated promotion system 210 to dynamically update one or more hyperparameters of the one or more LLMs or other generative artificial intelligence processes as required to provide song promotion recommendations for different songs and user cohorts that may produce greater positive engagement with these different songs.

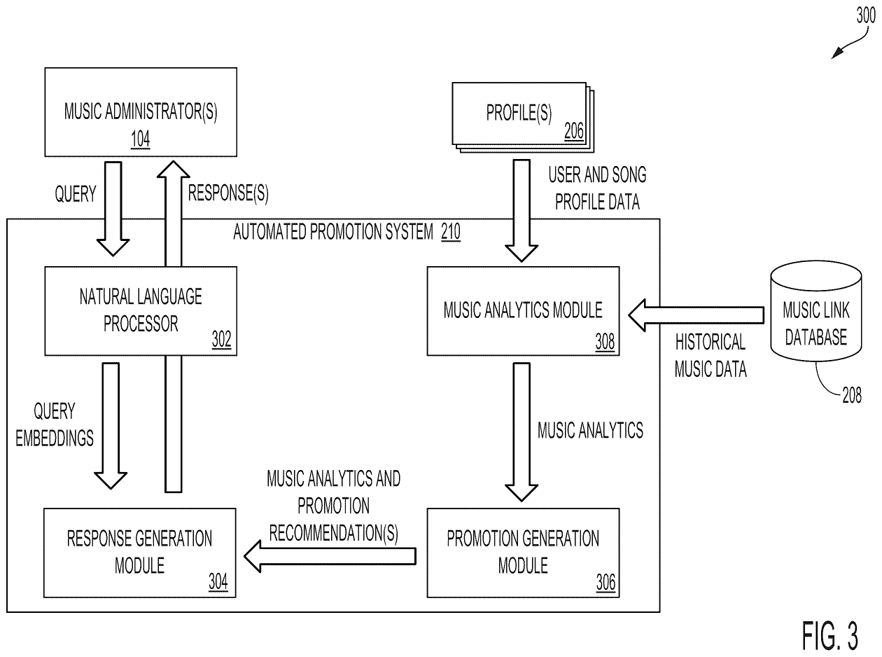

FIG. 3 shows an illustrative example of an environment 300 in which an automated promotion system 210 implemented by the P2P music recommendation service dynamically generates and evaluates music analytics corresponding to different songs to generate and provide promotion recommendations in response to user queries in accordance with at least one embodiment. In the environment 300, the automated promotion system 210 dynamically processes a communication or message from a music administrator 104 through a natural language processor 302 to generate a set of embeddings corresponding to the communication or message. The natural language processor 302, in an embodiment, is dynamically trained to process communications or messages obtained through ongoing communications sessions to convert these communications or messages into sets of message embeddings. The natural language processor 302 may be dynamically trained using a dataset of sample communications/messages (e.g., historical communications/messages, hypothetical communications/messages, combinations of historical and hypothetical communications/messages, etc.) and sample embeddings corresponding to the sample communications/messages. To dynamically train the natural language processor 302, the automated promotion system 210 may generate an initial iteration of the natural language processor 302. For instance, the automated promotion system 210 may initialize a set of coefficients or hyperparameters randomly according to a Gaussian or non-Gaussian distribution. Using this initial iteration of the natural language processor 302, the automated promotion system 210 may process the dataset of sample communications/messages and corresponding embeddings to generate an output. This output may specify, for each sample communication/message included in the dataset, a predicted set of embeddings. The automated promotion system 210 may compare the predicted set of embeddings generated using the initial iteration of the natural language processor 302 to the sample embeddings defined in the dataset for each of the data points (e.g., sample communications/messages) to identify any inaccuracies or other errors.

If the output of the natural language processor 302 does not satisfy one or more criteria, the automated promotion system 210 may iteratively update one or more coefficients or hyperparameters of the natural language processor 302 to generate a new iteration of the natural language processor 302. This new iteration of the natural language processor 302 may process the aforementioned training dataset, as well as any additional data points or other datasets obtained by the automated promotion system 210 to generate a new output for each data point in the training dataset. In some instances, the automated promotion system 210 may use an optimization algorithm to iteratively update the one or more coefficients or hyperparameters of the natural language processor 302 to generate a new iteration of the natural language processor 302 for evaluation. The automated promotion system 210 may use this new iteration of the natural language processor 302 to process the available data points of the training dataset and generate a new output. The automated promotion system 210 may evaluate this new output to determine whether the output satisfies the one or more criteria. This process of updating the set of coefficients or hyperparameters associated with the natural language processor 302 according to the one or more criteria may be performed iteratively until an iteration of the natural language processor 302 is produced that satisfies the one or more criteria.

Once the natural language processor 302 is dynamically trained according to the one or more criteria to convert received communications and messages into different sets of embeddings, the natural language processor 302 may process the communication or message received through an ongoing communications session into a particular set of embeddings corresponding to the communication or message. The natural language processor 302 may transmit this set of embeddings to a response generation module 304 to identify the intent of the music administrator 104 that submitted the communication or message (e.g., a query corresponding to a particular song, a request for particular analytics corresponding to a song, a request to generate a song promotion associated with a particular song and for a particular user cohort, etc.). The response generation module 304, in an embodiment, implements a song identification algorithm that is dynamically trained to compare received sets of embeddings to embeddings corresponding to known songs, as described above in connection with FIG. 2. These known song embeddings may be maintained within corresponding song profiles maintained by the P2P music recommendation service in the profiles 206.

If the response generation module 304 determines that a submitted query from a music administrator 104 is associated with a particular song (e.g., the query includes a request of music analytics corresponding to a particular song, etc.), the response generation module 304 may transmit a request to a promotion generation module 306 of the automated promotion system 210 to retrieve any available song analytics and recommendations for promotions that may be implemented to promote the identified song to different user cohorts. The promotion generation module 306, in an embodiment, implements one or more LLMs and/or other generative artificial intelligence processes to aggregate song analytics corresponding to a song indicated by a music administrator 104 and to dynamically generate, based on these aggregated song analytics, one or more song promotion recommendations for song promotions that may be implemented to increase exposure and engagement with the song. In an embodiment, the automated promotion system 210 implements a music analytics module 308 that is associated with the profiles 206 and the music link database 208 to obtain data corresponding to different song profiles and different user profiles, as well as to historical data corresponding to song interactions, to generate music analytics for different songs.

In an embodiment, the music analytics module 308 is configured to access the profiles 206 and the music link database 208 to obtain any available data corresponding to a song specified by the music administrator 104 and the users that have previously interacted with the song (e.g., shared the song with other users, interacted with the song, received the song through music recommendations provided to the user, etc.). For example, in an embodiment, the music analytics module 308 may obtain, from the profiles 206, a song profile associated with the indicated song to identify any tags and comments that have been assigned to the song by different users of the P2P music recommendation service over time. Additionally, the music analytics module 308 may obtain from the music link database 208 data corresponding to any tags and comments used by users of the P2P music recommendation service when sharing, requesting, and saving the particular song. For instance, in response to obtaining the query embeddings from the response generation module 304, the promotion generation module 306 may transmit a request to the music analytics module 308 to obtain any available data corresponding to the song and the users that may be associated with the song. This request may include, for instance, a unique identifier associated with the song (e.g., a song name, a song catalog number, etc.) that may be used to identify, from the profiles 206, the song profile associated with the song. Further, the unique identifier associated with the song may be used to identify, from the music link database 208 any previously shared music recommendations and/or submitted music recommendation requests that were associated with the song.

The music analytics module 308, in an embodiment, implements the aforementioned song profile machine learning algorithm that is dynamically trained to generate analytics or other metrics for different songs shared within the P2P music recommendation service network or otherwise made available to users of the P2P music recommendation service. As noted above, the set of song analytics for a specified song may include a listing of different artists whose fans, based on listening habits and cross-genre appeal (as determined through evaluation of user profiles of users that may have interacted with similar songs and/or artists), are likely to appreciate the specified song. Further, the music analytics module 308, based on an evaluation of data from the profiles 206 and the music link database 208, may identify a set of tags that are commonly associated with the specified song, a sentiment commonly associated with the specified song, any representative comments provided by users for the specified song, activities commonly associated with the specified song, and characteristics of the representative user that may positively interact with the specified song. The music analytics module 308 may further provide any additional insights regarding the specified song according to any additional data provided in the song profile associated with the specified song and/or obtained through the song profile machine learning algorithm.

In an embodiment, the promotion generation module 306 may dynamically process the aforementioned music analytics corresponding to the specified song to generate a set of song promotion recommendations that may be provided in response to the query from the music administrator 104. For instance, through the aforementioned one or more LLMs or other generative artificial intelligence processes, the promotion generation module 306 may aggregate the music analytics from the music analytics module 308 and process the aggregated music analytics to identify any user cohorts for which tailored song recommendations may be generated. Returning to an earlier illustrative example, based on a cluster of tags commonly associated with the particular song, the promotion generation module 306 (through the one or more LLMs or other generative artificial intelligence processes) may define a user cohort corresponding to a classification of this cluster of tags. For this user cohort, the promotion generation module 306 may query the music analytics module 308 to obtain additional user profile data from the profiles 206 that may be used to determine whether this user cohort is familiar with the song and, accordingly, derive a proposed song promotion that may be appealing to this user cohort. As another illustrative example, the promotion generation module 306 may automatically define a user cohort corresponding to users that are familiar with the artist associated with the song and/or with similar artists, as identified through the song profile machine learning algorithm implemented by the music analytics module 308. For this user cohort, the promotion generation module 306 may dynamically evaluate the user profile data associated with these users to identify any other user characteristics that may be used to define a proposed song promotion that may be appealing to this user cohort of fans of the artist and/or similar artists.

For each proposed song promotion, the promotion generation module 306 may further generate a description of the user cohort associated with the song promotion recommendation and a reasoning or rationale for promoting the song to this user cohort. The description of this user cohort and the rationale for promoting the song to this user cohort may be dynamically generated by the promotion generation module 306 by processing the aggregated music analytics through the one or more LLMs or other generative artificial intelligence processes implemented by the promotion generation module 306. For instance, as noted above, the one or more LLMs or other generative artificial intelligence processes may leverage one or more knowledge bases corresponding to known types of user cohorts (as defined by the P2P music recommendation service or through observation over time). Based on the aggregated music analytics and the identified user cohorts, the promotion generation module 306 may identify one or more knowledge bases that include basic or generic descriptions of these identified user cohorts and basic or generic reasonings and/or rationales for promoting a song to these identified user cohorts. Through the one or more LLMs or other generative artificial intelligence processes and using the generic descriptions and rationales from the identified knowledge bases, the promotion generation module 306 may dynamically process the aggregated music analytics associated with the song, to supplement the basic or generic descriptions and rationales from the knowledge bases with additional data that is specific to the song. This may result in a new tailored set of proposed song promotions that may be presented to the music administrator 104 in response to their query.

The promotion generation module 306 may provide this new tailored set of proposed song promotions, as well as the aggregated music analytics, to the response generation module 304 for presentation to the music administrator 104. The response generation module 304, according to the configuration of the interface used to implement the communications session between the music administrator 104 and the automated promotion system 210, may present the aggregated music analytics and the tailored set of proposed song promotions that may be implemented for different user cohorts. The music administrator 104 may review these aggregated music analytics and song promotion recommendations to provide feedback corresponding to these song promotion recommendations (e.g., acceptance of a song promotion recommendation, changes to a song promotion recommendation, rejection of a song promotion recommendation, etc.). The natural language processor 302 and the response generation module 304 may dynamically process any communications from the music administrator 104 corresponding to the provided music analytics and proposed song promotions to obtain feedback associated with these proposed song promotions. As noted above, based on such feedback from a music administrator 104, the automated promotion system 210 may dynamically retrain or otherwise update the one or more LLMs or other generative artificial intelligence processes implemented by the promotion generation module 306 to improve the likelihood of these one or more LLMs or other generative artificial intelligence processes generating song promotion recommendations that are relevant to a specified song and that may be appealing to corresponding user cohorts.

In an embodiment, if the response generation module 304, through the natural language processor 302, detects a communication indicating a request to execute a proposed song recommendation for a corresponding song, the response generation module 304 transmits a request to the promotion generation module 306 to deploy the song promotion. For instance, the promotion generation module 306 may update the song profile associated with the song in the profiles 206 to incorporate the song promotion for the user cohort such that, in response to a music recommendation request including tags, user profile data, or other information that is associated with the particular song and the song promotion, the song promotion may be automatically presented in response to the music recommendation request. As another illustrative example, if a user responding to a music recommendation request has selected a song that is similar to the particular song being promoted, the P2P music recommendation service may automatically surface the song promotion to the user. As yet another illustrative example, when a user accesses the P2P music recommendation service, the P2P music recommendation service may automatically evaluate the user profile data associated with the user from the profiles 206 and automatically present the song promotion based on similarities between the user's song preferences and characteristics of the particular song.

In an embodiment, the music analytics module 308 dynamically tracks user interactions with different song promotions deployed by the promotion generation module 306. For instance, the music analytics module 308 may dynamically obtain (in real-time, periodically, and/or in response to triggering events) user interaction data from the music link database 208. As noted above, the user interaction data may be used to determine the efficacy of an implemented song promotion for a particular song in increasing user engagement and interaction with the particular song. In an embodiment, the music analytics module 308 evaluates this user interaction data to generate various performance metrics related to the song promotion that may be provided to the music administrator 104. These performance metrics may include user feedback to the song promotion that may denote whether the song promotion was received favorably by users presented with the song promotion. Based on this feedback, the automated promotion system 210 may dynamically retrain or otherwise update the one or more LLMs or other generative artificial intelligence processes implemented by the promotion generation module 306 to further improve the song promotion recommendations for different songs and corresponding to different user cohorts.

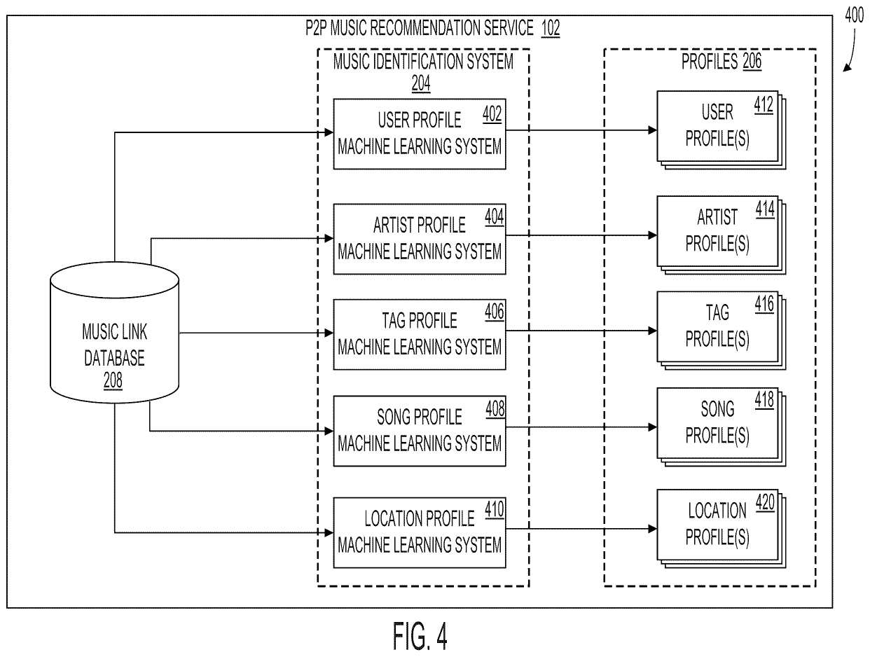

FIG. 4 shows an illustrative example of an environment in which a music identification system 204 of the P2P music recommendation service 102 utilizes a set of machine learning systems 402-410 to generate and update various profiles 206 used to identify music that can be shared by users of the P2P music recommendation service in accordance with at least one embodiment. In the environment 400, the P2P music recommendation service 102 maintains a music link database 208, which is used to track interactions amongst users of the P2P music recommendation service 102 as related to the sharing of songs and to the communications related to music recommendation requests submitted by users of the P2P music recommendation service 102 (e.g., feedback submitted by users, any additional tags submitted by users, etc.). For example, the music link database 208 may specify, for a given user action (e.g., sharing of a song, submission of a music recommendation request, etc.), any tags associated with the action (e.g., tags associated with a selected song to be shared, tags associated with a music recommendation request, etc.), any feedback provided with regard to the action (e.g., songs provided in response to a request, user interaction with a shared song, etc.), the targets corresponding to the action (e.g., users receiving a music recommendation request, users receiving a shared song, etc.), any songs and/or artists associated with the action (e.g., sample songs and/or artists specified in the submission of a music recommendation request, etc.), the location associated with the action (e.g., location from which a selected song is being shared from, location from which a music recommendation request is being submitted from, etc.), and the like. Further, the music link database 208 may specify, for a given action, information regarding any shared songs (e.g., songs submitted in a music recommendation request to other users, songs received in response to music recommendation request, songs shared with other users, etc.) including, but not limited to, song titles, artists that performed and/or produced the songs, the music genres of the songs, and the like. The music link database 208 may maintain an association of these songs to tags submitted by the users of the P2P music recommendation service 102 as well.

In an embodiment, the music identification system 204 processes the data in the music link database 208 using a set of machine learning systems 402-410 to generate a set of profiles 412-420 for use by the music identification system 204 to better serve users of the P2P music recommendation service 102, other entities (e.g., artists, other music services, music labels, promoters, brands that utilize music as a core component of their product, etc.) associated with the P2P music recommendation service 102, and to provide data that may be used to generate different song analytics usable to create tailored song promotions for different songs shareable through the P2P music recommendation service 102. For example, the music identification system 204 may include a user profile machine learning system 402 that is implemented to generate and update user profiles 412 for each of the users of the P2P music recommendation service 102. The user profile machine learning system 402 may be implemented using a computer system or utilizing an application implemented using a computer system of the P2P music recommendation service 102.

The user profile machine learning system 402 may implement a machine learning algorithm, trained using supervised learning techniques, to generate and update user profiles 412 for each user of the P2P music recommendation service 102. For instance, a dataset of sample tags corresponding to sample songs shared with different sample users and of sample user responses to these shared songs may be used to generate a set of sample user profiles that may indicate different users'individual tastes in music. Based on a sample user profile, the user profile machine learning system 402 may provide a user with a sample music recommendation based on a sample user profile generated for the user. Based on the user response to the sample music recommendation, the user profile machine learning system 402 may update one or more model coefficients of the machine learning algorithm to either reinforce the algorithm (e.g., if the user provides positive comments or feedback, the user shares the song provided in the recommendation, the user saves the song provided in the recommendation to a playlist, etc.) or to revise the algorithm to provide better recommendations (e.g., if the user provides negative comments or feedback, the user skips the song provided in the recommendation, etc.). Through this iterative process, the machine learning algorithm may be trained to provide music recommendations that are likely to be received positively by a user of the P2P music recommendation service 102.

In an embodiment, the user profile machine learning system 402 generates an anonymized taste profile for each user based on the user's lifetime tracking of the artists, songs, shared tags, saved songs, skipped songs, disliked songs, submitted requests, locations from which requests were submitted, time of day during which requests were submitted, and the like specified in the music link database 208. Additionally, the anonymized taste profile may be generated based on user interaction with other users, including the location and time for each interaction. This information from the music link database 208 may be processed using the machine learning algorithm of the user profile machine learning system 402 to generate or update a user profile of a particular user of the P2P music recommendation service 102. Thus, the user profile machine learning system 402 may maintain user profiles 412 for each of the users of the P2P music recommendation service 102. These user profiles 412 may be continuously updated as new data is added to the music link database 208 based on user interactions with the P2P music recommendation service 102 over time. A user profile 412 may thus provide the subjective tastes or a corresponding user for different contexts. For instance, a user profile 412 may define a user's preferences for a particular location, particular time of day, particular tag or combination of tags, moods, and the like.

The P2P music recommendation service 102 may utilize a user profile for various purposes. For instance, if a user of the P2P music recommendation service 102 submits a request to share a particular song with other users of the P2P music recommendation service 102, the P2P music recommendation service 102 may determine, based on user profiles for each of the other users to whom the song may be provided (e.g., users selected by the user, etc.), which users are likely to react positively to the song being shared. For instance, if a user is known to react positively to songs associated with a particular set of tags, the P2P music recommendation service 102 may determine whether the song being shared is associated with this particular set of tags and, if so, indicate to the user sharing the song that this particular user may react positively to the song. As another example, the user profiles 412 may be used for targeted promotion of music by artists, music administrators, and any other entities that may rely on the P2P music recommendation service 102 to promote their music. For instance, based on the characteristics of the song that is to be promoted to a particular user cohort, the P2P music recommendation service 102 may evaluate the user profiles 412 to identify members of the user cohort to which the song may be promoted to. Similarly, if a user indicates that they are seeking music recommendations from other users of the P2P music recommendation service 102, the P2P music recommendation service 102 may identify any promoted songs that may be received positively by the user and a promoted recommendation may be provided to the user. The user profiles 412 may further be used to identify target audiences for upcoming concerts, events, music streams, streaming services, products, brands, and the like that may be of interest to these target audiences.

In an embodiment, the user profile machine learning system 402 is further utilized to match users of the P2P music recommendation service 102 based on shared appreciation of content (e.g., songs, artists, musical genres, etc.). For instance, based on the characteristics of a user profile (e.g., positively received tags, songs, artists, etc.), the user profile machine learning system 402 may identify other user profiles that may have similar characteristics that are indicative of a shared appreciation for particular songs, artists, music genres, and the like. These similarities may be used to determine a likelihood that relationships amongst a set of users would result in a positive experience for the set of users. The P2P music recommendation service 102 may utilize this information to recommend other users, tastemakers, artists, music labels, brands, promoters, venues, events, streaming services, and the like to a particular user during their interaction with the P2P music recommendation service 102.

The music identification system 204 may further include an artist profile machine learning system 404 that may be utilized to generate and update artist profiles 414 for each artist associated with the P2P music recommendation service 102 (e.g., artists that perform and/or produce songs shared within the P2P music recommendation service 102 network, artists promoting songs via the P2P music recommendation service 102, etc.). The artist profile machine learning system 404 may be implemented using a computer system or utilizing an application implemented using a computer system of the P2P music recommendation service 102. The artist profile machine learning system 404 may utilize a machine learning algorithm, trained using supervised learning techniques, to generate and update artist profiles 414 for each artist associated with the P2P music recommendation service 102. For instance, a dataset of tags and comments corresponding to songs shared by users of the P2P music recommendation service 102 and of user responses to these shared songs may be used to generate a set of sample artist profiles that may indicate what type of users are likely to react positively to the artist's music and what tags may be associated with the artist. Based on a sample artist profile, the artist profile machine learning system 404 may provide an artist's songs to a user identified as being likely to react positively to the artist's songs or that has submitted a request specifying tags associated with the artist profile for music recommendations. Based on the user response to the artist's songs, the artist profile machine learning system 404 may update one or more model coefficients of the machine learning algorithm to either reinforce the algorithm (e.g., if the user responds positively to the artist's songs) or to revise the algorithm to provide better recommendations (e.g., if the user responds negatively to the artist's songs). Through this iterative process, the machine learning algorithm may be trained to generate a more accurate artist profile.

The artist profile machine learning system 404 may utilize the music link database 208 to track any tags and comments used by users of the P2P music recommendation service 102 when sharing, requesting, and saving songs by an artist. Further, the artist profile machine learning system 404 may track any user actions with regard to songs associated with the artist. For instance, the artist profile machine learning system 404 may track a user's sharing of a song by the artist, a user's act of saving a song by the artist, a user's skipping of a song by the artist, the amount of time between initiation of playback of a song and the user's skipping of the song by the artist, a user's response to a song by the artist (e.g., positive or negative reactions, etc.), and the like. Further, the artist profile machine learning system 404 may determine, for a given action, the context or circumstances surrounding the action (e.g., the request associated with the action, the time of day associated with the action, etc.). In an embodiment, the artist profile machine learning system 404 further maps the relationship between artists associated with the P2P music recommendation service 102. For instance, for a particular artist, the artist profile machine learning system 404 may evaluate the user profiles 412 of users that react positively to the artist's music to identify which other artists these users may also react positively to. This may result in the discovery of possible relationships amongst artists that may be used to group artists for user recommendations, discovery of different user cohorts for the promotion of different songs, for cross promotional ventures between artists, and the like.

The music identification system 204 may further include a tag profile machine learning system 406 that may be utilized to generate and update tag profiles 416 for each tag made available by the P2P music recommendation service 102 for the creation of sharing and music recommendation requests and for the providing of responses to said requests. The tag profile machine learning system 406 may be implemented using a computer system or utilizing an application implemented using a computer system of the P2P music recommendation service 102. The tag profile machine learning system 406 may utilize a machine learning algorithm, trained using supervised learning techniques, to generate and update tag profiles 416 for each tag made available by the P2P music recommendation service 102 for requests and for association with songs shared within the P2P music recommendation service network.

The tag profile machine learning system 406 may utilize a machine learning algorithm, trained using supervised learning techniques, to generate and update tag profiles 416 for each tag made available by the P2P music recommendation service 102 to users. For instance, a dataset of tag interactions amongst users of the P2P music recommendation service 102 may be used as input to identify a set of characteristics of each tag provided by the P2P music recommendation service and to generate a set of sample tag profiles. Based on a sample tag profile, the tag profile machine learning system 406 may assign the corresponding tag to a song or artist submitted by a user, such as via a song sharing request or with a song to be submitted as an example for identifying music recommendations for the user. Based on the user response to the tag identification provided by the machine learning algorithm, the tag profile machine learning system 406 may update one or more model coefficients of the machine learning algorithm to either reinforce the algorithm (e.g., if the user responds positively to the tag selection) or to revise the algorithm to better assign tags to a particular song or request (e.g., if the user responds negatively to the tag selection). Through this iterative process, the machine learning algorithm may be trained to more accurately assign tags to songs, artists, song promotions, and requests.

The tag profile machine learning system 406 may utilize the music link database 208 to track any which songs, artists, and users are associated with each tag. Further, the tag profile machine learning system 406 may track actions taken by users of the P2P music recommendation service 102, such as skipping songs, saving songs to a playlist, providing feedback (positive or negative) with regard to a particular song, submitting requests to share a song or to obtain music recommendations, interacting with song promotions associated with a song, and the like. Each of these actions may be associated with a set of tags, whose usage may be monitored by the tag profile machine learning system 406 through evaluation of the music link database 208 and used to generate and update the tag profiles 416. The tag profiles 416 may further be utilized by the aforementioned user profile machine learning system 402 and artist profile machine learning system 404 to provide tag recommendations to users and artists associated with the P2P music recommendation service 102 and to associate these users and artists with particular tags based on their individual interactions with the P2P music recommendation service 102.

The music identification system 204 may further include a song profile machine learning system 408 that may be utilized to generate and update song profiles 418 for each song shared within the P2P music recommendation service 102 network or otherwise made available to users of the P2P music recommendation service 102 (e.g., songs promoted by artists or other entities associated with the P2P music recommendation service 102, songs performed and/or produced by artists associated with the P2P music recommendation service 102, etc.). The song profile machine learning system 408 may be implemented using a computer system or utilizing an application implemented using a computer system of the P2P music recommendation service 102. The song profile machine learning system 408 may utilize a machine learning algorithm, trained using supervised learning techniques, to generate and update song profiles 418 for each song made available by the P2P music recommendation service 102 for sharing amongst users of the P2P music recommendation service 102. For instance, a dataset of tags and comments corresponding to songs shared by users of the P2P music recommendation service 102 and of user responses to these shared songs may be used to generate a set of sample song profiles that may indicate what type of users are likely to react positively to certain songs and what tags may be associated with these songs.

Based on a sample song profile, the song profile machine learning system 408 may provide or recommend the song to a user identified as being likely to react positively to the particular song or that has submitted a request specifying tags associated with the song profile for music recommendations. Based on the user response to the song, the song profile machine learning system 408 may update one or more model coefficients of the machine learning algorithm to either reinforce the algorithm (e.g., if the user responds positively to the song) or to revise the algorithm to provide better recommendations (e.g., if the user responds negatively to the song). Through this iterative process, the machine learning algorithm may be trained to generate a more accurate song profile.

In an embodiment, the song profile machine learning system 408 further maps the relationship between a song and a particular location. For instance, for a particular song, the song profile machine learning system 408 may evaluate location profiles 420 to identify locations where the song may have been shared from and resulted in positive reactions from users. This may result in the discovery of possible relationships between songs and locations, as well as between the song and other songs that may have also been shared from the same location. These relationships may be used to group songs for user recommendations, for generating promotions at the given location, and the like.

As noted above, the song profile machine learning system 408 may further be trained to generate analytics or other metrics for different songs shared within the P2P music recommendation service network or otherwise made available to users of the P2P music recommendation service 102 by identifying any correlations between different songs according to the characteristics of the provided requests and recommendations. Further, the song profile machine learning system 408 may be dynamically trained to classify the different characteristics of music recommendation requests and of shared music recommendations (e.g., tags, comments, sentiments, user demographics, locations, activities, representative songs provided in requests and/or recommendations, etc.) to generate or otherwise update song profiles 418 for different songs that may be shared through the P2P music recommendation service 102. The song profile machine learning system 408 may be further trained to classify different clusters of tags that may be associated with different song characteristics according to one or more vectors of similarity between the clusters of tags for the particular song and known tag clusters associated with different song characteristics. The song profile machine learning system 408, in some instances, is further trained to identify correlations between different users and songs shareable through the P2P music recommendation service 102. The song profile machine learning algorithm, in an embodiment, dynamically processes historical music data from the music link database 208 and the user profiles 412 to provide the aforementioned outputs and generate corresponding song analytics. These song analytics may be used to dynamically generate different song promotion recommendations for different songs, as described in greater detail herein.

In some instances, if a music administrator submits a request to execute a proposed song promotion for a particular song and for a corresponding user cohort, the automated promotion system described herein may update the song profile 418 associated with the song to incorporate the song promotion for the user cohort such that, in response to a music recommendation request including tags, user profile data, or other information that is associated with the particular song and the song promotion, the song promotion may be automatically presented to the user that submitted the music recommendation request. As another illustrative example, if a user responding to a music recommendation request has selected a song that is similar to the particular song being promoted (e.g., the song has similar tags to those of the promoted song, the song is associated with a similar artist or to the same artist of the promoted song, etc.), the music identification system 204 may provide, based on the song profiles 418, the song promotion associated with the promoted song and automatically surface the song promotion to the user.

The music identification system 204 may further include a location profile machine learning system 410 that may be utilized to generate and update location profiles 420 for different locations where users may be located or from which songs are shared with other users of the P2P music recommendation service 102. The location profile machine learning system 410 may be implemented using a computer system or utilizing an application implemented using a computer system of the P2P music recommendation service 102. The location profile machine learning system 318 may utilize a machine learning algorithm, trained using supervised learning techniques, to generate and update location profiles 420 corresponding to user locations and other locations from which songs may be shared with users of the P2P music recommendation service 102. For instance, a dataset of tags, songs, artists, user responses to shared songs, and location information may be used to generate a set of sample location profiles that may indicate what type of songs and artists are shared from a particular location by users of the P2P music recommendation service 102. The location profile machine learning system 410 may track which users, artists, songs, and tags each location is associated with, as well as the actions taken by users at the location (e.g., skipping songs, saving songs, feedback provided with regard to songs shared from the location, requests submitted from the location, etc.).

Based on a sample location profile, the location profile machine learning system 410 may provide or recommend a song to users at the corresponding location. Based on the user response to the song at the location, the location profile machine learning system 410 may update one or more model coefficients of the machine learning algorithm to either reinforce the algorithm (e.g., if the user responds positively to the song) or to revise the algorithm to provide better recommendations (e.g., if the user responds negatively to the song). Through this iterative process, the machine learning algorithm may be trained to generate a more accurate location profile, which may be used to determine which songs to recommend at a particular location.

A location profile may correspond to a national, regional, local, and/or hyper-local (e.g., a particular venue, etc.) location. Further, a location profile may be associated with different user, artist, tag, and song profiles maintained by the P2P music recommendation service 102. For instance, a location profile may be associated with a set of song profiles corresponding to songs that are frequently shared from the location. Similarly, a location profile may be associated with a set of artist profiles corresponding to the artists whose songs are frequently shared from the location. Tag profiles corresponding to tags included share requests or music recommendation requests submitted from the location may also be associated with a location profile. User profiles of users that frequent the location may also be associated with the location profile for the location. This interconnectivity among profiles may allow the music identification system 204 to utilize a user's location to determine which songs are frequently shared from the location, may be appealing to the user at the location, and the like. Further, a location profile may be used to generate targeted promotions at the location based on the songs and artists that are frequently shared amongst users of the P2P music recommendation service 102 from the location and feedback from these users with regard to the shared songs and artists.

FIG. 5 shows an illustrative example of an environment 500 in which an automated promotion system 210, through a user interface 108 and for a particular song, provides music analytics corresponding to user listening habits and preferences in accordance with at least one embodiment. In the environment 500, the automated promotion system 210 may dynamically process a user query with regard to a specified song to generate different song analytics relevant to the song and that may be used to dynamically craft one or more song promotion recommendations for the music administrator that submitted the user query. As noted above, through an input field 114 implemented through the interface 108, a music administrator can submit a request to the automated promotion system 210 to dynamically generate and provide various music analytics and other metrics corresponding to a particular song. In response to this request, the automated promotion system 210, through the one or more LLMs or other generative artificial processes described above in connection with FIGS. 2-3, may dynamically process user and song profile data relevant to the song (e.g., data corresponding to users that have previously interacted with the song and/or similar songs, data corresponding to the song and associated characteristics, etc.) and historical music data corresponding to music recommendation requests associated with the song to generate and present a set of music analytics corresponding to the specified song.

As illustrated in FIG. 5, in response to a user query denoting a particular song, the automated promotion system 210 may update the interface 108 to provide a response 112 that includes a listing of different artists whose fans, based on listening habits and cross-genre appeal, are likely to appreciate the specified song. This listing of different artists may be generated by the song profile machine learning algorithm described above based on analysis of the song profile corresponding to the specified song and evaluation of user profile data corresponding to users that previously interacted with the specified song (such as through submitted music recommendation requests and/or through shared music recommendations associated with the specified song) and/or other similar songs (as determined through evaluation of different song profiles and user profiles).

Additionally, as illustrated in FIG. 5, the automated promotion system 210 may further provide a music administrator, through the interface 108, with a set of tags that are commonly associated with the specified song. For instance, in response to a user query denoting a particular song, the automated promotion system 210, through the one or more LLMs or other generative artificial intelligence processes, may dynamically process a song profile corresponding to the song, user profiles corresponding to users that have previously interacted with the particular song through the P2P music recommendation service, and available tag profiles corresponding to the different tags implemented by the P2P music recommendation service, to identify any correlations amongst the song, any listening user cohorts associated with the song, and tags assigned to the song by these listening user cohorts. Based on these correlations, the automated promotion system 210 may dynamically identify a set of tags or tag clusters that are frequently associated with the particular song and the listening user cohorts associated with the particular song.

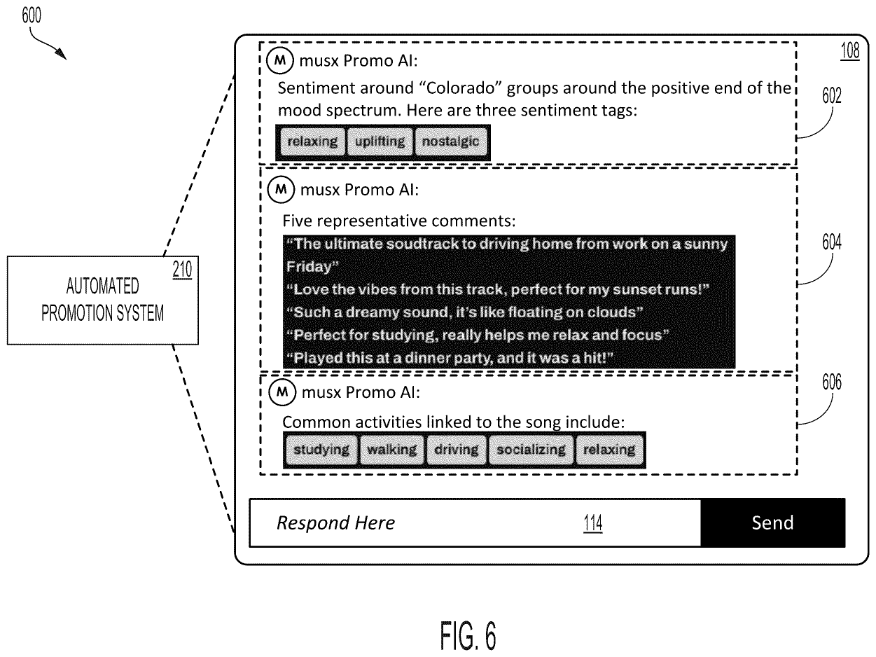

FIG. 6 shows an illustrative example of an environment 600 in which an automated promotion system 210, through a user interface 108 and for a particular song, provides music analytics corresponding to user sentiment, user activities, and user comments regarding the particular song in accordance with at least one embodiment. In the environment 600, in addition to providing a listing of different artists whose fans are likely to appreciate the specified song and a set of tags that are commonly associated with the specified song by a listening user cohort, the automated promotion system 210 may provide, through the interface 108, analytics corresponding to any sentiments associated with the particular song. In an embodiment, to determine a sentiment associated with a particular song, the automated promotion system 210 (through the one or more LLMs or other generative artificial intelligence processes) may dynamically evaluate the tag profiles corresponding to the different tags associated with the song and the listening user cohorts identified as being associated with the song.

A tag profile corresponding to a particular tag may include data corresponding to the music recommendation requests transmitted to other users of the P2P music recommendation service. For instance, in a music recommendation request, a user may designate one or more tags corresponding to the types of music desired by the user. These one or more tags may denote a positive sentiment towards these tags for these types of music. Conversely, a user may designate one or more tags corresponding to the types of music that the user dislikes or is otherwise not interested in. These one or more tags may thus denote a negative sentiment towards these tags for these types of music. Thus, as users generate music recommendation requests for different music recommendations, the P2P music recommendation service may track user sentiments corresponding to the tags indicated in these requests.

In some instances, a tag profile corresponding to a particular tag may further include data corresponding to the different songs shared amongst users of the P2P music recommendation service in response to music recommendation requests. For instance, as noted above, when a user recommends a particular song to another user in response to a music recommendation request, the user may assign one or more tags to the particular song. Further, the user may provide an optional comment denoting the reasoning behind the user sharing the selected song with the requesting user. In an embodiment, the P2P music recommendation service (such as through the tag profile machine learning system 406 implemented by the music identification system 204 illustrated in FIG. 4) processes any comments provided by a user in conjunction with the tags assigned to a song being shared with other users to identify any correlations between these comments and tags. For example, if a user assigns the tag “relaxing” to a particular song and includes the comment “I really enjoy listening to this song when taking a breather,” the P2P music recommendation service may associate the tag “relaxing” with a positive sentiment or mood, as the provided comment (as evaluated by the tag profile machine learning system 406 using NLP or other language processing algorithm) denotes the sharing user's enjoyment when listening to the song when relaxing.

In some instances, a particular tag may be inherently associated with a particular sentiment. For example, an “uplifting” tag may be inherently associated with a positive sentiment as the term “uplifting,” by definition, may have a positive connotation. Thus, the automated promotion system 210 may dynamically evaluate the set of tags that are commonly associated with the specified song by a listening user cohort to identify any tags that may be inherently associated with a particular sentiment. Returning to the analytics corresponding to any sentiments associated with a particular song, as presented in FIG. 6, the automated promotion system 210 may perform such evaluation of the tags and of the corresponding tag profiles to identify the tags that are associated with a sentiment. The identified tags may be clustered according to corresponding sentiments. The automated promotion system 210, through the one or more LLMs or other generative artificial intelligence processes, may identify a cluster of tags that best represents a sentiment associated with the song (such as through an evaluation of historical music recommendation requests and analytics corresponding to the song) and generate a response that denotes the sentiment and the corresponding cluster of tags. For instance, as illustrated in FIG. 6 and through the response 602, the automated promotion system 210 may indicate that the sentiment associated with the specified song is on the positive end of the mood spectrum and may further provide the cluster of tags including the “relaxing” tag, the “uplifting” tag, and the “nostalgic” tag as being representative of this sentiment.

In an embodiment, the automated promotion system 210 further provides, through the interface 108, a set of comments 604 that are representative of the sentiments and opinions corresponding to the specified song. In some instances, these representative comments may be selected by the automated promotion system 210 at random from the song profile associated with the specified song. Alternatively, the automated promotion system 210 may dynamically process any comments associated with the song (as indicated in the song profile and/or the music link database) through the one or more LLMs or other generative artificial intelligence processes to identify any representative comments that are associated with the sentiment provided in the response 602. In an embodiment, to identify representative comments associated with the particular sentiment corresponding to the song, the automated promotion system 210 implements a language processing algorithm (such as through the natural language processor 302 described above in connection with FIG. 3) that is dynamically trained to process comments associated with the song from a corresponding song profile to generate sentiment scores corresponding to these comments. Sentiment scores may be associated with different sentiments, whereby a sentiment score corresponding to a comment may be evaluated against different sentiment score ranges corresponding to different sentiments to identify the sentiment associated with the comment. The language processing algorithm may be configured to automatically process comments associated with a song (e.g., comments provided by users in a music recommendation that includes the song, etc.) as input to generate sentiment scores for these comments. The language processing algorithm may be trained using supervised learning techniques. For instance, a dataset of input comments and corresponding sentiments and sentiment scores can be selected for training of the language processing algorithm. The language processing algorithm may be evaluated to determine, based on the input comments supplied to the language processing algorithm, whether the language processing algorithm is providing accurate outputs that can be used to determine the sentiment and corresponding sentiment score for a comment. Based on this evaluation, the language processing algorithm may be modified (e.g., one or more hyperparameters or variables may be updated) to increase the likelihood of the language processing algorithm generating the desired results (accurate sentiments corresponding to input comments).

Based on the sentiments assigned to the different comments associated with the song, the automated promotion system 210 may dynamically select a pre-defined number of comments associated with the identified sentiment indicated in the response 602 and that may be presented as representative comments 604 associated with the song. These representative comments 604 may be presented to the music administrator through the interface 108. For example, as illustrated in FIG. 6, the automated promotion system 210 may provide five representative comments 604 associated with the particular song. This number of representative comments 604 may be selected based on the configuration of the interface 108 to reduce the likelihood of these representative comments 604 monopolizing the space within the interface 108 and overwhelming the music administrator. However, any number of representative comments 604 may be provided for a given sentiment through the interface 108.

In an embodiment, the automated promotion system 210 provides the music administrator with a set of options for responding to any of the representative comments 604 associated with the particular song. For example, the automated promotion system 210, through the interface 108, may provide one or more user interface elements for each representative comments that, when selected, allows the music administrator to interact with the user that submitted the representative comment. Through these interactions, the music administrator may provide their appreciation to the user for their comment, provide recommendations for other songs and/or artists that may be of interest to the user, or otherwise engage in a communications session with the user. By allowing the music administrator to engage with users according to their representative comments 604, the music administrator may obtain, in real-time, additional feedback from users with regard to the particular song and any other songs and/or artists discussed among the music administrator and these users. Further, this may increase the likelihood of the particular song being received positively by these users, as these users may gain a greater sense of familiarity and camaraderie with the music administrator (which may include the artist behind the particular song).

In an embodiment, the automated promotion system 210 further provides the music administrator with a set of options for responding to individual music recommendation requests as these individual music recommendation requests are generated by different users. For instance, when a user submits a music recommendation request whereby the promoted song may be relevant to the request (e.g., the request includes a set of tags known to be closely related to the promoted song, the request includes the promoted song as a reference for obtaining new music recommendations, etc.), the automated promotion system 210 may update the interface 108 to present this music recommendation request to the music administrator to allow the music administrator to interact with the music recommendation request and/or the user that submitted the music recommendation request.

In an embodiment, the automated promotion system 210 further provides, through the interface 108, analytics corresponding to different activities 606 that may be linked to the specified song. Similar to the identification of different clusters of tags that may be associated with different sentiments, the automated promotion system 210 (through the one or more LLMs or other generative artificial intelligence processes) may dynamically evaluate the tag profiles corresponding to the different tags associated with the song and the listening user cohorts identified as being associated with the song. For instance, in some instances, a particular tag may be inherently associated with a particular activity. For example, the “studying” tag may be inherently associated with the act of studying, by definition. As another illustrative example, the “walking” tag may be inherently associated with the act of walking. Thus, the automated promotion system 210 may dynamically evaluate the set of tags that are commonly associated with the specified song by a listening user cohort to identify any tags that may be inherently associated with different activities or actions. Returning to the analytics corresponding to any activities 606 associated with a particular song, as presented in FIG. 6, the automated promotion system 210 may perform such evaluation of the tags and of the corresponding tag profiles to identify the tags that are associated with an activity or action. The automated promotion system 210, through the one or more LLMs or other generative artificial intelligence processes, may select which tags corresponding to different activities may be presented through the interface 108 according to the frequency in which these tags are associated with the song by different users.

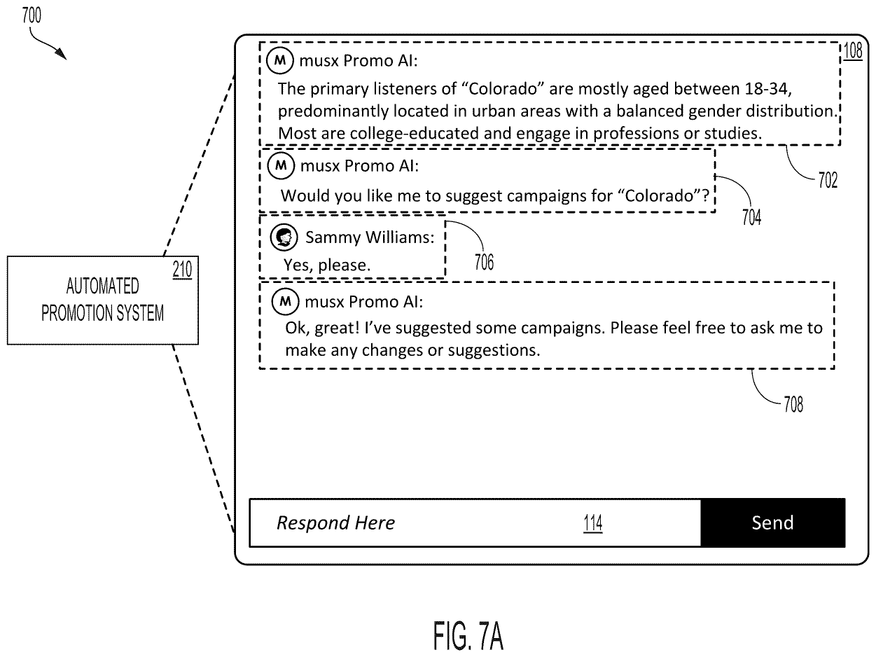

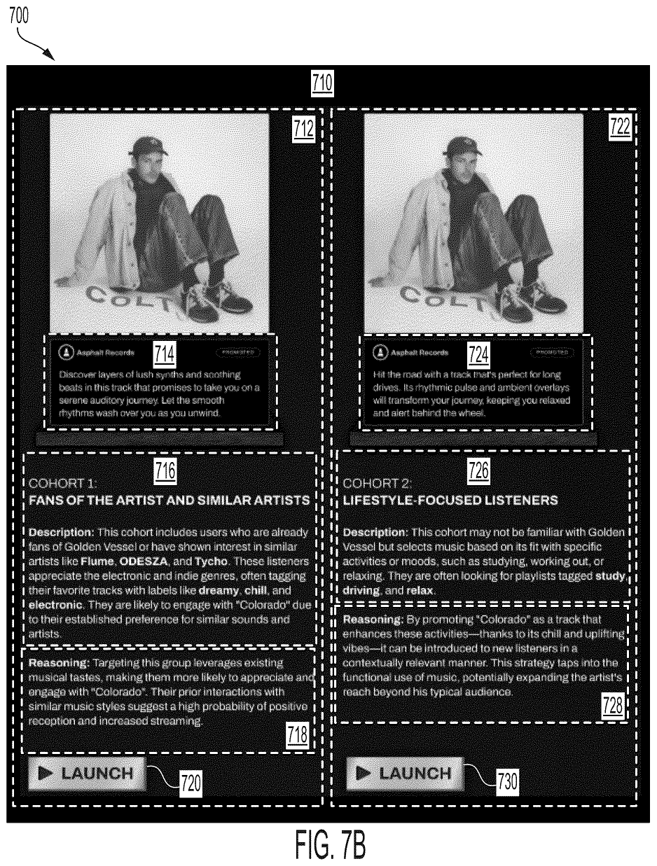

FIGS. 7A-7B show an illustrative example of an environment 700 in which an automated promotion system 210 dynamically generates different song promotion recommendations 712, 722 corresponding to different user cohorts in accordance with at least one embodiment. In the environment 700, the automated promotion system 210 may provide additional song analytics corresponding to the song specified by the music administrator through the interface 108. For instance, through the response 702 illustrated in FIG. 7A, the automated promotion system 210 may provide the music administrator with demographic information corresponding to users that have listened to or otherwise have interacted with the specified song.

As noted above, the P2P music recommendation service implements a machine learning algorithm or artificial intelligence that is trained to identify correlations between different users and songs shareable through the P2P music recommendation service. For instance, for any music recommendation requests and shared music recommendations associated with a particular song, the machine learning algorithm or artificial intelligence may dynamically retrieve any user profile data corresponding to the users associated with these music recommendation requests and shared music recommendations. This user profile data, for a particular user, may include any available user demographics (e.g., age, gender, education level, employment, etc.), user location, user hobbies, and the like. The machine learning algorithm or artificial intelligence may process these different user characteristics for the users corresponding to the music recommendation requests and shared music recommendations associated with a particular song to identify any correlations between these different user characteristics and the different characteristics of the particular song. For instance, the machine learning algorithm or artificial intelligence may evaluate all positive interactions with a particular song to identify the users associated with these positive interactions. The machine learning algorithm or artificial intelligence may evaluate the user profile data corresponding to these users to obtain corresponding user characteristics and, through clustering of these user characteristics, identify a set of representative user characteristics corresponding to a representative user that may have a positive interaction with the particular song. The characteristics corresponding to this representative user may be added to the song profile for the particular song.

The automated promotion system 210 may obtain from the song profile associated with the specified song, the set of representative user characteristics corresponding to the listening user cohort associated with the specified song. Through the one or more LLMs or other generative artificial intelligence systems, the automated promotion system 210 may dynamically generate a response 702 that incorporates this set of representative user characteristics that may be presented to the music administrator along with the aforementioned song analytics described above in connection with FIGS. 5-6.

In an embodiment, once the automated promotion system 210 has provided, through the interface 108, different song analytics corresponding to the specified song, the automated promotion system 210 can prompt the music administrator to determine whether they would like the automated promotion system 210 to generate tailored music promotion recommendations for the specified song. For example, as illustrated in FIG. 7A, the automated promotion system 210, through the one or more LLMs or other generative artificial intelligence processes, may dynamically generate a prompt 704 for the music administrator to determine whether the music administrator would like the automated promotion system 210 to generate tailored music promotion recommendations for the song “Colorado.” Through the input field 114 implemented on the interface 108, the music administrator may provide a response 706 to the prompt 704. This response 706 may be displayed through the interface 108. Further, the automated promotion system 210 may dynamically process this response 706 through the natural language processor 302 described above in connection with FIG. 3 to determine whether the response 706 is indicative of a request to generate one or more music promotion recommendations for the specified song. For example, if the music administrator submits an affirmative response (e.g., “Yes, please.”) in response to the prompt 704, the automation promotion system 210 may determine that the music administrator has submitted a request to generate one or more music promotion recommendations for the song. Alternatively, if the music administrator submits a negative response (e.g., “No, thanks.”, etc.), the automated promotion system 210 may determine that the music administrator is not interested in having any music promotion recommendation generated for the specified song. In some instances, the music administrator, in their response 706, may provide a detailed request to generate a tailored music promotion recommendation for the specified song. For example, rather than providing an affirmative or negative response to the prompt 704, the music administrator may submit a response that includes different parameters for a music promotion that the music administrator would like to implement for the song. These parameters may include, but are not limited to, the user cohort to which the song is to be promoted, the duration of the song promotion, the description to be included with the song promotion, artwork to be included with the song promotion, and the like. The automated promotion system 210, through the one or more LLMs or other generative artificial intelligence processes, may dynamically process the response 706 to obtain these parameters and construct a song promotion in accordance with these parameters.

If the music administrator submits, through the interface 108, an affirmative response to the prompt 704, the automated promotion system 210 may provide a new response 708 acknowledging the music administrator's request to obtain different music promotion recommendations. Further, the automated promotion system 210 may dynamically process the song analytics corresponding to the specified song to generate and present one or more music promotion recommendations for the specified song. As noted above, the automated promotion system 210 may implement a promotion generation module (such as promotion generation module 306 described above in connection with FIG. 3) that may dynamically process the song analytics corresponding to the specified song to generate a set of song promotion recommendations that may be provided in response to the query from the music administrator. For instance, through the aforementioned one or more LLMs or other generative artificial intelligence processes, the promotion generation module may aggregate and process the song analytics to identify any user cohorts for which tailored song recommendations may be generated. Returning to an earlier illustrative example, based on a cluster of tags commonly associated with the particular song, the promotion generation module (through the one or more LLMs or other generative artificial intelligence processes) may define a user cohort corresponding to a classification of this cluster of tags. For this user cohort, the promotion generation module may obtain additional user profile data that may be used to determine whether this user cohort is familiar with the song and, accordingly, derive a proposed song promotion that may be appealing to this user cohort. As another illustrative example, the promotion generation module may automatically define a user cohort corresponding to users that are familiar with the artist associated with the song and/or with similar artists, as identified through the song profile machine learning algorithm. For this user cohort, the promotion generation module may dynamically evaluate the user profile data associated with these users to identify any other user characteristics that may be used to define a proposed song promotion that may be appealing to this user cohort of fans of the artist and/or similar artists.

As illustrated in FIG. 7B, the automated promotion system 210, through a promotion recommendation interface 710, may present the music administrator with different music promotion recommendations corresponding to different user cohorts. For instance, in the illustrative example provided in FIG. 7B, the automated promotion system 210 has generated and presented two different song promotion recommendations 712, 722 corresponding to the same song. These different song promotion recommendations 712, 722 may be uniquely tailored according to the user cohorts associated with the different song promotion recommendations 712, 722. For example, the song promotion recommendation 712 may be associated with a user cohort corresponding to users that are fans of the artist and of similar artists. The song promotion recommendation 722, alternatively, may be associated with a user cohort corresponding to lifestyle-focused listeners.

The different song promotion recommendations 712, 722 may include corresponding song descriptions 714, 724 that may be tailored to the particular user cohort for which the song promotion is being generated and presented. For example, the song description 714 corresponding to the song promotion recommendation 712 may be tailored to appeal to fans of the artist associated with the song and to fans of other similar artists, whereby the song description 714 may include song characteristics that are commonly attributed to the artist of the specified song and to similar artists. As another illustrative example, the song description 724 corresponding to the song promotion recommendation 722 may be tailored to appeal to lifestyle-focused listeners, whereby the song description 724 may include song characteristics that may be tied to particular activities that correspond to user lifestyles. Further, the song description 724 may be constructed to make reference to these particular activities so as to entice these lifestyle-focused listeners.

The different song promotion recommendations 712, 722 may further include corresponding user cohort descriptions 716, 726 corresponding to the different user cohorts for which these different song promotion recommendations 712, 722 are being tailored. In addition to providing user cohort descriptions 716, 726 for the different user cohorts associated with the different song promotion recommendations 712, 722, the automated promotion system 210 may further provide corresponding reasonings 718, 728 for promoting the particular song to these user cohorts. These reasonings 718, 728 may provide additional insights into the corresponding user cohorts and into how promoting the specified song to these user cohorts may increase user engagement with the song through the P2P music recommendation service. As noted above, for each proposed song promotion recommendation 712, 722, the automated promotion system may leverage one or more LLMs or other generative artificial intelligence processes to generate the description of the corresponding user cohort and the reasoning for promoting the song to the user cohort.

The description of a user cohort and the corresponding reasoning for promoting the song to this user cohort may be dynamically generated by the one or more LLMs or other generative artificial intelligence processes using one or more knowledge bases corresponding to these user cohorts (as defined by the P2P music recommendation service or through observation over time). Returning to an earlier illustrative example, based on a selected user cohort, the one or more LLMs or other generative artificial intelligence processes implemented by the automated promotion system 210 may identify a knowledge base that includes basic descriptions of the user cohort and basic reasonings for promoting a song to this user cohort. The one or more LLMs or other generative artificial intelligence processes, using the historical song data from the song profile associated with the specified song and the user profile data corresponding to users in the selected user cohort, the one or more LLMs or other generative artificial intelligence processes may supplement the basic descriptions and basic reasonings from the knowledge base with such data to generate tailored descriptions and reasonings that are specific to the selected user cohort.

Through the interface 710, the music administrator may review these song promotion recommendations 712, 722, provide feedback related to these song promotion recommendations 712, 722, and submit requests to launch any of the song promotions recommended by the P2P music recommendation service. For example, as illustrated in FIG. 7B, the automated promotion system 210 may provide, for each song promotion recommendation 712, 722, a corresponding launch button 720, 730 that may be selected by the music administrator to request implementation of the corresponding song promotion. When a song promotion recommendation is accepted by a music administrator (such as through selection of a launch button corresponding to the song promotion recommendation), the automated promotion system 210 may deploy the selected song promotion for the particular song. For instance, the automated promotion system 210 may update the song profile associated with the song to incorporate the song promotion such that, in response to a music recommendation request including tags, user profile data, or other information that is associated with the particular song and the song promotion, the song promotion may be presented to the user that submitted the music recommendation request. As another illustrative example, if a user responding to a music recommendation request has selected a song that is similar to the particular song being promoted (e.g., the song has similar tags to those of the promoted song, the song is associated with a similar artist or to the same artist of the promoted song, etc.), the automated promotion system 210 may automatically surface the song promotion to the user. As yet another illustrative example, when a user accesses the P2P music recommendation service, the automated promotion system 210 may evaluate the user profile data associated with the user and identify the song promotion based on similarities between song preferences indicated in user profile data and the song profile for the particular song.

As noted above, the automated promotion system 210 may dynamically track user interactions with presented song promotions to determine the efficacy of these song promotions in increasing user engagement and interaction with the particular song. Based on aggregated data corresponding to these user interactions, the automated promotion system 210 may further retrain or otherwise update the one or more LLMs or other generative artificial intelligence processes trained to dynamically generate song promotion recommendations according to song profile data and user profile data. For instance, if a particular promotion launched by the automated promotion system 210 does not result in increased user interaction with a promoted song amongst a particular user cohort, the automated promotion system 210 may annotate the data point corresponding to the song promotion created for this user cohort to indicate that the song promotion was not appealing for the user cohort (including any feedback provided by users of user cohort). This data point may cause the automated promotion system 210, for similar songs and user cohorts, to adjust the proposed song promotion recommendations according to the obtained feedback.

In some instances, through the interface 108 illustrated in FIG. 7A, the automated promotion system 210 may automatically provide detailed analytics corresponding to a launched song promotion. As noted above, as users interact with presented song promotions, the music identification system may track these interactions through the music link database. This song promotion tracking data may be used to determine the efficacy of an implemented song promotion for a particular song in increasing user engagement and interaction with the particular song. The automated promotion system 210 may evaluate this song promotion tracking data to generate various performance metrics related to the song promotion that may be provided to the music administrator through the interface 108. These performance metrics may include user feedback to the song promotion that may denote whether the song promotion was received favorably by users presented with the song promotion. Based on this feedback, the automated promotion system 210 may dynamically retrain or otherwise update the one or more LLMs or other generative artificial intelligence processes to further improve the song promotion recommendations for different songs and corresponding to different user cohorts. Returning to an earlier illustrative example, if a particular promotion launched by the automated promotion system 210 does not result in increased user interaction with a promoted song amongst a corresponding user cohort, the automated promotion system 210 may annotate the data point corresponding to the song promotion associated with the song and created for this user cohort to indicate that the song promotion was not appealing for the user cohort (including any feedback provided by users of user cohort). The one or more LLMs or other generative artificial intelligence processes may process the updated dataset (including this newly annotated data point) to generate new outputs that may be evaluated by the automated promotion system 210 to dynamically update the one or more LLMs or other generative artificial intelligence processes as required to provide song promotion recommendations for different songs and user cohorts that may produce greater positive engagement with these different songs. Further, using the updated one or more LLMs or other generative artificial intelligence processes, the P2P music recommendation service may provide new song promotion recommendations. These new song promotion recommendations may include a retargeting of a same user cohort with a different song associated with the artist and/or with the music administrator. As another illustrative example, if the promoted song was well received by a user cohort, the P2P music recommendation service, through the updated one or more LLMs or other generative artificial intelligence processes, may automatically generate a new song promotion recommendation for a similar user cohort.

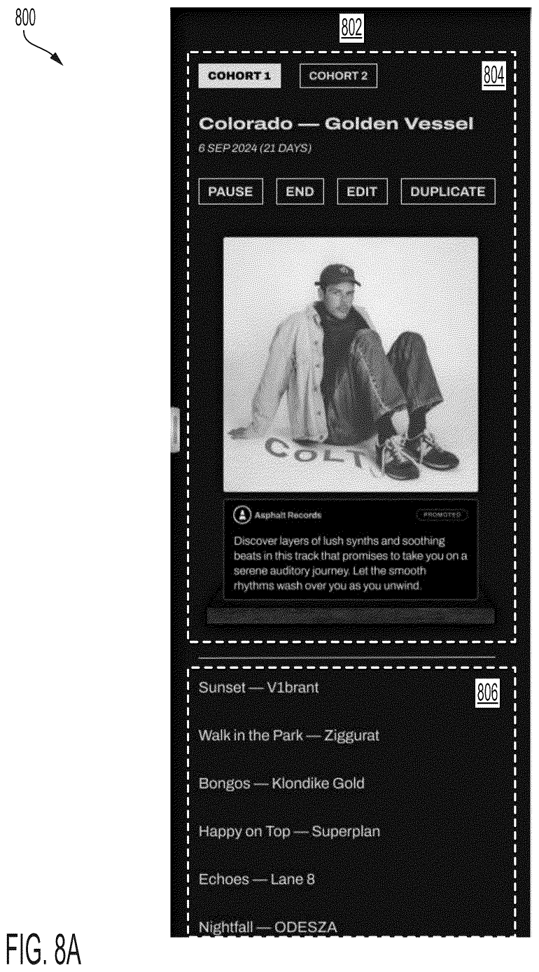

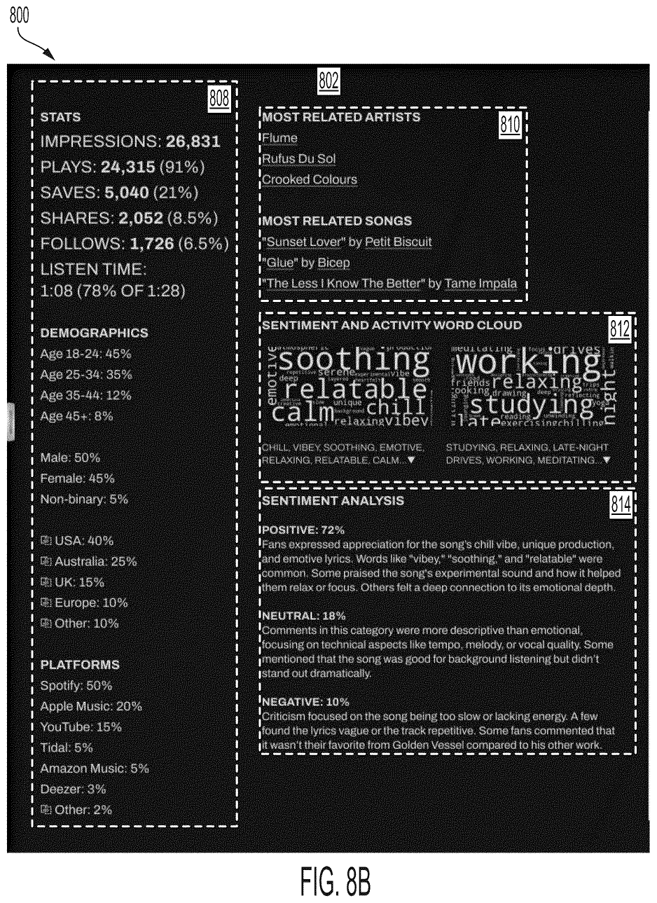

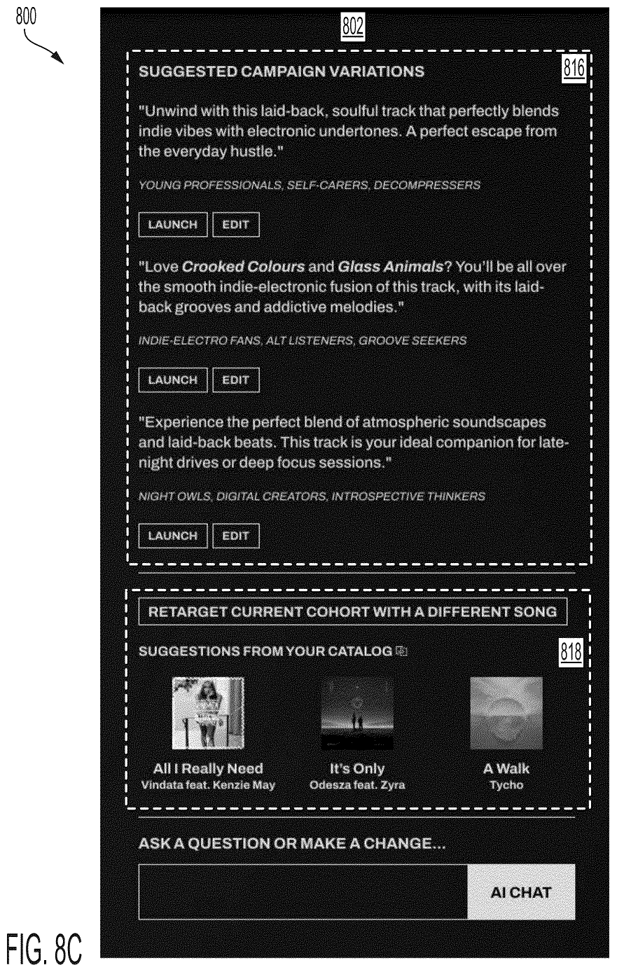

FIGS. 8A-8C show an illustrative example of an environment 800 in which an automated promotion system, through a user interface and for a particular music promotion, provides promotion analytics corresponding to the music promotion and recommendations for modifying the music promotion in accordance with at least one embodiment. In the environment 800, the automated promotion system provides a dashboard 802 through which the automated promotion system may provide detailed information and analytics corresponding to the performance of an existing music promotion implemented by a music administrator through the P2P music recommendation service. As illustrated in FIG. 8A, the automated promotion system, through the dashboard 802, may provide a graphical representation of an active song promotion 804 implemented by a music administrator through the P2P music recommendation service and presented to different users belonging to a defined user cohort.

The illustrative example of the active song promotion 804 presented through the dashboard 802, as illustrated in FIG. 8A, may correspond to the song promotion recommendation 712 previously presented to a music administrator for a particular user cohort. As noted above, the song promotion recommendation 712 may be provided with a corresponding song description that is tailored to the particular user cohort for which the song promotion is being generated and presented. For example, the song promotion recommendation 712 may be tailored to appeal to fans of the artist associated with the song and to fans of other similar artists, whereby the song description may include song characteristics that are commonly attributed to the artist of the specified song and to similar artists. When a music administrator submits a request to launch the song promotion recommendation 712, the automated promotion system may deploy the song promotion for the particular song. Further, through the dashboard 802, the automated promotion system may present, to the music administrator, the active song promotion 804 launched from the accepted song promotion recommendation 712.

In an embodiment, the automated promotion system, through the dashboard 802, provides a music administrator with a set of options for managing an active song promotion 804. For example, as illustrated in FIG. 8A, the automated promotion system may provide the music administrator to pause the active song promotion 804, end the active song promotion 804, edit the active song promotion 804, or duplicate the active song promotion 804. If the music administrator, through the dashboard 802, selects a presented option to pause the active song promotion 804, the automated promotion system may update the song profile associated with the song to indicate that the active song promotion 804 is suspended. This indication in the song profile may prevent the song promotion from being presented in response to music recommendation requests including tags, user profile data, or other information that is associated with the song and the active song promotion 804. In some instances, through the dashboard 802, the music administrator may pause an active song promotion 804 for a defined period of time after which the automated promotion system may automatically update the song profile to make the song promotion available and presentable in response to music recommendation requests including the tags, user profile data, or other information associated with the song and the active song promotion 804.

If the music administrator selects a presented option to end the active song promotion 804, the automated promotion system may automatically update the song profile corresponding to the song being promoted to remove any reference to the active song promotion 804. This may prevent presentation of the active song promotion 804 in response to new music recommendation requests including the tags, user profile data, or other information associated with the song. Further, the automated promotion system may aggregate any available analytics corresponding to the concluded song promotion, as well as recommendations for improving future song promotions, as described in greater detail herein.

In an embodiment, if the music administrator selects, from the dashboard 802, an option to edit the active song promotion 804, the automated promotion system updates the dashboard 802 to provide the music administrator with various options and recommendations for editing the active song promotion 804. For example, the automated promotion system may process any obtained analytics corresponding to the active song promotion 804, as well as the different active song promotion parameters (as obtained from the song profile associated with the particular song) to generate and present different recommendations for modifying the active song promotion 804 for the specified song. As noted above, the automated promotion system may implement a promotion generation module (such as the promotion generation module 306 described above in connection with FIG. 3) that may dynamically process the song analytics corresponding to the specified song to generate a set of song promotion recommendations that may be provided to the music administrator for a particular song. For instance, through the aforementioned one or more LLMs or other generative artificial intelligence processes, the automated promotion system may aggregate and process the song analytics corresponding to the active song promotion 804 to generate different recommendations for modifying the active song promotion 804. For example, if the automated promotion system determines, through the one or more LLMs or other generative artificial intelligence processes and based on the song analytics, that users within the user cohort for which the song promotion was generated are not receiving the song promotion favorably, the automated promotion system may re-evaluate a cluster of tags commonly associated with the particular song to refine the user cohort or define a new user cohort corresponding to a classification of this cluster of tags. For a refined or new user cohort, the automated promotion system may obtain additional user profile data that may be used to determine whether this refined or new user cohort is familiar with the song and, accordingly, derive recommendations for modifications to the active song promotion 804 that may make the active song promotion 804 appealing to this refined or new user cohort.

If the automated promotion system refines an existing user cohort or defines a new user cohort that may be presented to the music administrator in response to a request to edit the active song promotion 804, the automated promotion system may provide a recommendation corresponding to a new song description that may be provided for the active song promotion 804. This new song description may be tailored to the refined or new user cohort according to song characteristics that may be appealing to this refined or new user cohort. If the automated promotion system refines the original user cohort or defines a new user cohort for the active song promotion 804 based on an evaluation of the active song promotion analytics, the automated promotion system may generate and provide a description of the refined or new user cohort and rationales for modifying the active song promotion 804 to appeal to this refined or new user cohort. The description and corresponding rationales may be generated by the one or more LLMs or other generative artificial intelligence processes using one or more knowledge bases corresponding to these user cohorts, as described above.

In an embodiment, any edits made to an active song promotion 804 are used to dynamically retrain or otherwise update the one or more LLMs or other generative artificial intelligence processes implemented to provide different song promotion recommendations for different songs and corresponding to different user cohorts. For instance, if a music administrator redirects the active song promotion 804 towards a new user cohort based on the available song promotion analytics, the automated promotion system may update the training dataset for the one or more LLMs or other generative artificial intelligence processes to add a new data point corresponding to the active song promotion 804, including the original user cohort for which the song promotion was created, any applicable song promotion analytics, and the corresponding edits made to the active song promotion 804 as a result of the applicable song promotion analytics. The one or more LLMs or other generative artificial intelligence processes may process the updated dataset (including this newly annotated data point) to generate new outputs that may be evaluated by the automated promotion system to dynamically update any hyperparameters or other model coefficients as required to provide song promotion recommendations for different songs and user cohorts that may produce greater positive engagement with these different songs.

Through the dashboard 802, the automated promotion system may provide the music administrator with a panel 806 through which the music administrator may review any other existing song promotions corresponding to other songs and/or artists. For instance, a music administrator may concurrently manage different song promotions corresponding to different songs and/or artists associated with a music label managed by the music administrator. If the music administrator, through the panel 806, selects a different song for which one or more song promotions are active through the P2P music recommendation service, the automated recommendation system may dynamically update the dashboard 802 to present the active song promotions corresponding to the different song, as well as any available song promotion analytics and other recommendations corresponding to these active song promotions.

As illustrated in FIG. 8B, the automated promotion system, through the dashboard 802, provides a song statistics panel 808 through which the automated promotion system may present detailed statistics corresponding to user interactions with the promoted song. As noted above, the automated promotion system may automatically provide detailed analytics corresponding to an active song promotion. For instance, as users interact with presented song promotions, the music identification system may track these interactions through the music link database. The automated promotion system may evaluate this song promotion tracking data to generate various performance metrics related to the song promotion that may be provided to the music administrator through the song statistics panel 808. These performance metrics may include statistics corresponding to number of song promotion impressions through which the promoted song was presented to different users associated with a user cohort. The automated promotion system may track, from these impressions, the number of times that the promoted song was played by these users, the number of times that the promoted song was saved by these users, the number of times that the promoted song was shared with other users, the number of times users opted to follow the corresponding artist in response to the song recommendation, the average amount of time that users spent listening to the promoted song, and the like. These statistics may be used by the music administrator to determine the efficacy of the song promotion in getting users to interact with the promoted song, as well as determine whether the promoted song was well received by these users.

In an embodiment, the automated promotion system may dynamically process the generated statistics to provide demographic information corresponding to the users that have interacted with the song promotion. For instance, for each user interaction with the song promotion, the automated promotion system may access the user profile associated with the user interacting with the song promotion to obtain demographic information associated with the user. This demographic information may include the age of the user, the gender of the user, the location of the user, and the like. The automated promotion system may aggregate the obtained demographic information corresponding to the population of the users that have interacted with the song promotion to provide a breakdown of user demographics. This may be used by the music administrator to identify the user demographic that the music administrator may target for future promotions of the song, the artist associated with the song, the music label associated with the song, and the like.

In some instances, the automated promotion system may process the generated statistics to identify the different music streaming platforms or other streaming services through which the promoted song was accessed in response to the song promotion. In some instances, the P2P music recommendation service may provide access to the P2P music recommendation service through a module or application implemented on an alternative music streaming platform or other streaming service. As an illustrative example, if a user is listening to a particular song via an alternative music streaming service, and the alternative music streaming service provides the user with access to the P2P music recommendation service via a module implemented by the alternative music streaming service (e.g., an icon corresponding to the module presented via an interface of the alternative music streaming service, etc.), the user may utilize the module to access the P2P music recommendation service. This may allow the user to access any song promotions that may be provided to the user by virtue of the user being a member of the user cohort for which the song promotion was generated. As users interact with song promotions through these alternative music streaming services, the automated promotion system may track the platforms from which these users are accessing the song promotions.

Through the dashboard 802, the automated promotion system may further provide a related artists and songs panel 810 through which the automated promotion system may indicate which artists and songs are closely related to the promoted song. For instance, based on song profile data corresponding to the promoted song and evaluation of user profile data, the automated promotion system may identify other songs that are commonly recommended by users that have interacted with the song promotion and the promoted song. Further, the automated promotion system may provide, through the related artists and songs panel 810, a listing of different artists whose fans, based on listening habits and cross-genre appeal, are likely to appreciate the promoted song. This listing of different artists may be generated by the song profile machine learning algorithm described above based on analysis of the song profile corresponding to the promoted song and evaluation of user profile data corresponding to users that interacted with the promoted song.

The automated promotion system may further provide, through the dashboard 802, analytics corresponding to different sentiments and activities that may be linked to the promoted song according to user interactions with the promoted song. Similar to the identification of different clusters of tags that may be associated with different sentiments, the automated promotion system (through the one or more LLMs or other generative artificial intelligence processes) may dynamically evaluate the tag profiles corresponding to the different tags associated with the promoted song and the user cohort to which the song was promoted. As noted above, in some instances, a particular tag may be inherently associated with a particular activity. For example, the “studying” tag may be inherently associated with the act of studying, by definition. As another illustrative example, the “walking” tag may be inherently associated with the act of walking. Thus, the automated promotion system may dynamically evaluate the set of tags that that are commonly associated with the promoted song by the user cohort to identify any tags corresponding to different user sentiments and activities.

The automated promotion system, through the one or more LLMs or other generative artificial intelligence processes, may select which tags corresponding to different activities and sentiments may be presented through the dashboard 802 according to the frequency in which these tags are associated with the song by different users. For instance, the automated promotion system, through a word cloud panel 812 of the dashboard 802, may dynamically generate a sentiment word cloud and an activity word cloud that may be populated with different sentiment and activity tags, respectively, according to the frequency in which these tags are assigned to the promoted song by different users interacting with the promoted song. For example, the automated promotion system may dynamically monitor song recommendations provided by different users and corresponding to the promoted song in response to recommendation requests to identify the different tags associated with these recommendation requests (e.g., the promoted song may be associated with the different tags by virtue of being recommended in response to recommendation requests associated with the different tags). As another illustrative example, the automated promotion system may dynamically monitor user interactions with a promoted song when the promoted song has been recommended to different users and in response to recommendation requests including different tags. For instance, when a user saves the promoted song, the automated promotion system may record the one or more tags associated with the recommendation request for which the promoted song was provided. As yet another illustrative example, the automated promotion system may dynamically monitor user responses (e.g., comments related to song recommendations including the promoted song, actual recommendations including the promoted song, etc.) to recommendation requests to identify the tags assigned to the promoted song in these user responses.

The size of the different words (i.e., tags) within each word cloud may correspond to the frequency in which the different words were encountered during the lifetime of the song promotion. In some instances, the size of the different words within each word cloud may further correspond to a polarity of the responses for which the tags were assigned. For example, the size of a particular tag within a word cloud may reflect positive engagement with the promoted song for which the tag was assigned while the song promotion was active. Thus, through the word cloud panel 812, the music administrator may readily determine which sentiment and activity tags are most commonly associated with the promoted song, as indicated by different users.

In an embodiment, the automated promotion system further provides, through a sentiment analysis panel 814, a sentiment analysis corresponding to the different responses provided by different users interacting with the song promotion. To generate the sentiment analysis, the automated promotion system may process any user feedback corresponding to the song promotion through the one or more LLMs or other generative artificial intelligence processes to generate a summary of the feedback associated with the song promotion according to different user sentiments towards the promoted song (e.g., positive, neutral, and negative). The sentiment analysis may be dynamically generated by the automated promotion system by processing the aggregated song promotion analytics and user comments/feedback through the aforementioned one or more LLMs or other generative artificial intelligence processes. For instance, the one or more LLMs or other generative artificial intelligence processes may leverage one or more knowledge bases corresponding to known sentiments (as defined by the P2P music recommendation service or through observation over time), as well as natural language processing, to dynamically evaluate different user comments and feedback corresponding to the promoted song. Based on the aggregated music analytics and the user feedback, the automated promotion system may identify one or more knowledge bases that include basic or generic descriptions of these identified sentiments and basic or generic reasonings for these sentiments according to provided user comments and feedback. Through the one or more LLMs or other generative artificial intelligence processes and using the generic descriptions from the identified knowledge bases, as well as the actual comments and feedback provided by different users, the automated promotion system may dynamically process the aggregated music analytics and user feedback associated with the promoted song, to supplement the basic or generic descriptions from the knowledge bases with additional data that is specific to the promoted song.

In an embodiment, the automated promotion system can further provide, for an active song promotion, recommendations for variations to the active song promotion that may be implemented to reach other audiences that are likely to react positively to the promoted song. For instance, the automated promotion system may dynamically process the song analytics corresponding to the promoted song and to the active song promotion, as well as the user profiles corresponding to the users that have interacted with the promoted song and/or the song promotion, through the one or more LLMs or other generative artificial intelligence processes to identify any new user cohorts for which the promoted song is likely to be received positively. Returning to an earlier illustrative example, based on a cluster of tags commonly associated with the promoted song (as determined based on the song analytics corresponding to the promoted song and the song promotion itself), the one or more LLMs or other generative artificial intelligence processes may define a user cohort corresponding to a classification of this cluster of tags. For this user cohort, the one or more LLMs or other generative artificial intelligence processes may obtain additional user profile data that may be used to determine whether this user cohort is familiar with the song and, accordingly, generate a recommended song promotion that may be appealing to this user cohort. As another illustrative example, the one or more LLMs or other generative artificial intelligence processes may automatically define a user cohort corresponding to users that are familiar with the artist associated with the promoted song and/or with similar artists, as identified through the song profile machine learning algorithm. For this user cohort, the promotion generation module may dynamically evaluate the user profile data associated with these users to identify any other user characteristics that may be used to define a recommended song promotion that may be appealing to this user cohort of fans of the artist and/or similar artists.

As illustrated in FIG. 8C, the automated promotion system, through a suggested campaign variations panel 816 provided through the dashboard 802, may provide a set of recommended song promotions generated through the aforementioned one or more LLMs or other generative artificial intelligence processes according to the most recent song analytics associated with the promoted song and with the song promotion. These recommended song promotions may correspond to different user cohorts identified by the one or more LLMs or other generative artificial intelligence processes through evaluation of the most recent song analytics. Further, for each recommended song promotion, the one or more LLMs or other generative artificial intelligence processes may provide a corresponding song description that may be tailored to the particular user cohort which the recommended song promotion has been generated and presented through the suggested campaign variations panel 816. In some instances, the automated promotion system may provide, for each recommended song promotion, options to either launch the recommended song promotion or to edit the recommended song promotion. If the music administrator selects an option to edit a recommended song promotion, the automated promotion system may dynamically update the dashboard 802 to present a detailed description of the recommended song promotion. The presentation of the recommended song promotion may be similar to that of the song promotions illustrated in FIG. 7B, whereby the automated promotion system may provide the song description tailored for the particular user cohort for which the recommended song promotion was generated, a description of the user cohort, and rationales for promoting the song to this user cohort. The description of the user cohort and the rationales for promoting the song to this user cohort may be generated by the one or more LLMs or other generative artificial intelligence processes, as described above.

If the music administrator, through the suggested campaign variations panel 816, selects an option to request implementation of a recommended song promotion, the automated promotion system may deploy the recommended song promotion for the promoted song. For instance, the automated promotion system may update the song profile associated with the song to incorporate the new song promotion such that, in response to a music recommendation request including tags, user profile data, or other information that is associated with the particular song and the song new promotion, the new song promotion may be presented to the user that submitted the music recommendation request. Returning to an earlier illustrative example, if a user responding to a music recommendation request has selected a song that is similar to the particular song being promoted (e.g., the song has similar tags to those of the promoted song, the song is associated with a similar artist or to the same artist of the promoted song, etc.), the automated promotion system may automatically surface the new song promotion to the user. As yet another illustrative example, when a user accesses the P2P music recommendation service, the automated promotion system may evaluate the user profile data associated with the user and identify the song promotion based on similarities between song preferences indicated in user profile data (e.g., whether the user belongs to the user cohort for which the new song promotion was generated, etc.) and the song profile for the particular song.

In addition to providing recommended song promotions for different user cohorts, the automated promotion system, through the one or more LLMs or other generative artificial intelligence processes, may process the song analytics corresponding to the promoted song and to the active song promotion, as well as the user profiles corresponding to the users that have interacted with the promoted song and/or the song promotion to identify any other songs that may be promoted to the user cohort for which the original song promotion was implemented. For instance, the automated promotion system, through the one or more LLMs or other generative artificial intelligence processes may dynamically process user profile data corresponding to the user cohort to identify a set of songs associated with the music administrator that may be promoted to the user cohort and that may be positively received by the user cohort. The one or more LLMs or other generative artificial intelligence processes may dynamically process the user profile data to generate new reecommended song promotions according to different vectors of similarity defined based on song characteristics (e.g., genre, artist, music label, etc.) and user characteristics (e.g., user song preferences, user location, user demographics, etc.) defined in the user profile data. According to the vector values corresponding to the user profile data, the automated promotion system may identify a set of songs associated with the music administrator and that includes various characteristics whose vector values are in relative proximity to the vector values corresponding to the user profile data.

In an embodiment, and as illustrated in FIG. 8C, the automated promotion system provides a panel 818 through which the automated promotion system can present one or more other songs associated with the music administrator that may be promoted to the user cohort associated with the original song promotion presented through the dashboard 802. These one or more other songs may be selected by the automated promotion system through the one or more LLMs or other generative artificial intelligence processes described above. Further, through the panel 818, the automated promotion system may provide the music administrator with an option to redirect the user cohort with a different song that can be selected from the one or more other songs provided through the panel 818. If the music administrator selects the option to retarget the user cohort with a different song, the automated promotion system may update the dashboard 802 to present a detailed description of the new song promotion corresponding to the different song. The presentation of the new song promotion may be similar to that of the song promotions illustrated in FIG. 7B, whereby the automated promotion system may provide a song description corresponding to the different song and tailored for the particular user cohort for which the new song promotion was generated, a description of the user cohort, and rationales for promoting the different song to this user cohort. The description of the user cohort and the rationales for promoting the song to this user cohort may be generated by the one or more LLMs or other generative artificial intelligence processes, as described above.

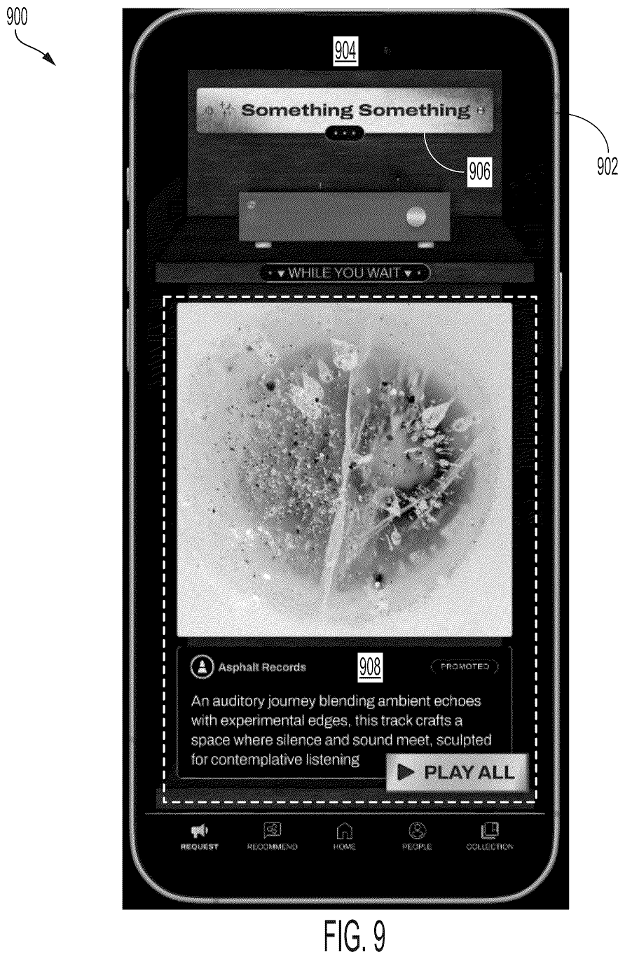

FIG. 9 shows an illustrative example of an environment 900 in which a P2P music recommendation service automatically surfaces a music promotion in response to a user request for music recommendations in accordance with at least one embodiment. In the environment 900, a user of the P2P music recommendation service, through their computing device 902, may submit a request for music recommendations from other users of the P2P music recommendation service. As noted above, when a user submits a new music recommendation request to the P2P music recommendation service, the P2P music recommendation service can automatically surface one or more song promotions that may be of interest to the user. For instance, through an interface 904 corresponding to the new music recommendation request, the P2P music recommendation service may automatically provide a name 906 for the music recommendation request. This name 906 may be automatically generated by the P2P music recommendation service based on the parameters of the music recommendation request (e.g., tags selected by the user, keywords or phrases included in the music recommendation request, a request label supplied by the user, etc.). Further, the P2P music recommendation service may provide, through the interface 904, a song promotion window 908 through which different song promotions may be presented to the user while awaiting responses to the music recommendation request from other users of the P2P music recommendation service.

As noted above, when a song promotion for a particular song is deployed, the P2P music recommendation service may update a song profile associated with the particular song to incorporate the song promotion. In response to a music recommendation request, the P2P music recommendation service may dynamically process any tags, user profile data, and any other information associated with the music recommendation request to identify a song promotion that may be presented to the user through the song promotion window 908. For instance, the P2P music recommendation service may process this request data through a promotion selection algorithm that is dynamically trained to identify song promotions according to different vectors of similarity defined based on different tags, song characteristics (e.g., genre, artist, music label, etc.), and user characteristics (e.g., user song preferences, user location, user demographics, etc.) defined in the request data. According to the vector values corresponding to the request data, the promotion selection algorithm may identify a song promotion that includes various characteristics whose vector values are in relative proximity to the vector values corresponding to the request data.

A song promotion provided through the song promotion window 908 may include various elements. For instance, as illustrated in FIG. 9, a song promotion may include artwork corresponding to the promoted song (e.g., album artwork, single artwork, artist artwork, etc.). Further, the song promotion may include a song description that provides context that may be appealing to the user. As noted above, the automated promotion system implemented by the P2P music recommendation service may provide music administrators with different song promotion recommendations that are specific to different user cohorts. The song description provided in each of these different song promotion recommendations may be tailored according to the user cohort for which the song promotion recommendation is generated and that may be appealing to this user cohort. Thus, in some instances, the P2P music recommendation service, based on user profile data corresponding to the user and the music recommendation request, may identify the user cohort that the user belongs to and, accordingly, provide a song description that is tailored for the user cohort.

In an embodiment, the P2P music recommendation service, based on the user profile data corresponding to the user and the music recommendation request, can further tailor the song description according to the user's personal behavior and preferences. For example, the P2P music recommendation service, through the one or more LLMs or other generative artificial intelligence processes described above, may process the original song description for the song promotion and the historical activity associated with the user (e.g., songs previously recommended by the user to other users, the tags associated with these previously recommended songs, any available contextual information corresponding to these previously recommended songs, etc.) to tailor a user-specific song description that incorporates the user's unique behaviors, preferences, and other idiosyncrasies.

As noted above, the P2P music recommendation service may dynamically track user interactions with the presented song promotion to determine the efficacy of the song promotion in increasing user engagement and interaction with the particular song. Based on aggregated data corresponding to these user interactions, the P2P music recommendation service may retrain or otherwise update the one or more LLMs or other generative artificial intelligence processes trained to dynamically generate song promotion recommendations according to song profile data and user profile data. For instance, if the user does not interact with the song promotion presented in the song promotion window 908, the P2P music recommendation service may annotate the data point corresponding to the song promotion created for this user cohort to indicate that the song promotion was not appealing for the user cohort (including any feedback provided by the user). This data point may cause the P2P music recommendation service, for similar songs and user cohorts, to adjust the proposed song promotion recommendations according to the obtained feedback. Alternatively, if the user, through the song promotion window 908, interacts with the song promotion (e.g., opts to play the promoted song, saves the promoted song to a playlist, shares the promoted song to other users, etc.), the P2P music recommendation service may annotate the data point corresponding to the song promotion created for this user cohort to indicate that the song promotion was received positively by the user. This may cause the P2P music recommendation service, for similar songs and user cohorts, to generate recommendations for similar song promotions that may be presented to similar user cohorts.

In an embodiment, the P2P music recommendation service, through the song promotion window 908, can provide the user with an option to determine why the user was selected for presentation of the song promotion. If the user selects this option, the P2P music recommendation service may update the interface 904 to provide the user with information corresponding to the user cohort that the user is associated with, as well as a detailed description as to why the song was selected for promotion to this user cohort.

It should be noted that the P2P music recommendation service can automatically surface a music promotion to a user at any time and not just in response to user requests for music recommendations. For example, the P2P music recommendation service can automatically surface a music promotion alongside other music recommendations provided by other users in response to a music recommendation request. As another illustrative example, the P2P music recommendation service can automatically surface a music promotion to a user when the user first accesses the P2P music recommendation service or otherwise initiates a new session with the P2P music recommendation service. As yet another illustrative example, the P2P music recommendation service can automatically surface a music promotion to a user as the user generates and provides a response to a received music recommendation request from another user or as the user otherwise shares a different song to the other user.

FIG. 10 shows an illustrative example of an environment 1000 in which a P2P music recommendation service provides a set of songs 1010 associated with a music administrator to different users through a music administrator profile page 1004 in accordance with at least one embodiment. In the environment 1000, a user of the P2P music recommendation service may access a music administrator profile page 1004 through which the music administrator may promote various songs 1010 to users of the P2P music recommendation service. For instance, when a user, through their computing device 1002, accesses the P2P music recommendation service (such as through a web portal or application provided by the P2P music recommendation service), the P2P music recommendation service may present one or more recommendations corresponding to different music administrators that may be of interest to the user.

In an embodiment, when the user accesses the P2P music recommendation service, the P2P music recommendation service may process the user profile associated with the user through a trained machine learning algorithm to identify one or more music administrators that may be promoted to the user. The machine learning algorithm may be dynamically trained using a dataset of sample user profiles (e.g., actual user profiles, hypothetical user profiles, etc.) and sample music administrator profiles (e.g., actual music administrator profiles, hypothetical music administrator profiles, etc.). For instance, the machine learning algorithm may analyze the dataset to identify any correlations between the different sample user profiles (e.g., user music preferences or tastes, tags associated with shared songs and/or submitted recommendation requests, known or frequent locations, user demographics, etc.) and the different sample music administrator profiles (e.g., musical genres associated with songs shared by the music administrator, location of the music administrator, tags associated with songs shared by the music administrator, etc.). The machine learning algorithm may classify the sample user profiles and sample music administrator profiles according to one or more vectors of similarity between the sample user profiles and the sample music administrator profiles.

Through the processing of the different sample user profiles and of the different sample music administrator profiles, the machine learning algorithm may generate partial matches among the different sample user profiles and the different sample music administrator profiles to identify, for each sample user profile, one or more sample music administrators that may be associated with different songs that may be appealing to the user. The P2P music recommendation service may evaluate these output partial matches against a set of expected partial matches (as defined in the dataset) to determine whether the machine learning algorithm is accurately identifying the music administrators that may be recommended to the user according to the corresponding user profile. Based on this evaluation, the P2P music recommendation service may dynamically update one or more model coefficients of the machine learning algorithm to dynamically improve the accuracy of the machine learning algorithm in identifying music administrators that may be appealing to a user. For instance, if the output of the machine learning algorithm does not satisfy one or more criteria (e.g., does not identify the appropriate music administrators based on a given sample user profile, etc.), the P2P music recommendation service may iteratively update one or more model coefficients of the machine learning algorithm to generate an updated machine learning algorithm. The updated machine learning algorithm or artificial intelligence may be used to process the aforementioned training dataset, as well as any additional data points or other datasets obtained by the P2P music recommendation service to generate a new output for each data point in the training dataset. In some instances, the P2P music recommendation service may use an optimization algorithm to iteratively update the one or more coefficients of the set of coefficients associated with the machine learning algorithm. For instance, the P2P music recommendation service may use gradient descent to update the logistic coefficients of the machine learning algorithm to generate new cutoff values that may be used to classify the data points of the previously evaluated dataset and of any new data points obtained by the P2P music recommendation service. The P2P music recommendation service may use this updated machine learning algorithm to process the available data points and generate a new output. The P2P music recommendation service may evaluate this new output to determine whether the output satisfies the one or more criteria. This process of updating the set of coefficients associated with the machine learning algorithm according to the one or more criteria may be performed iteratively until an updated machine learning algorithm is produced that satisfies the one or more criteria.

In an embodiment, if the output generated by the machine learning algorithm satisfies the one or more criteria, the P2P music recommendation service implements the machine learning algorithm to dynamically, and in real-time, process (in response to user accessing the P2P music recommendation service) user profiles associated with the different users to identify different music administrators that may be promoted to these different users. For example, as illustrated in FIG. 10, based on a user profile corresponding to the user of the computing device 1002, the P2P music recommendation service may identify Asphalt Records as being a music administrator that may be appealing to the user. Through the music administrator profile page 1004, the user may review a description 1006 corresponding to the different songs shared by the music administrator to different users. In an embodiment, the description 1006 may be dynamically generated using one or more LLMs or other generative artificial intelligence processes and according to the user profile associated with the user accessing the music administrator profile page 1004. These one or more LLMs or other generative artificial intelligence processes may be similar to those implemented by the automated promotion system described above in connection with FIGS. 2-3. For instance, through the one or more LLMs or other generative artificial intelligence processes, the P2P music recommendation service may identify any user cohorts to which different music administrators may be recommended. As an illustrative example, based on a cluster of tags commonly associated with a set of users, the one or more LLMs or other generative artificial intelligence processes may define a user cohort corresponding to a classification of this cluster of tags. For this user cohort, the one or more LLMs or other generative artificial intelligence processes may obtain additional user profile data that may be used to identify different music administrators that may be appealing to this user cohort. As another illustrative example, the one or more LLMs or other generative artificial intelligence processes may automatically define a user cohort corresponding to users that are familiar with a music administrator (including any artists and/or songs associated with the music administrator). For this user cohort, the one or more LLMs or other generative artificial intelligence processes may dynamically evaluate the user profile data associated with these users to identify any other user characteristics that may be used to identify music administrators that may be appealing to this user cohort.

The description 1006 may be tailored to the particular user cohort that the user belongs to and for whom the music administrator page 1004 is being presented. For example, the description 1006 corresponding to the songs shared by the music administrator may be tailored to include song characteristics that are commonly attributed to the artists and/or songs shared by the music administrator. Further, the description 1006 may be tailored according to common music preferences associated with the user cohort. For example, the description 1006 may be tailored towards a user cohort that is known to include users that are reflective or contemplative in nature and that become engrossed in the music that they listen to. Through the one or more LLMs or other generative artificial intelligence processes, the P2P music recommendation service may craft a description 1006 that incorporates these characteristics of the user cohort to make the music administrator page 1004 more appealing to users of this user cohort.

In an embodiment, in addition to providing a description 1006 representative of the songs shared by the music administrator, the music administrator page 1004 includes a set of songs 1008 that may be recommended to the user and that may be representative of the different artists and/or songs associated with the music administrator. The selection of this set of songs 1008 may be performed through a process like that described above in connection with FIG. 9 for identifying and presenting song promotions to different users. For instance, when the user accesses the music administrator page 1004, the P2P music recommendation service may dynamically process user profile data corresponding to the user (including any information corresponding to previously submitted music recommendation requests and to previously shared songs) to identify a set of songs 1008 associated with the music administrator that may be presented to the user through the music administrator page 1004. The P2P music recommendation service may dynamically process the user profile data through the aforementioned promotion selection algorithm that is dynamically trained to identify song promotions according to different vectors of similarity defined based on song characteristics (e.g., genre, artist, music label, etc.) and user characteristics (e.g., user song preferences, user location, user demographics, etc.) defined in the user profile data. According to the vector values corresponding to the user profile data, the promotion selection algorithm may identify a set of songs 1008 associated with the music administrator and that includes various characteristics whose vector values are in relative proximity to the vector values corresponding to the user profile data.

The P2P music recommendation service may track user interactions with the set of songs 1008 provided through the music administrator page 1004 to determine the efficacy of the music administrator page 1004 in increasing user engagement with the set of songs 1008 and with the music administrator. Based on aggregated data corresponding to these user interactions, the P2P music recommendation service may retrain or otherwise update the one or more LLMs or other generative artificial intelligence processes trained to dynamically generate customized music administrator pages and to select songs associated with the music administrator that may be appealing to different users and/or user cohorts. For instance, if the user does not interact with any of the songs 1008 provided through the music administrator page 1004, the P2P music recommendation service may annotate the data point corresponding to the music administrator page 1004 and the set of songs 1008 selected for this user cohort to indicate that the set of songs 1008 was not appealing to the user cohort (including any feedback provided by the user with regard to the set of songs 1008 and/or the music administrator page 1004). This data point may cause the P2P music recommendation service, for similar user cohorts, to adjust the set of songs that may be presented to these similar user cohorts according to the obtained feedback. Alternatively, if the user, through the music administrator page 1004, interacts with the one or more songs from the set of songs 1008 (e.g., opts to play one or more songs from the set of songs 1008, saves one or more songs to a playlist, shares one or more songs to other users, promotes the music administrator to other users, etc.), the P2P music recommendation service may annotate the data point corresponding to the music administrator page 1004 and the set of songs 1008 selected for this user cohort to indicate that the set of songs 1008 and the music administrator page 1004 were received positively by the user. This may cause the P2P music recommendation service, for user cohorts, to provide this set of songs 1008 to users of these similar user cohorts when accessing the music administrator page 1004.

In an embodiment, the P2P music recommendation service further tracks user interactions with the set of songs 1008 to determine whether to dynamically adjust the songs being promoted or otherwise presented to the user through the music administrator page 1004. For example, as the user interacts with the set of songs 1008 presented through the music administrator page 1004, the P2P music recommendation service may dynamically update the user profile corresponding to the user to indicate the user's feedback with regard to the set of songs 1008. The updated user profile may be processed through the one or more LLMs or other generative artificial intelligence processes to dynamically identify any updates to the music administrator page 1004 and/or to the set of songs 1008 presented to the user. For example, if a user opts to save a particular song from the set of songs 1008 presented through the music administrator page 1004, the P2P music recommendation service may, in real-time, update the user profile corresponding to the user to denote this positive reaction to the song. The updated user profile may be processed through the one or more LLMs or other generative artificial intelligence, along with a song profile corresponding to the saved song, and other information associated with the song (e.g., artist information, known tags associated with the song, etc.), to identify other songs associated with the music administrator that may be appealing to the user.

In an embodiment, based on the other songs identified by the one or more LLMs or other generative artificial intelligence in response to user interactions with one or more songs from the set of songs 1008, the P2P music recommendation service dynamically updates the music administrator page 1004 to present new song recommendations corresponding to these other songs. For example, if a user saves a particular song from the set of songs 1008 presented through the music administrator page 1004, the P2P music recommendation service may identify one or more new songs associated with the music administrator that may be similar to the saved song and, thus, may be appealing to the user. Accordingly, the P2P music recommendation service may dynamically update the set of songs 1008 to remove the saved song and any other songs that may not be as appealing as the one or more new songs identified by the P2P music recommendation service through the one or more LLMs or other generative artificial intelligence processes. Further, the P2P music recommendation service may add the one or more new songs to the set of songs 1008 presented through the music administrator page 1004. Thus, as a user interacts with a set of songs 1008 promoted through the music administrator page 1004, the P2P music recommendation service may dynamically update the set of songs 1008 to promote different songs that may be appealing to the user according to changing user preferences and idiosyncrasies.

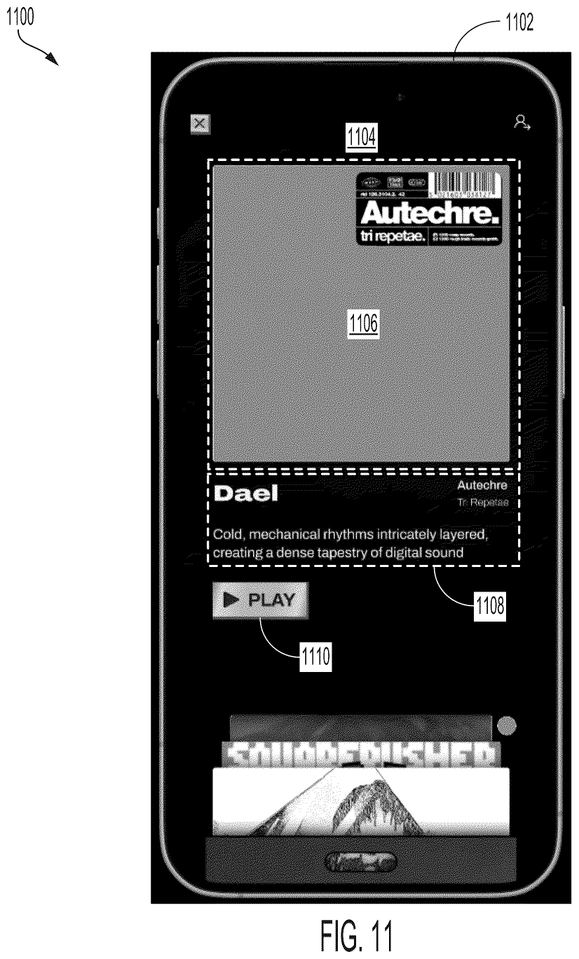

FIG. 11 shows an illustrative example of an environment 1100 in which a P2P music recommendation service provides a song promoted by a music administrator according to a defined music promotion and to a user profile in accordance with at least one embodiment. In the environment 1100, a user of the P2P music recommendation service may access a song promotion page 1104 corresponding to a particular song associated with a music administrator. In some instances, the user may access the song promotion page 1104 by selecting a particular song from the set of songs 1008 presented through the music administrator page 1004 described above in connection with FIG. 10. Alternatively, the user may access the song promotion page 1104 through interaction with a song promotion window (such as the song promotion window 908 described above in connection with FIG. 9) while awaiting music recommendations from other users in response to a submitted music recommendation request.

The song promotion page 1104 may include similar elements to that of the song promotion window 908 described above in connection with FIG. 9. For instance, the song promotion page 1104 may include artwork 1106 corresponding to the promoted song (e.g., album artwork, single artwork, artist artwork, etc.). Further, the song promotion page 1104 may include a song description 1108 that provides context associated with the song and that may be appealing to the user. As noted above, the automated promotion system implemented by the P2P music recommendation service may provide music administrators with different song promotion recommendations that are specific to different user cohorts. The song description 1108 provided in each of these different song promotion recommendations may be tailored according to the user cohort for which the song promotion recommendation is generated and that may be appealing to this user cohort. Thus, in some instances, the P2P music recommendation service, based on user profile data corresponding to the user, may identify the user cohort that the user belongs to and, accordingly, provide a song description 1108 that is tailored for the user cohort.

As illustrated in FIG. 11, the P2P music recommendation service may further provide, through the song promotion page 1104, a play button 1110. Through selection of the play button 1110, a user may interact with the presented song. For instance, if the user selects the play button 1110, the P2P music recommendation service may update the song promotion page 1104 to present one or more interaction elements that may be used to initiate playback of the song and perform other actions. For instance, a user, through these one or more interaction elements, may save the promoted song to their own playlist or library. Alternatively, a user may dismiss or skip a promoted song. Further, a user may re-share the promoted song with other users of the P2P music recommendation service.

The P2P music recommendation service, in an embodiment, dynamically tracks user interactions with the song promotion page 1104 to determine the efficacy of the song promotion in increasing user engagement and interaction with the particular song. Based on aggregated data corresponding to these user interactions, the P2P music recommendation service may retrain or otherwise update the one or more LLMs or other generative artificial intelligence processes described above. For instance, if the user does not interact with the song presented in the song promotion page 1104 (e.g., the user does not select the play button 1110, the user dismisses the song promotion page 1104, etc.), the P2P music recommendation service may annotate the data point corresponding to the song promotion created for the user cohort associated with the user to indicate that the song promotion was not appealing for the user cohort (including any feedback provided by the user). This data point may cause the P2P music recommendation service, for similar songs and user cohorts, to adjust the proposed song promotion recommendations according to the obtained feedback. Alternatively, if the user, through the song promotion page 1104, interacts with the song promotion (e.g., selects the play button 1110 to initiate playback of the promoted song, saves the promoted song to a playlist, shares the promoted song with other users, etc.), the P2P music recommendation service may annotate the data point corresponding to the song promotion created for this user cohort associated with the user to indicate that the song promotion was received positively by the user. This may cause the P2P music recommendation service, for similar songs and user cohorts, to generate recommendations for similar song promotions that may be presented to similar user cohorts.

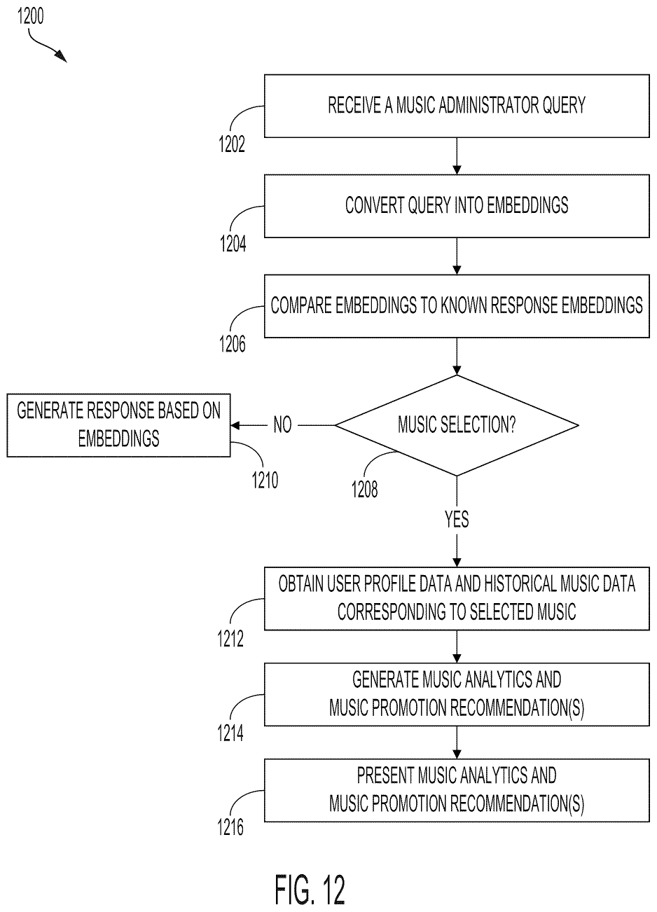

FIG. 12 shows an illustrative example of a process 1200 for generating music promotion analytics and recommendations in response to music administrator queries and corresponding embeddings in accordance with at least one embodiment. The process 1200 may be performed by the automated promotion system described above in connection with FIGS. 2-3. In some instances, certain steps of the process 1200 may be performed through one or more machine learning algorithms or artificial intelligence, including the LLMs or other generative artificial intelligence processes described above.

At step 1202, the automated promotion system may receive a music administrator query. As noted above, the automated promotion system may provide an interface through which music administrators may interact with an automated agent implemented by the automated promotion system to obtain analytics related to different songs administered by these music administrators and to implement different promotional campaigns to increase exposure of these different songs to different users of the P2P music recommendation service. Through the interface, a music administrator may provide a plaintext query corresponding to a request that the music administrator would like fulfilled by the automated promotion system. In some instances, the music administrator query may be provided through the interface using other forms of media (e.g., digital images, recorded video, recorded audio, etc.).

At step 1204, the automated promotion system may convert the music administrator query into a set of query embeddings. For instance, the automated promotion system may dynamically process the music administrator query through a natural language processor to generate a set of embeddings corresponding to the music administrator query. Once the automated promotion system has converted the music administrator query into a set of query embeddings, the automated promotion system, at step 1206, may compare this set of query embeddings to known response embeddings maintained by the P2P music recommendation service. In an embodiment, the automated promotion system accesses available knowledge bases implemented by the P2P music recommendation service and that include knowledge base articles usable to generate responses to submitted queries. These knowledge base articles, in some instances, are converted into a set of response embeddings that may be used to identify, based on the set of query embeddings, the nature of the music administrator query submitted by a music administrator. The automated promotion system, through a machine learning algorithm or artificial intelligence, may perform clustering or classification of the set of query embeddings to obtain partial matches among different known responses and intents to determine whether there is a known response or intent that sufficiently matches the intent associated with the music administrator query (e.g., an obtained partial match satisfies a matching threshold for selection of a known response).

Based on this comparison of the set of query embeddings to the set of response embeddings maintained by the automated promotion system and corresponding to different intents and known responses (as defined through the different knowledge bases and corresponding articles provided by the P2P music recommendation service), the automated promotion system may determine, at step 1208, whether the set of query embeddings correspond to a song for which the music administrator is requesting different song analytics and song promotion recommendations. If the set of query embeddings do not correspond to a request for song analytics and song promotion recommendations for a particular song, the automated promotion system, at step 1210, may generate a response corresponding to the known response associated with the set of response embeddings identified by the automated promotion system as sufficiently matching the set of query embeddings.

If the automated promotion system determines that the set of query embeddings correspond to a request to generate song analytics and song promotion recommendations for a specified song, the automated promotion system, at step 1212, may obtain available user profile data, song profile data, and historical music data corresponding to the selected song. As noted above, the automated promotion system may implement a music analytics module that is configured to access a set of profiles and the music link database to obtain any available data corresponding to the song specified in the music administrator query and the users that have previously interacted with the specified song. Returning to an earlier illustrative example, the music analytics module may obtain a song profile associated with the indicated song to identify any tags and comments that have been assigned to the song by different users of the P2P music recommendation service over time. Additionally, the music analytics module may obtain from the music link database any data corresponding to any tags and comments used by users of the P2P music recommendation service when sharing, requesting, and saving the particular song.

At step 1214, the automated promotion system may dynamically generate a set of song analytics and song promotion recommendations for the song specified in the music administrator query. For instance, the automated promotion system, through the aforementioned song profile machine learning algorithm, may process the data from the set of profiles and the music link database to generate analytics or other metrics for different songs shared within the P2P music recommendation service network or otherwise made available to users of the P2P music recommendation service. As noted above, the set of song analytics for a specified song may include a listing of different artists whose fans, based on listening habits and cross-genre appeal (as determined through evaluation of user profiles of users that may have interacted with similar songs and/or artists), are likely to appreciate the specified song. Further, set of song analytics may include a set of tags that are commonly associated with the specified song, a sentiment commonly associated with the specified song, any representative comments provided by users for the specified song, activities commonly associated with the specified song, characteristics of the representative user that may positively interact with the specified song, and the like.

Additionally, the automated promotion system (through the aforementioned one or more LLMs or other generative artificial intelligence processes) may aggregate this set of song analytics and process these aggregated song analytics to identify any user cohorts for which tailored song recommendations may be generated. Returning to an earlier illustrative example, based on a cluster of tags commonly associated with the particular song, the automated promotion system (through the one or more LLMs or other generative artificial intelligence processes) may define a user cohort corresponding to a classification of this cluster of tags. For this user cohort, the automated promotion system may obtain additional user profile data that may be used to determine whether this user cohort is familiar with the song and, accordingly, derive a proposed song promotion that may be appealing to this user cohort. As another illustrative example, the automated promotion system may automatically define a user cohort corresponding to users that are familiar with the artist associated with the song and/or with similar artists, as identified through the song profile machine learning algorithm. For this user cohort, the automated promotion system may dynamically evaluate the user profile data associated with these users to identify any other user characteristics that may be used to define a proposed song promotion that may be appealing to this user cohort of fans of the artist and/or similar artists.

As noted above, for each proposed song promotion, the automated promotion system may further generate a description of the user cohort associated with the song promotion recommendation and a reasoning or rationale for promoting the song to this user cohort. The description of this user cohort and the rationale for promoting the song to this user cohort may be dynamically generated by the automated promotion system by processing the aggregated music analytics through the aforementioned one or more LLMs or other generative artificial intelligence processes. For instance, as noted above, the one or more LLMs or other generative artificial intelligence processes may leverage one or more knowledge bases corresponding to known types of user cohorts (as defined by the P2P music recommendation service or through observation over time). Based on the aggregated music analytics and the identified user cohorts, the automated promotion system may identify one or more knowledge bases that include basic or generic descriptions of these identified user cohorts and basic or generic reasonings and/or rationales for promoting a song to these identified user cohorts. Through the one or more LLMs or other generative artificial intelligence processes and using the generic descriptions and rationales from the identified knowledge bases, the automated promotion system may dynamically process the aggregated music analytics associated with the song, to supplement the basic or generic descriptions and rationales from the knowledge bases with additional data that is specific to the song.

At step 1216, the automated promotion system may present the aggregated music analytics and proposed song promotion recommendations to the music administrator through the interface provided by the P2P music recommendation service. For instance, the automated promotion system, according to the configuration of the interface, may present the aggregated music analytics and the tailored set of proposed song promotions that may be implemented for different user cohorts to the music administrator. The music administrator, through the interface, may review these aggregated music analytics and song promotion recommendations to provide feedback corresponding to these song promotion recommendations. As noted above, the automated promotion system may dynamically process any communications from the music administrator corresponding to the provided music analytics and proposed song promotions to obtain feedback associated with these proposed song promotions. Based on this feedback from a music administrator, the automated promotion system may dynamically retrain or otherwise update the one or more LLMs or other generative artificial intelligence processes implemented by the automated promotion system to improve the likelihood of these one or more LLMs or other generative artificial intelligence processes generating song promotion recommendations that are relevant to a specified song and that may be appealing to corresponding user cohorts.

It should be noted that the process 1200 may be performed continuously and simultaneously for different music administrator queries submitted by any number of different music administrators. For instance, the automated promotion system may continuously and simultaneously process these different music administrator queries as the different music administrator queries are received to detect music administrator intents and, based on these intents, provide relevant responses to these queries. Additionally, for any music administrator queries corresponding to requests for song analytics and song promotion recommendations for specified songs, the automated promotion system may dynamically generate and provide song analytics and song promotion recommendations for these specified songs simultaneously and in parallel. Any feedback obtained corresponding to a particular song promotion recommendation, as obtained from a music administration may be used to dynamically retrain or update the song profile machine learning algorithm and the one or more LLMs or other generative artificial intelligence processes implemented to dynamically generate song analytics and song promotion recommendations. Thus, the automated promotion system, may continuously and simultaneously process any number of music administrator queries in real-time or near real-time as these music administrator queries are received to generate and provide song analytics and song promotion recommendations in real-time or near real-time.

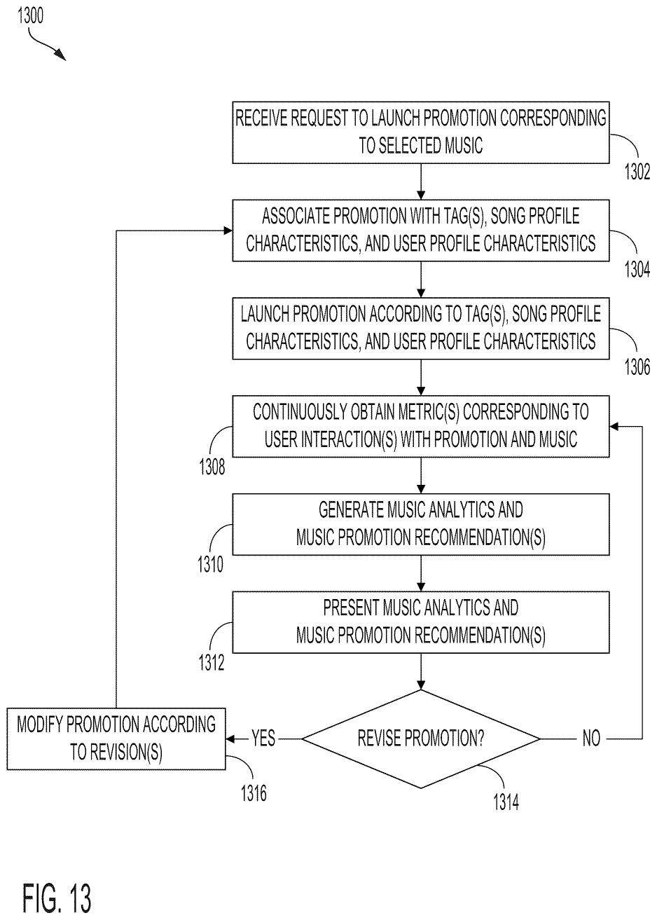

FIG. 13 shows an illustrative example of a process 1300 for launching a music promotion and dynamically monitoring user interactions with the music promotion to generate music promotion analytics and recommendations in accordance with at least one embodiment. The process 1300 may be performed by the automated promotion system described above in connection with FIGS. 2-3. In some instances, certain steps of the process 1300 may be performed through one or more machine learning algorithms or artificial intelligence, including the LLMs or other generative artificial intelligence processes described above.

At step 1302, the automated promotion system may receive a request to launch a song promotion for a particular song. As noted above, the automated promotion system, through an interface provided by the P2P music recommendation service to a music administrator, may generate and present different music promotion recommendations corresponding to different user cohorts. For instance, the automated promotion system may generate and present different song promotion recommendations corresponding to the same song. These different song promotion recommendations may be uniquely tailored according to the user cohorts associated with the different song promotion recommendations. For example, a song promotion recommendation may be associated with a user cohort corresponding to users that are fans of the artist and of similar artists whereas a different song promotion recommendation may be associated with a user cohort corresponding to lifestyle-focused listeners. Through the interface, the music administrator may select a particular song promotion recommendation that the music administrator wishes to implement for the particular song.

At step 1304, the automated promotion system may associate the song promotion with a set of tags, song profile characteristics, and user profile characteristics. For instance, the automated promotion system may update the song profile associated with the song to incorporate the song promotion such that, in response to a music recommendation request including tags, user profile data, or other information that is associated with the particular song and the song promotion, the song promotion may be presented to the user that submitted the music recommendation request. As another illustrative example, if a user responding to a music recommendation request has selected a song that is similar to the particular song being promoted (e.g., the song has similar tags to those of the promoted song, the song is associated with a similar artist or to the same artist of the promoted song, etc.), the automated promotion system may automatically surface the song promotion to the user. As yet another illustrative example, when a user accesses the P2P music recommendation service, the automated promotion system may evaluate the user profile data associated with the user and identify the song promotion based on similarities between song preferences indicated in user profile data and the song profile for the particular song. Thus, through association of the song promotion with different tags, song profile characteristics, and user profile characteristics, the automated promotion system, at step 1306, may launch the song promotion.

At step 1308, the automated promotion system may continuously obtain various metrics corresponding to user interactions with the song promotion and the underlying song. As noted above, the automated promotion system may dynamically track user interactions with presented song promotions to determine the efficacy of these song promotions in increasing user engagement and interaction with the particular song. Based on aggregated data corresponding to these user interactions, the automated promotion system may further retrain or otherwise update the one or more LLMs or other generative artificial intelligence processes trained to dynamically generate song promotion recommendations according to song profile data and user profile data. For instance, if a particular promotion launched by the automated promotion system does not result in increased user interaction with a promoted song amongst a particular user cohort, the automated promotion system may annotate the data point corresponding to the song promotion created for this user cohort to indicate that the song promotion was not appealing for the user cohort (including any feedback provided by users of user cohort). This data point may cause the automated promotion system, for similar songs and user cohorts, to adjust the proposed song promotion recommendations according to the obtained feedback.

At step 1310, the automated promotion system, based on the obtained metrics, may generate new song analytics and song promotion recommendations that may be implemented to supplement or replace the previously launched song promotion. For instance, similar to step 1214 of the process 1200 described above in connection with FIG. 12, the automated promotion system may process the data from the set of profiles and the music link database to generate analytics or other metrics for the particular song associated with the launched promotion. As noted above, the set of song analytics for the song may include a listing of different artists whose fans, based on listening habits and cross-genre appeal are likely to appreciate the song. Further, the set of song analytics may include a set of tags that are commonly associated with the song, a sentiment commonly associated with the song, any representative comments provided by users for the song, activities commonly associated with the song, characteristics of the representative user that may positively interact with the song, and the like. Additionally, the set of song analytics may include any feedback corresponding to the launched song promotion (e.g., user interactions with the song through the presented song promotion, as described above).

In an embodiment, the automated promotion system may process the new song analytics through the aforementioned one or more LLMs or other generative artificial intelligence processes to identify the user cohorts for which tailored song recommendations may be generated. These identified user cohorts may include any previously identified user cohorts associated with the launched song promotion and/or new user cohorts to which the song should be promoted based on the new song analytics. For each of these user cohorts, the automated promotion system may obtain additional user profile data corresponding to users of the user cohort to determine whether this user cohort is familiar with the song and, accordingly, derive a new proposed song promotion or modify an existing song promotion. For each of these proposed song promotions, and based on new song analytics and characteristics of the corresponding user cohort, the automated promotion system (through the one or more LLMs or other generative artificial intelligence processes) may further generate tailored user cohort descriptions and rationales for promoting the song to this user cohort.

At step 1312, the automated promotion system may present the song analytics and proposed song promotion recommendations to the music administrator through the interface provided by the P2P music recommendation service. For instance, the automated promotion system, according to the configuration of the interface, may present the new song analytics and the tailored set of proposed song promotions that may be implemented for different user cohorts to the music administrator. The music administrator, through the interface, may review these new song analytics and song promotion recommendations to provide feedback corresponding to these new song promotion recommendations. As noted above, the automated promotion system may dynamically process any communications from the music administrator corresponding to the provided music analytics and proposed song promotions to obtain feedback associated with these proposed song promotions. Based on this feedback from a music administrator, the automated promotion system, at step 1314, may dynamically determine whether the previously launched song promotion is to be revised according to the new song analytics and newly provided song promotion recommendations.

If the automated promotion system determines that the previously launched song promotion is to be revised according to the provided song promotion recommendations, the automated promotion system, at step 1316, may modify the previously launched song promotion according to the accepted revisions. For instance, if a music administrator accepts a new song promotion recommendation that includes a new song description for a user cohort associated with a previously launched song promotion, the automated promotion system may associate the revised song promotion with a set of tags, song profile characteristics, and user profile characteristics at step 1314. As another illustrative example, if the music administrator opts to replace a previously launched song promotion with a new song promotion recommended by the automated promotion system, the automated promotion system may remove the association between the previously launched music promotion and the set of tags, song profile characteristics, and user profile characteristics. Further, the automated promotion system may associate the new song promotion with the set of tags, song profile characteristics, and user profile characteristics at step 1314.

If the automated promotion system determines that the previously launched song promotion is not to be revised, the automated promotion system may continue to obtain various metrics corresponding to user interactions with the song promotion and the corresponding song at step 1308. Thus, the automated promotion system may continuously monitor user interactions with a song promotion and the corresponding song to dynamically modify the song promotion according to evolving user preferences and tastes, thereby increasing the likelihood of users engaging with the promoted song in a positive manner and increasing exposure to the promoted song to new users, such as through sharing of the promoted song amongst users of the P2P music recommendation service.

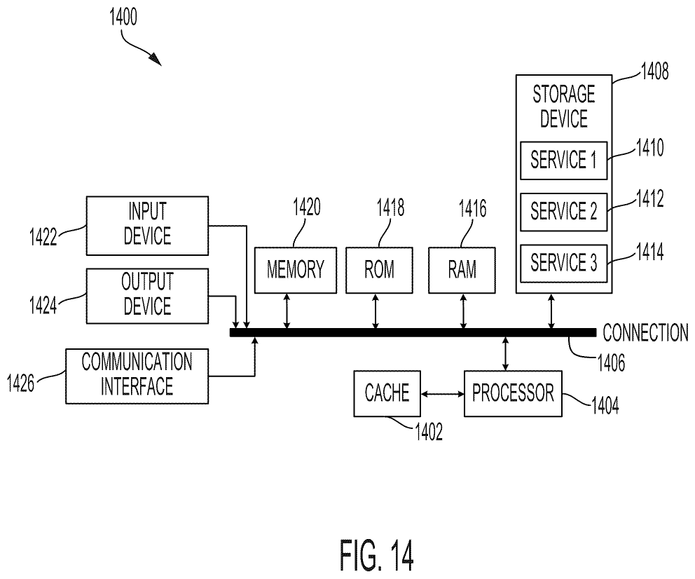

FIG. 14 illustrates a computing system architecture 1400 including various components in electrical communication with each other using a connection 1406, such as a bus, in accordance with some implementations. Example system architecture 1400 includes a processing unit (CPU or processor) 1404 and a system connection 1406 that couples various system components including the system memory 1420, such as ROM 1418 and RAM 1416, to the processor 1404. The system architecture 1400 can include a cache 1402 of high-speed memory connected directly with, in close proximity to, or integrated as part of the processor 1404. The system architecture 1400 can copy data from the memory 1420 and/or the storage device 1408 to the cache 1402 for quick access by the processor 1404. In this way, the cache can provide a performance boost that avoids processor 1404 delays while waiting for data. These and other modules can control or be configured to control the processor 1404 to perform various actions.

Other system memory 1420 may be available for use as well. The memory 1420 can include multiple different types of memory with different performance characteristics. The processor 1404 can include any general purpose processor and a hardware or software service, such as service 1 1410, service 2 1412, and service 3 1414 stored in storage device 1408, configured to control the processor 1404 as well as a special-purpose processor where software instructions are incorporated into the actual processor design. The processor 1404 may be a completely self-contained computing system, containing multiple cores or processors, a bus, memory controller, cache, etc. A multi-core processor may be symmetric or asymmetric.

To enable user interaction with the computing system architecture 1400, an input device 1422 can represent any number of input mechanisms, such as a microphone for speech, a touch-sensitive screen for gesture or graphical input, keyboard, mouse, motion input, speech and so forth. An output device 1424 can also be one or more of a number of output mechanisms known to those of skill in the art. In some instances, multimodal systems can enable a user to provide multiple types of input to communicate with the computing system architecture 1400. The communications interface 1426 can generally govern and manage the user input and system output. There is no restriction on operating on any particular hardware arrangement and therefore the basic features here may easily be substituted for improved hardware or firmware arrangements as they are developed.

Storage device 1408 is a non-volatile memory and can be a hard disk or other types of computer readable media which can store data that are accessible by a computer, such as magnetic cassettes, flash memory cards, solid state memory devices, digital versatile disks, cartridges, RAMs 1416, ROM 1418, and hybrids thereof.

The storage device 1408 can include services 1410, 1412, 1414 for controlling the processor 1404. Other hardware or software modules are contemplated. The storage device 1408 can be connected to the system connection 1406. In one aspect, a hardware module that performs a particular function can include the software component stored in a computer-readable medium in connection with the necessary hardware components, such as the processor 1404, connection 1406, output device 1424, and so forth, to carry out the function.

The disclosed systems associated with the P2P music recommendation service can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purpose computers, special-purpose computer systems, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a user query to generate a music promotion corresponding to a song, wherein the user query is received during an ongoing communications session;
dynamically converting the user query into a set of embeddings, wherein the set of embeddings are obtained through language processing of the user query;
obtaining user profile data and historical music data corresponding to the song and based on the set of embeddings, wherein the user profile data is associated with a set of different users, and wherein the historical music data corresponds to different user interactions with the song;
processing the user profile data and the historical music data through a trained machine learning algorithm to dynamically generate a set of music analytics corresponding to the song and a set of recommendations for different music promotions, wherein the trained machine learning algorithm is trained using a dataset of sample music data and sample promotions;
generating a response to the user query, wherein the response includes the set of music analytics and the set of recommendations; and
updating the trained machine learning algorithm based on feedback associated with the set of music analytics and the set of recommendations, wherein the feedback is obtained through the ongoing communications session.

2. The computer-implemented method of claim 1, further comprising:
receiving a request to implement a music promotion corresponding to a provided recommendation, wherein the request is received through the ongoing communications session; and
automatically implementing the music promotion according to a set of characteristics associated with the song and the provided recommendation.

3. The computer-implemented method of claim 1, wherein the different music promotions correspond to different user cohorts, and wherein the different user cohorts are identified according to the user profile data.

4. The computer-implemented method of claim 1, wherein the set of recommendations includes corresponding rationales for generating the set of recommendations and predicted outcomes from implementing the set of recommendations.

5. The computer-implemented method of claim 1, wherein the set of music analytics includes a set of tags defining attributes assigned to the song in response to the different user interactions with the song.

6. The computer-implemented method of claim 1, wherein the set of music analytics includes representative comments communicated amongst the set of different users as the song is shared.

7. The computer-implemented method of claim 1, wherein the set of music analytics includes different activities linked to the song based on the different user interactions with the song.

8. A system, comprising:
one or more processors; and
memory storing thereon instructions that, as a result of being executed by the one or more processors, cause the system to:
receive a user query to generate a music promotion corresponding to a song, wherein the user query is received during an ongoing communications session;
dynamically convert the user query into a set of embeddings, wherein the set of embeddings are obtained through language processing of the user query;
obtain user profile data and historical music data corresponding to the song and based on the set of embeddings, wherein the user profile data is associated with a set of different users, and wherein the historical music data corresponds to different user interactions with the song;
process the user profile data and the historical music data through a trained machine learning algorithm to dynamically generate a set of music analytics corresponding to the song and a set of recommendations for different music promotions, wherein the trained machine learning algorithm is trained using a dataset of sample music data and sample promotions;
generate a response to the user query, wherein the response includes the set of music analytics and the set of recommendations; and
update the trained machine learning algorithm based on feedback associated with the set of music analytics and the set of recommendations, wherein the feedback is obtained through the ongoing communications session.

9. The system of claim 8, wherein the instructions further cause the system to:
receive a request to implement a music promotion corresponding to a provided recommendation, wherein the request is received through the ongoing communications session; and
automatically implement the music promotion according to a set of characteristics associated with the song and the provided recommendation.

10. The system of claim 8, wherein the different music promotions correspond to different user cohorts, and wherein the different user cohorts are identified according to the user profile data.

11. The system of claim 8, wherein the set of recommendations includes corresponding rationales for generating the set of recommendations and predicted outcomes from implementing the set of recommendations.

12. The system of claim 8, wherein the set of music analytics includes a set of tags defining attributes assigned to the song in response to the different user interactions with the song.

13. The system of claim 8, wherein the set of music analytics includes representative comments communicated amongst the set of different users as the song is shared.

14. The system of claim 8, wherein the set of music analytics includes different activities linked to the song based on the different user interactions with the song.

15. A non-transitory computer-readable storage medium storing thereon executable instructions that, as a result of being executed by one or more processors of a computer system, cause the computer system to:
receive a user query to generate a music promotion corresponding to a song, wherein the user query is received during an ongoing communications session;
dynamically convert the user query into a set of embeddings, wherein the set of embeddings are obtained through language processing of the user query;
obtain user profile data and historical music data corresponding to the song and based on the set of embeddings, wherein the user profile data is associated with a set of different users, and wherein the historical music data corresponds to different user interactions with the song;
process the user profile data and the historical music data through a trained machine learning algorithm to dynamically generate a set of music analytics corresponding to the song and a set of recommendations for different music promotions, wherein the trained machine learning algorithm is trained using a dataset of sample music data and sample promotions;
generate a response to the user query, wherein the response includes the set of music analytics and the set of recommendations; and
update the trained machine learning algorithm based on feedback associated with the set of music analytics and the set of recommendations, wherein the feedback is obtained through the ongoing communications session.

16. The non-transitory computer-readable storage medium of claim 15, wherein the executable instructions further cause the computer system to:
receive a request to implement a music promotion corresponding to a provided recommendation, wherein the request is received through the ongoing communications session; and
automatically implement the music promotion according to a set of characteristics associated with the song and the provided recommendation.

17. The non-transitory computer-readable storage medium of claim 15, wherein the different music promotions correspond to different user cohorts, and wherein the different user cohorts are identified according to the user profile data.

18. The non-transitory computer-readable storage medium of claim 15, wherein the set of recommendations includes corresponding rationales for generating the set of recommendations and predicted outcomes from implementing the set of recommendations.

19. The non-transitory computer-readable storage medium of claim 15, wherein the set of music analytics includes a set of tags defining attributes assigned to the song in response to the different user interactions with the song.

20. The non-transitory computer-readable storage medium of claim 15, wherein the set of music analytics includes representative comments communicated amongst the set of different users as the song is shared.

21. The non-transitory computer-readable storage medium of claim 15, wherein the set of music analytics includes different activities linked to the song based on the different user interactions with the song.
